(19) United States
(12) Patent Application Publication
(10) Pub. No.: US 2026/0159790 A1
(43) Pub. Date: Jun. 11, 2026

(54) AGAVE SPIRIT REPLICAS

(71) Applicant: Ava Food Labs, Inc., Detroit, MI (US)

(72) Inventors: Lucas Baker, San Francisco, CA (US); Solomon Eli Isaacson, Oakland, CA (US); Mardonn Carl Chua, Ann Arbor, MI (US); Lindsay Loretta Smith, San Francisco, CA (US)

(21) Appl. No.: 18/708,874

(22) PCT Filed: Nov. 9, 2022
(86) PCT No.: PCT/US2022/049433

§ 371 Date: May 9, 2024

Related U.S. Application Data
(60) Provisional application No. 63/277,226, filed on Nov. 9, 2021.

(51) Int. Cl. C12G 3/06; C12G 3/07

(52) U.S. Cl. CPC C12G 3/06; C12G 3/07

(57) ABSTRACT

Materials and methods for producing tequila-like alcoholic beverages containing individual volatile components are provided herein.

### CROSS-REFERENCE TO RELATED APPLICATIONS

This application claims priority from U.S. Provisional Application Ser. No. 63/277,226, filed Nov. 9, 2021. The disclosure of the prior application is considered part of (and is incorporated by reference in) the disclosure of this application.

### TECHNICAL FIELD

This document relates to materials and methods for producing tequila-like alcoholic beverages that contain individually added volatile components.

### BACKGROUND

The term “tequila” generally refers to a distilled spirit made from the agave plant. The liquor can only be produced in designated areas of Mexico. “Mezcal” is the name for a distilled spirit made from the maguey (agave) plant. Technically, tequila is a mezcal, but all mezcals are not tequila. The biggest difference between tequila and mezcal is in how the agave is prepared. For tequila, the agave piñas (the succulent core of the plant) typically are baked in ovens, while Mezcal distillers traditionally bake the agave piñas in earthen pits, imparting a noticeable smoky flavor to the product.

Tequila typically is 38 to 55 percent alcohol by volume (ABV), although the alcohol content can vary depending on the type of tequila. Traditional methods for producing tequila can be lengthy and costly, involving the proper tending of agave and harvesting the piñas, followed by processing, fermenting, distilling, and in some cases, aging in wooden barrels. Each component of the traditional process for making tequila can have an inherent variability and risk, including climate, crop disease, and contamination, which can render such methods and their resulting products inconsistent from batch to batch and year to year.

### SUMMARY

This document is based, at least in part, on the identification of compounds that contribute to the flavor and aroma of agave spirits (e.g., tequila), and on the development of methods for combining those compounds to yield agave spirit (e.g., tequila) replicas that have the taste, aroma, and other characteristics of traditionally generated agave spirits. Because each ingredient is added individually, the methods disclosed herein reduce many of the risks and variability associated with traditional agave spirit (e.g., tequila) production. The methods also can provide nearly infinite reproducibility of a recipe, which is not possible with traditional production methods. Further, the methods described herein allow for unique flexibility in optimization of the flavors, aromas, and textures of agave spirits of various types (e.g., traditionally made tequilas or mezcal tequilas), and can greatly reduce or even eliminate the possibility that the resulting beverage will contain detrimental or undesired components. Moreover, the methods disclosed herein differ from currently existing methods in that they are rapid, reproducible, and cost-effective.

In a first aspect, this document features an agave spirit replica containing, consisting essentially of, or consisting of water; a grain neutral spirit; optionally, a agave spirit, wherein the agave spirit replica contains no more than about 10 wt % of the agave spirit; glycerin; optionally, an oak extract; optionally, a plant oil; and at least ten added VOCs, wherein the added VOCs include at least one acid, at least one additional alcohol, at least one aldehyde, at least one ester, at least one terpene, and at least one furan, and wherein the added VOCs comprise about 0.001 wt % to about 1 wt % of the agave spirit replica. The at least one acid can include one or more of decanoic acid, hexanoic acid, lauric acid, and octanoic acid. The at least one acid can include hexanoic acid and decanoic acid. The at least one acid can include decanoic acid, hexanoic acid, lauric acid, and octanoic acid. The at least one additional alcohol can include one or more of 1-butanol, propyl alcohol, 2-methyl-1-butanol, isobutyl alcohol, isoamyl alcohol, fuselol, and phenethyl alcohol. The at least one additional alcohol can include 1-butanol, propyl alcohol, 2-methyl-1-butanol, isobutyl alcohol, isoamyl alcohol, and fuselol. The at least one additional alcohol can include propyl alcohol, 2-methyl-1-butanol, isobutyl alcohol, isoamyl alcohol, fuselol, and phenethyl alcohol. The at least one aldehyde can include one or more of acetaldehyde, isovaleraldehyde, and nonanal. The at least one aldehyde can include acetaldehyde, isovaleraldehyde, and nonanal. The at least one ester can include one or more of butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate. The at least one terpene can include one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol. The at least one terpene can include alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol. The at least one terpene can include 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol. The at least one terpene can include one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol. The at least one terpene can include one or both of 2-acetylfuran and furfuryl alcohol.

The added VOCs can include ten or more compounds selected from the group consisting of 1-butanol, 2-acetylfuran, 2-methyl-1-butanol, 3-carene, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl butyrate, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol. The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol. The added VOCs can include 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol. The added VOCs can include 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

The agave spirit replica can include from about 5 wt % to about 70 wt % water; from about 30 wt % to about 95 wt % grain neutral spirits, not more than about 5 wt % agave spirit; from about 0.1 wt % to about 5 wt % glycerin; and from about 0.001 wt % to about 1 wt % added VOCs, wherein the added VOCs include ten or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol. The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol. The added VOCs can include 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol. The added VOCs can include 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

The added VOCs can include isoamyl acetate, wherein the isoamyl acetate is present in the agave spirit replica at a concentration greater than about 6 mg/L. The added VOCs can include hexanoic acid, wherein the hexanoic acid is present in the agave spirit replica at a concentration greater than about 23 mg/L. The added VOCs can include octanoic acid, wherein the octanoic acid is present in the agave spirit replica at a concentration less than about 5 mg/L. The added VOCs can include lauric acid, wherein the lauric acid is present in the agave spirit replica at a concentration less than about 1.9 mg/L. The added VOCs can include thymol, wherein the thymol is present in the agave spirit replica at a concentration greater than about 0.5 mg/L. The added VOCs can include ethyl octanoate, wherein the ethyl octanoate is present in the agave spirit replica at a concentration greater than about 8 mg/L. The added VOCs can include isoamyl alcohol, wherein the isoamyl alcohol is present in the agave spirit replica at a concentration less than about 100 mg/L. The added VOCs can include p-cymene, wherein the p-cymene is present in the agave spirit replica at a concentration greater than about 0.0085 mg/L. The added VOCs can include caryophyllene, wherein the caryophyllene is present in the agave spirit replica at a concentration greater than about 0.007 mg/L. The added VOCs can include isobutyl alcohol, wherein the isobutyl alcohol is present in the agave spirit replica at a concentration greater than about 650 mg/L. The added VOCs can include furfuryl alcohol, wherein the furfuryl alcohol is present in the agave spirit replica at a concentration greater than about 8.5 mg/L. The added VOCs can include nonanal, wherein the nonanal is present in the agave spirit replica at a concentration greater than about 0.06 mg/L. The added VOCs can include alpha-pinene, wherein the alpha-pinene is present in the agave spirit replica at a concentration greater than about 0.01 mg/L. The added VOCs can include humulene, wherein the humulene is present in the agave spirit replica at a concentration greater than about 0.01 mg/L. The added VOCs can include ethyl butyrate, wherein the ethyl butyrate is present in the agave spirit replica at a concentration greater than about 1.6 mg/L. The added VOCs can include isoamyl octanoate, wherein the isoamyl octanoate is present in the agave spirit replica at a concentration greater than about 0.6 mg/L. The added VOCs can include ethyl decanoate, wherein the ethyl decanoate is present in the agave spirit replica at a concentration less than about 0.007 mg/L. The added VOCs can include 2-acetylfuran, wherein the 2-acetylfuran is present in the agave spirit replica at a concentration less than about 0.05 mg/L. The added VOCs can include diethyl succinate, wherein the diethyl succinate is present in the agave spirit replica at a concentration greater than about 2.3 mg/L. The added VOCs can include alpha-terpineol, wherein the alpha-terpineol is present in the agave spirit replica at a concentration less than about 0.24 mg/L. The added VOCs can include octanoic acid, wherein less than about 0.0013 wt % of the one or more additional VOCs is octanoic acid. The added VOCs can include thymol, wherein greater than about 0.00053 wt % of the one or more additional VOCs is thymol. The added VOCs can include isoamyl alcohol, wherein less than about 0.03 wt % of the one or more additional VOCs is isoamyl alcohol. The added VOCs p-cymene, wherein greater than about 0.0000087 wt % of the one or more additional VOCs is p-cymene. The added VOCs can include caryophyllene, wherein greater than about 0.0000067 wt % of the one or more additional VOCs is caryophyllene. The added VOCs can include isobutyl alcohol, wherein greater than about 0.52 wt % of the one or more additional VOCs is isobutyl alcohol. The added VOCs can include furfuryl alcohol, wherein greater than about 0.0086 wt % of the one or more additional VOCs is furfuryl alcohol. The added VOCs can include alpha-pinene, wherein greater than about 0.000009 wt % of the one or more additional VOCs is alpha-pinene. The added VOCs can include ethyl butyrate, wherein greater than about 0.0017 wt % of the one or more additional VOCs is ethyl butyrate. The added VOCs can include isoamyl octanoate, wherein greater than about 0.0006 wt % of the one or more additional VOCs is isoamyl octanoate. The added VOCs can include ethyl decanoate, wherein less than about 0.0000017 wt % of the one or more additional VOCs is ethyl decanoate. The added VOCs can include diethyl succinate, wherein greater than about 0.0023 wt % of the one or more additional VOCs is diethyl succinate. The added VOCs can include alpha-terpineol, wherein less than about 0.00006 wt % of the one or more additional VOCs is alpha-terpineol.

In another aspect, this document features a method for making an agave spirit replica, where the method includes, or consists essentially of, combining water; a grain neutral spirit; optionally, an agave spirit, wherein the agave spirit replica includes no more than about 10 wt % of the agave spirit; glycerin; optionally, an oak extract; optionally, a plant oil; and at least ten added VOCs, wherein the VOCs are provided as separate ingredients and include at least one acid, at least one additional alcohol, at least one aldehyde, at least ester, at least one terpene, and at least one furan, and wherein the added VOCs comprise about 0.001 wt % to about 1 wt % of the agave spirit replica. The at least one acid can include one or more of decanoic acid, hexanoic acid, lauric acid, and octanoic acid. The at least one acid can include hexanoic acid and decanoic acid. The at least one acid can include decanoic acid, hexanoic acid, lauric acid, and octanoic acid. The at least one additional alcohol can include one or more of 1-butanol, propyl alcohol, 2-methyl-1-butanol, isobutyl alcohol, isoamyl alcohol, fuselol, and phenethyl alcohol. The at least one additional alcohol can include 1-butanol, propyl alcohol, 2-methyl-1-butanol, isobutyl alcohol, isoamyl alcohol, and fuselol. The at least one additional alcohol can include propyl alcohol, 2-methyl-1-butanol, isobutyl alcohol, isoamyl alcohol, fuselol, and phenethyl alcohol. The at least one aldehyde can include one or more of acetaldehyde, isovaleraldehyde, and nonanal. The at least one aldehyde can include acetaldehyde, isovaleraldehyde, and nonanal. The at least one ester can include one or more of butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate. The at least one ester can include butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate. The at least one terpene can include one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol. The at least one terpene can include alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol. The at least one terpene can include 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol. The at least one terpene can include one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol. The at least one terpene can include one or both of 2-acetylfuran and furfuryl alcohol.

The added VOCs can include ten or more compounds selected from the group consisting of 1-butanol, 2-acetylfuran, 2-methyl-1-butanol, 3-carene, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl butyrate, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl Jaurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol. The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol. The added VOCs can include 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol. The added VOCs can include 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

The agave spirit replica can contain from about 5 wt % to about 70 wt % water; from about 30 wt % to about 95 wt % grain neutral spirits; not more than about 5 wt % agave spirit; from about 0.0001 wt % to about 5 wt % glycerin; and from about 0.001 wt % to about 1 wt % added VOCs, wherein the added VOCs include ten or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol. The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

The added VOCs can include 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol. The added VOCs can include 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol. The added VOCs can include 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

The added VOCs can include isoamyl acetate, wherein the isoamyl acetate is present in the agave spirit replica at a concentration greater than about 6 mg/L. The added VOCs can include hexanoic acid, wherein the hexanoic acid is present in the agave spirit replica at a concentration greater than about 23 mg/L. The added VOCs can include octanoic acid, wherein the octanoic acid is present in the agave spirit replica at a concentration less than about 5 mg/L. The added VOCs can include lauric acid, wherein the lauric acid is present in the agave spirit replica at a concentration less than about 1.9 mg/L. The added VOCs can include thymol, wherein the thymol is present in the agave spirit replica at a concentration greater than about 0.5 mg/L. The added VOCs can include ethyl octanoate, wherein the ethyl octanoate is present in the agave spirit replica at a concentration greater than about 8 mg/L. The added VOCs can include isoamyl alcohol, wherein the isoamyl alcohol is present in the agave spirit replica at a concentration less than about 100 mg/L. The added VOCs can include p-cymene, wherein the p-cymene is present in the agave spirit replica at a concentration greater than about 0.0085 mg/L. The added VOCs can include caryophyllene, wherein the caryophyllene is present in the agave spirit replica at a concentration greater than about 0.007 mg/L. The added VOCs can include isobutyl alcohol, wherein the isobutyl alcohol is present in the agave spirit replica at a concentration greater than about 650 mg/L. The added VOCs can include furfuryl alcohol, wherein the furfuryl alcohol is present in the agave spirit replica at a concentration greater than about 8.5 mg/L. The added VOCs can include nonanal, wherein the nonanal is present in the agave spirit replica at a concentration greater than about 0.06 mg/L. The added VOCs can include alpha-pinene, wherein the alpha-pinene is present in the agave spirit replica at a concentration greater than about 0.01 mg/L. The added VOCs can include humulene, wherein the humulene is present in the agave spirit replica at a concentration greater than about 0.01 mg/L. The added VOCs can include ethyl butyrate, wherein the ethyl butyrate is present in the agave spirit replica at a concentration greater than about 1.6 mg/L. The added VOCs can include isoamyl octanoate, wherein the isoamyl octanoate is present in the agave spirit replica at a concentration greater than about 0.6 mg/L. The added VOCs can include ethyl decanoate, wherein the ethyl decanoate is present in the agave spirit replica at a concentration less than about 0.007 mg/L. The added VOCs can include 2-acetylfuran, wherein the 2-acetylfuran is present in the agave spirit replica at a concentration less than about 0.05 mg/L. The added VOCs can include diethyl succinate, wherein the diethyl succinate is present in the agave spirit replica at a concentration greater than about 2.3 mg/L. The added VOCs can include alpha-terpineol, wherein the alpha-terpineol is present in the agave spirit replica at a concentration less than about 0.24 mg/L. The added VOCs can include octanoic acid, wherein less than about 0.0013 wt % of the one or more additional VOCs is octanoic acid. The added VOCs can include thymol, wherein greater than about 0.00053 wt % of the one or more additional VOCs is thymol. The added VOCs can include isoamyl alcohol, wherein less than about 0.03 wt % of the one or more additional VOCs is isoamyl alcohol. The added VOCs p-cymene, wherein greater than about 0.0000087 wt % of the one or more additional VOCs is p-cymene. The added VOCs can include caryophyllene, wherein greater than about 0.0000067 wt % of the one or more additional VOCs is caryophyllene. The added VOCs can include isobutyl alcohol, wherein greater than about 0.52 wt % of the one or more additional VOCs is isobutyl alcohol. The added VOCs can include furfuryl alcohol, wherein greater than about 0.0086 wt % of the one or more additional VOCs is furfuryl alcohol. The added VOCs can include alpha-pinene, wherein greater than about 0.000009 wt % of the one or more additional VOCs is alpha-pinene. The added VOCs can include ethyl butyrate, wherein greater than about 0.0017 wt % of the one or more additional VOCs is ethyl butyrate. The added VOCs can include isoamyl octanoate, wherein greater than about 0.0006 wt % of the one or more additional VOCs is isoamyl octanoate. The added VOCs can include ethyl decanoate, wherein less than about 0.0000017 wt % of the one or more additional VOCs is ethyl decanoate. The added VOCs can include diethyl succinate, wherein greater than about 0.0023 wt % of the one or more additional VOCs is diethyl succinate. The added VOCs can include alpha-terpineol, wherein less than about 0.00006 wt % of the one or more additional VOCs is alpha-terpineol.

In another aspect, this document features an agave spirit replica produced by a method described herein.

In still another aspect, this document features a tequila-like alcoholic beverage concentrate containing, consisting essentially of, or consisting of glycerin; optionally, a tequila, wherein the alcoholic beverage, after dilution to produce a final product, contains no more than about 10 wt % of the tequila; optionally, an oak extract, optionally, a plant oil; and at least ten added VOCs, wherein the added VOCs include at least one acid, at least one additional alcohol, at least one aldehyde, at least one ester, at least one terpene, and at least one furan, and wherein at least one of the added VOCs is present in a concentration of at least about 2-fold the concentration of the same VOC in a corresponding traditional tequila or a corresponding non-concentrate tequila. At least one of the added VOCs can be present in the concentrate in a concentration of at least about 5-fold the concentration of the same VOCs in a corresponding traditional tequila or a corresponding non-concentrate tequila. At least one of the added VOCs can be present in the concentrate in a concentration of at least about 10-fold the concentration of the same VOCs in a corresponding traditional tequila or a corresponding non-concentrate tequila. At least one of the added VOCs can be present in the concentrate in a concentration of at least about 15-fold the concentration of the same VOCs in a corresponding traditional tequila or a corresponding non-concentrate tequila. Upon dilution of the tequila-like beverage concentrate to a tequila-like alcoholic beverage, the tequila-like alcoholic beverage can be an agave spirit replica described herein.

In yet another aspect, this document features a method for making a tequila-like alcoholic beverage concentrate, where the method includes, consists essentially of, or consists of combining glycerin; optionally, a tequila, wherein the alcoholic beverage, after dilution to produce a final product, contains no more than about 10 wt % of the tequila; optionally, an oak extract; optionally, a plant oil; and at least ten added VOCs, wherein the added VOCs include at least one acid, at least one additional alcohol, at least one aldehyde, at least one ester, at least one terpene, and at least one furan, and wherein at least one of the added VOCs is present in a concentration of at least about 2-fold the concentration of the same VOC in a corresponding traditional tequila or a corresponding non-concentrate tequila. At least one of the added VOCs can be present in the concentrate in a concentration of at least about 5-fold the concentration of the same VOCs in a corresponding traditional tequila or a corresponding non-concentrate tequila. At least one of the added VOCs can be present in the concentrate in a concentration of at least about 10-fold the concentration of the same VOCs in a corresponding traditional tequila or a corresponding non-concentrate tequila. At least one of the added VOCs can be present in the concentrate in a concentration of at least about 15-fold the concentration of the same VOCs in a corresponding traditional tequila or a corresponding non-concentrate tequila. Upon dilution of the tequila-like beverage concentrate to a tequila-like alcoholic beverage, the tequila-like alcoholic beverage can be an agave spirit replica described herein.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and from the claims.

### DETAILED DESCRIPTION

This document provides tequila-like alcoholic beverages (also referred to as “agave spirit replicas,” “agave spirit products,” “tequila replicas,” “tequila products,” and “flavored tequilas”), as well as methods for making tequila-like alcoholic beverages by combining water and ethanol with individual VOCs. Going forward in this document, the term “tequila” refers to both “tequila” and “tequila” spirits.

The tequila-like alcoholic beverages described herein have characteristics—including taste, aroma, mouthfeel, and appearance—of traditionally produced tequilas, and are meant to be consumed and enjoyed in the same manner as traditional tequilas. For example, the tequila replicas can have colors consistent with those of traditional tequilas, ranging from colorless (blanco) to golden (añejo), with similar “tears” on the sides of the glass and similar viscosity to traditional tequilas. In some cases, a tequila replica can have a pale lemon color reminiscent of traditionally-made reposado tequila. On the nose, the tequila replicas provided herein can have fruity, herbaceous, smoky, and/or floral aromas, and sometimes oak aromas, much like traditionally-made tequila. In some cases, for example, a tequila replica can have an agave-reminiscent floral character combined with citrus and pomaceous fruit. On the palate, the tequila replicas provided herein can have flavors (e.g., sweetness), alcoholic perception, finish, and mouthfeel that mimic those of traditionally-made tequila. In some cases, the tequila replicas can have a smooth and floral character associated with the style of blanco and reposado tequilas.

As used herein, the terms “traditional” and “reference” agave spirits (e.g., “traditional tequila” and “reference tequila”) refer to agave spirits produced through standard processing, fermenting, and distilling processes.

The following standards of identity for traditionally produced distilled neutral spirits are set forth in 27 C.F.R. § 5.22 (a):

Class 1; neutral spirits or alcohol. “Neutral spirits” or “alcohol” are distilled spirits produced from any material at or above 190° proof, and, if bottled, bottled at not less than 80° proof.

The following standards of identity for traditionally produced tequilas are further set forth in 27 C.F.R. § 5.22 (g):

Class 7, Agave Spirits. “Agave spirits” are distilled from a fermented mash, of which at least 51 percent is derived from plant species in the genus Agave and up to 49 percent is derived from other sugars. Agave spirits must be distilled at less than 95 percent alcohol by volume (190° proof) and bottled at or above 40 percent alcohol by volume (80° proof). Agave spirits may be stored in wood barrels. Agave spirits may contain added flavoring or coloring materials as authorized by § 5.23. This class also includes mixtures of agave spirits. Agave spirits that meet the standard of identity for “Tequila” or “Mezcal” may be designated as “agave spirits” or as “Tequila” or “Mezcal” as applicable.
(1) “Tequila” is an agave spirit that is a distinctive product of Mexico. Tequila must be made in Mexico, in compliance with the laws and regulations of Mexico governing the manufacture of Tequila for consumption in that country.
(2) “Mezcal” is an agave spirit that is a distinctive product of Mexico. Mezcal must be made in Mexico, in compliance with the laws and regulations of Mexico governing the manufacture of Mezcal for consumption in that country.

The alcoholic beverages provided herein can, in some cases, include a traditional tequila, such that the beverages can be considered “spirits” as defined above. In such embodiments, any appropriate percentage of the ethanol in a tequila replica, on a proof gallon basis, can be from the traditional tequila. For example, about 1 percent to about 5 percent of the ethanol in a tequila replica, on a proof gallon basis, can be from a traditional tequila. A “proof gallon” is one liquid gallon of spirits that is 50% alcohol at 60° F. Thus, for example, a distilled spirit bottled at 80 proof (40% alcohol) would be 0.8 proof gallons per gallon of liquid. An 80 proof spirit tequila replica containing 1% ethanol from a traditional tequila on a proof gallon basis therefore would contain 0.8×0.01=0.008 proof gallon from the traditional tequila.

The tequila replicas described herein can contain particular volatile and, optionally, non-volatile organic compounds. The terms “contain,” “include,” “comprise” are used herein to indicate that a compound is present in a tequila replica in an amount that is detectable (e.g., using a mass spectrometry method, such as gas chromatography mass spectrometry). The terms “lacks,” “does not contain,” “does not include,” and “does not comprise” are used herein to indicate that a compound is not detectable in a tequila replica (e.g., using a mass spectrometry method, such as liquid chromatography mass spectrometry). The tequila replicas provided herein can be distinguished from traditional tequilas based at least in part on the combination of VOCs and, in some cases, non-volatile organic compounds contained or not contained therein, and/or based on the amounts of particular VOCs or, in some cases, non-volatile organic compounds contained therein.

In some embodiments, a tequila replica can consist of the ingredients included in a particular list, or can have a VOC content (or non-volatile compound content) that consists of the VOCs (or non-volatile compounds) included in a particular list. Further, a tequila replica can consist essentially of the ingredients included in a particular list, or can have a VOC content (or non-volatile compound content) that consists essentially of the VOCs (or non-volatile compounds) that are included in a particular list. By “consisting essentially of” is meant that a tequila replica contains specified ingredients/VOCs/non-volatile compounds, and can contain additional ingredients/VOCs/non-volatile compounds that do not materially affect the basic and novel characteristics of the tequila.

Various formulations for tequila replicas are described herein. In general, the tequila replicas include the following components, or classes of components:
(a) a source of water, either pure or with mineral content present to improve flavor;
(b) a source of ethanol (e.g., a distilled or fermented ethanol, such as grain neutral spirits);
(c) optionally, a traditional tequila, where the traditional tequila makes up no more than about 10 wt % of the tequila replica;
(d) glycerin;
(e) optionally, an oak extract;
(f) optionally, one or more plant oils in addition to any oils provided in the traditional tequila;
(g) one or more additional VOCs (that is, one or more VOCs in addition to the ethanol and in addition to any volatile compounds that may be present in the traditional tequila, plant oil(s), and oak extract, if included); and optionally
(h) one or more additional non-volatile compounds (that is, one or more non-volatile compounds in addition to any non-volatile compounds that may be present in the traditional tequila, plant oil(s), and/or oak extract, if included), such as one or more coloring agents.

Water is the main component of the tequila replicas, acting as a solvent for the other ingredients. The ethanol component and the traditional tequila component (if any) provide the alcoholic content. The one or more added VOCs and the optional oak extract and optional one or more plant oils can provide both aroma and flavor, including fruity, floral, earthy, herbaceous, oak, yeast, spice, and/or mineral aromas and flavors. In some cases, non-volatile components can provide acidity, flavor, aftertaste, and mouthfeel perception of the tequila replicas.

In general, the tequila replicas provided herein can have a water content of about 5 to about 70 wt %. For example, a tequila replica can have a water content of about 5 to 10 wt %, about 10 to 20 wt %, about 20 to 30 wt %, about 30 to 40 wt %, about 40 to 45 wt %, about 45 to 50 wt %, about 50 to 55 wt %, about 55 to 60 wt %, about 60 to 65 wt %, or about 65 to 70 wt %.

In general, the tequila replicas provided herein can have a total alcohol content (e.g., an ethanol content from grain neutral spirits and traditional tequila) content that ranges from about 30 wt % to about 95 wt %. For example, a tequila replica can have an alcohol content of about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt %.

In some cases, the tequila replicas provided herein can contain about 30 wt % to about 95 wt % grain neutral spirits (e.g., about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt % grain neutral spirits) and about 0.1 wt % to about 10 wt % traditional tequila (e.g., about 0.1 wt %, about 0.25 wt %, about 0.5 wt %, about 0.75 wt %, about 1 wt %, about 1.25 wt %, about 1.5 wt %, about 2 wt %, about 3 wt %, about 5 wt %, about 10 wt %, about 0.1 to 0.25 wt %, about 0.25 to 0.5 wt %, about 0.5 to 0.75 wt %, about 0.75 to 1 wt %, about 1 to 1.25 wt %, about 1.25 to 1.5 wt %, about 1.5 to 2 wt %, about 2 to 3 wt %, about 3 to 5 wt %, about 5 to 10 wt %, no more than about 1 wt %, no more than about 2 wt %, no more than about 3 wt %, no more than about 5 wt %, or no more than about 10 wt % traditional tequila).

The tequila replicas provided herein can contain about 0.1 wt % to about 5 wt % glycerin, which can contribute to the mouthfeel and viscosity of the tequila replicas, and can also provide some sweetness. For example, a tequila replica can contain glycerin in an amount of about 0.1 wt %, about 0.5 wt %, about 1 wt %, about 1.5 wt %, about 2 wt %, about 2.5 wt %, about 3 wt %, about 4 wt %, about 5 wt %, about 0.1 to about 0.5 wt %, about 0.5 to 1 wt %, about 0.5 to about 1.5 wt %, about 1 to about 1.5 wt %, about 1.5 to about 2 wt %, about 2 to about 3 wt %, about 3 to about 4 wt %, or about 4 to about 5 wt %.

In some cases, the tequila replicas provided herein can contain an oak extract. The oak extract can be included in an amount from about 0.1 wt % to about 15 wt %. For example, a tequila replica can contain about 0.1 wt %, about 0.5 wt %, about 1 wt %, about 1.5 wt %, about 2 wt %, about 2.5 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 0.1 to 0.5 wt %, about 0.5 to 1 wt %, about 1 to 1.5 wt %, about 1.5 to 2 wt %, about 2 to 3 wt %, about 3 to 4 wt %, about 4 to 5 wt %, about 5 to 6 wt %, about 6 to 7 wt %, about 7 to 8 wt %, about 8 to 9 wt %, about 9 to 10 wt %, about 10 to 12 wt %, about 11 to 13 wt %, about 12 to 14 wt %, or about 13 to 15 wt % oak extract. In some cases, a tequila replica provided herein contains no oak extract.

In some cases, the tequila replicas provided herein can contain one or more plant oils (e.g., thyme oil, pepper oil, rosemary oil, or any combination thereof). The one or more plant oils can be included in a total amount of about 0.0001 wt % to about 0.002 wt % (e.g., about 0.0001 wt %, about 0.0002 wt %, about 0.0003 wt %, about 0.0005 wt %, about 0.0008 wt %, about 0.001 wt %, about 0.0015 wt %, about 0.002 wt %, about 0.0001 to about 0.0002 wt %, about 0.0002 to about 0.0005 wt %, about 0.0005 to about 0.0007 wt %, about 0.0007 to about 0.001 wt %, about 0.001 to 0.015 wt %, or about 0.0015 to 0.002 wt %). In some cases, a tequila replica provided herein contains no individually added plant oil.

The tequila replicas provided herein also contain one or more additional VOCs, where the additional VOCs were added to the tequila replica on an individual basis (e.g., in pure or substantially pure form). The tequila replicas provided herein also can contain one or more additional non-volatile compounds, where the additional non-volatile compounds were added to the tequila replica on an individual basis (e.g., in pure or substantially pure form). In some cases, a tequila replica can include water, ethanol, optionally a traditional tequila, glycerin, optionally a plant oil and/or an oak extract, and (a) one or more additional VOCs (i.e., VOCs in addition to ethanol), where the one or more additional VOCs are not present in a corresponding reference tequila (also sometimes herein called a corresponding traditional tequila); (b) one or more additional VOCs, where the one or more additional VOCs do not include one or more VOCs that are present in a corresponding reference tequila; (c) one or more additional non-volatile compounds, where the one or more additional non-volatile compounds are not present in a corresponding reference tequila; (d) one or more additional non-volatile compounds, where the one or more additional non-volatile compounds do not include one or more non-volatile compounds that are present in a corresponding reference tequila; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

As used herein, a “corresponding reference tequila” can be a single type, a single brand, or a single bottle of traditionally-produced tequila that a tequila replica as described herein is intended to replicate. In some cases, a single type, single brand, or single bottle of traditionally-produced tequila can be a blend of two or more (e.g., two, three, four, or more than four) tequilas. For example, if a tequila replica is meant to be the same as a reposado tequila, then a traditional reposado tequila would be a corresponding reference tequila.

The one or more added VOCs that are present in a tequila replica can include one or more compounds that fall into any of several categories, including acids, alcohols, aldehydes, esters, ketones, terpenes, furans, and/or other types of VOCs (e.g., sulfides). In some cases, for example, a tequila replica can contain added VOCs that include an acid, an alcohol in addition to the ethanol, an aldehyde, a ketone, an ester, a terpene, and a sulfide. In some cases, a tequila replica can contain added VOCs that include an acid, an alcohol in addition to the ethanol, an aldehyde, an ester, a terpene, and a furan. The additional VOCs can be present at any suitable amount within a tequila replica. For example, additional VOCs can make up about 0.008 wt % to about 0.04 wt % (e.g., about 0.008 to about 0.009 wt %, about 0.009 to about 0.01 wt %, about 0.01 to about 0.02 wt %, about 0.02 to about 0.03 wt %, or about 0.03 to about 0.04 wt %) of a tequila replica.

Acids can contribute to the signature flavors of alcoholic beverages. Non-limiting examples of acids that can be included in the tequila replicas provided herein include acetic acid, decanoic acid, hexanoic acid, lauric acid, myristic acid, octanoic acid, propionic acid, and any combination thereof. A tequila replica provided herein can contain one or more, two or more, three or more, four or more, five or more, six, or all seven acids selected from the group consisting of acetic acid, decanoic acid, hexanoic acid, lauric acid, myristic acid, octanoic acid, propionic acid. For example, a tequila replica can contain one or more acids selected from hexanoic acid, lauric acid, decanoic acid, and octanoic acid. In some cases, a tequila replica can contain hexanoic acid, lauric acid, decanoic acid, and octanoic acid. In some cases, a tequila replica can contain hexanoic acid and decanoic acid. The acid(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more acids. The one or more acids can be present at any suitable amount within a tequila replica. For example, added acid(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs can include no acids.

Alcohols in addition to the ethanol provided by the grain neutral spirit and the traditional tequila can provide various flavor components to alcoholic beverages, including banana, spice, grassiness, and oxidized characteristics. In some cases, higher alcohols also can add roundness to the general aroma of an alcoholic beverage, as well as some weight on the palate. Non-limiting example of alcohols that can be present in the tequila replicas provided herein include 1-decanol, 1-octen-3-ol, 2-heptanol, 2,3-butanediol, 2,4,6-trimethylphenol, 4-ethylguaiacol, carvacrol, farnesol, furfuryl alcohol, fuselol (also referred to as fusel oil), hexyl alcohol, isoamyl alcohol, isobutyl alcohol, phenethyl alcohol, phenol, propyl alcohol, thymol, nerolidol, 1-butanol, and 2-methyl-1-butanol, and any combination thereof. A tequila replica provided herein can contain one or more, two or more, three or more, four or more, five or more, six or more, eight or more, 10 or more, 12 or more, or 15 or more alcohols selected from the group consisting of 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 1-butanol, and 2-methyl-1-butanol. For example, a tequila replica can contain one or more alcohols selected from 1-butanol, propyl alcohol, 2-methyl-1-butanol, isobutyl alcohol, isoamyl alcohol, fuselol, and phenethyl alcohol. In some cases, a tequila replica can contain 1-butanol, propyl alcohol, 2-methyl-1-butanol, isobutyl alcohol, isoamyl alcohol, and fuselol. In some cases, a tequila replica can contain propyl alcohol, 2-methyl-1-butanol, isobutyl alcohol, isoamyl alcohol, fuselol, and phenethyl alcohol. The alcohol(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more alcohols. The one or more alcohols can be present at any suitable amount within a tequila replica. In some cases, for example, added alcohol(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs can include no additional alcohols.

Aldehydes also can provide flavors that add to the general character of an alcoholic beverage. In some cases, aldehydes that can be used in the tequila replicas provided herein can include, without limitation, 3-methylbutyraldehyde, 5-methylfurfural, acetal, acetaldehyde, furfural, vanillin, acetol, isovaleraldehyde, nonanal, and any combination thereof. A tequila replica provided herein can contain one or more, two or more, three or more, four or more, five or more, six or more, seven or more, eight, or all nine aldehydes selected from the group consisting of 3-methylbutyraldehyde, 5-methylfurfural, acetal, acetaldehyde, furfural, vanillin, acetol, isovaleraldehyde, and nonanal. For example, a tequila replica can contain one or more aldehydes selected from acetol, isovaleraldehyde, and nonanal. In some cases, a tequila replica can contain acetol, isovaleraldehyde, and nonanal. The aldehyde(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more aldehydes. The one or more aldehyde(s) can be present at any suitable amount within a tequila replica. In some cases, for example, added aldehyde(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs can include no aldehydes.

Esters, including ethyl, methyl, and acetate esters, can contribute fruity and floral characteristics to an alcoholic beverage. In some cases, esters that can be used in a tequila replica include, without limitation, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, butyl acetate, isoamyl butyrate, isobutyl hexanoate, and any combination thereof. A tequila replica provided herein can contain one or more, two or more, three or more, four or more, five or more, six or more, seven or more, eight or more, ten or more, or 15 or more esters selected from the group consisting of diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, butyl acetate, isoamyl butyrate, and isobutyl hexanoate. For example, a tequila replica can contain one or more esters selected from butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate. In some cases, a tequila replica can contain butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate. In some cases, a tequila replica can contain butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate. In some cases, a tequila replica can contain butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate. In some cases, a tequila replica can contain butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate. The ester(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more esters. The one or more esters can be present at any suitable amount within a tequila replica. In some cases, for example, added ester(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs can include no esters.

Ketones can also contribute to the signature flavors of alcoholic beverages. Non-limiting examples of ketones that can be included in the tequila replicas provided herein include acetoin, acetone, methylcyclopentenolone, piperine, and any combination thereof. The ketone(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more ketones. The one or more ketones can be present at any suitable amount within a tequila replica. In some cases, for example, added ketone(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs can include no ketones.

Terpenes can contribute various floral and green characteristics to an alcoholic beverage. Non-limiting examples of terpenes that can be included in the tequila replicas provided herein include 1-octene, d-limonene, linalool, linalool oxide, myrcene (also referred to as beta-myrcene), p-cymene, 3-carene, alpha-phellandrene, alpha-pinene, alpha-terpineol, beta-bisabolene, beta-myrcene, beta-pinene, camphene, caryophyllene, eucalyptol, gamma-terpinene, humulene, terpinolene, thymol, and any combination thereof. A tequila replica can contain one or more, two or more, three or more, four or more, five or more, six or more, seven or more, eight or more, nine or more, ten or more, 12 or more, or 15 or more terpenes selected from the group consisting of 1-octene, d-limonene, linalool, linalool oxide, p-cymene, 3-carene, alpha-phellandrene, alpha-pinene, alpha-terpineol, beta-bisabolene, beta-myrcene, beta-pinene, camphene, caryophyllene, eucalyptol, gamma-terpinene, humulene, terpinolene, and thymol. For example, a tequila replica can contain one or more terpenes selected from 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol. In some cases, a tequila replica can contain alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol. In some cases, a tequila replica can contain 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol. In some cases, a tequila replica can contain 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol. The terpene(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more terpenes. The one or more terpenes can be present at any suitable amount within a tequila replica. In some cases, for example, added terpene(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs can include no terpenes.

Furans also can contribute to the flavors of an alcoholic beverage. Non-limiting examples of furans that can be included in the tequila replicas provided herein include 2-acetyl furan, furfuryl alcohol, and any combination thereof. A tequila replica provided herein can contain one or both of 2-acetyl furan and furfuryl alcohol. The furan(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more furans. The one or more furans can be present at any suitable amount within a tequila replica. In some cases, for example, added furan(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, a tequila replica can contain furans at a concentration of at least about 13.5 mg/L (e.g., at least about 15 mg/L, or at least about 20 mg/L). In some cases, the additional VOCs can include no furans.

In some cases, a tequila replica provided herein can include one or more VOCs that do not fall into the above categories. Non-limiting examples of such VOCs that can be included in the tequila replicas provided herein are dimethyl disulfide, methyl sulfide, pyridine, and any combination thereof. These VOC(s) can make up any suitable proportion of the overall additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise dimethyl disulfide, methyl sulfide, and/or pyridine. The one or more VOCs that do not fall into the above categories can be present at any suitable amount within a tequila replica. In some cases, for example, the added VOC(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, the additional VOCs do not include any compounds that are not within one of the above-described categories.

A tequila replica can include any appropriate number of additional VOCs. For example, a tequila replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) additional VOCs.

In some cases, a tequila replica can include five or more (e.g., ten or more, 15 or more, 20 or more, 25 or more, 30 or more, 35 or more, 40 or more, 45 or more 50 or more, 55 or more, 60 or more, 70 or more, 80 or more, or 90 or more) additional VOCs selected from the group consisting of acetic acid, decanoic acid, hexanoic acid, lauric acid, myristic acid, octanoic acid, propionic acid, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, p-cymene, 1-butanol, 2-acetylfuran, 2-methyl-1-butanol, 3-carene, acetol, alpha-phellandrene, alpha-pinene, alpha-terpineol, beta-bisabolene, beta-pinene, butyl acetate, camphene, caryophyllene, eucalyptol, gamma-terpinene, humulene, isoamyl butyrate, isobutyl hexanoate, isovaleraldehyde, nonanal, and terpinolene.

For example, in some cases, a tequila-like alcoholic beverage can include at least ten (e.g., ten or more, 15 or more, 20 or more, 25 or more, 30 or more, 35 or more, 40 or more, 45 or more 50 or more, or 55 or more) added VOCs, where the added VOCs are selected from the group consisting of 1-butanol, propyl alcohol, 2-acetylfuran, 2-methyl-1-butanol, isobutyl alcohol, 3-carene, isoamyl alcohol, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl butyrate, isoamyl octanoate, isobutyl acetate, isobutyl hexanoate, isoamyl hexanoate, isovaleraldehyde, lauric acid, linalool, decanoic acid, nonanal, octanoic acid, octyl acetate, p-cymene, phenethyl alcohol, terpinolene, and thymol.

In some cases, a tequila-like alcoholic beverage can include at least 10 (e.g., at least 15, at least 20, at least 25, at least 30, at least 35, at least 40, 10 to 20, 10 to 30, 10 to 40, 10 to 50, 15 to 20, 15 to 25, 15 to 30, 15 to 40, 15 to 50, 20 to 30, 20 to 40, 20 to 50, 25 to 30, 25 to 40, 25 to 50, 30 to 40, 30 to 50, or 40 to 50) added VOCs, where the added VOCs are selected from the group consisting of 1-butanol, propyl alcohol, 2-acetylfuran, 2-methyl-1-butanol, isobutyl alcohol, 3-carene, isoamyl alcohol, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl octanoate, isobutyl acetate, isobutyl hexanoate, isoamyl hexanoate, isovaleraldehyde, lauric acid, linalool, decanoic acid, nonanal, octanoic acid, octyl acetate, p-cymene, phenethyl alcohol, terpinolene, and thymol.

In some cases, a tequila-like alcoholic beverage provided herein can contain added VOCs that include one or more acids (e.g., acetic acid, hexanoic acid, lauric acid, decanoic acid, octanoic acid, or any combination thereof), one or more additional alcohols (e.g., 1-butanol, propyl alcohol, 2-methyl-1-butanol, isobutyl alcohol, isoamyl alcohol, fuselol, phenethyl alcohol, or any combination thereof), one or more aldehydes (e.g., acetal, acetaldehyde, acetoin, acetol, isovaleraldehyde, nonanal, or any combination thereof), one or more esters (e.g., butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl butyrate, isoamyl hexanoate, isoamyl octanoate, isobutyl acetate, isobutyl hexanoate, octyl acetate, or any combination thereof), one or more furans (e.g., 2-acetylfuran, furfuryl alcohol, or a combination thereof), and one or more terpenes (e.g., 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol, or any combination thereof).

In some cases, a tequila-like alcoholic beverage provided herein can contain added VOCs that include one or more acids (e.g., hexanoic acid, lauric acid, decanoic acid, octanoic acid, or any combination thereof), one or more additional alcohols (e.g., 1-butanol, propyl alcohol, 2-methyl-1-butanol, isobutyl alcohol, isoamyl alcohol, fuselol, phenethyl alcohol, or any combination thereof), one or more aldehydes (e.g., acetaldehyde, isovaleraldehyde, nonanal, or any combination thereof), one or more esters (e.g., butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, octyl acetate, or any combination thereof), one or more furans (e.g., 2-acetylfuran, furfuryl alcohol, or a combination thereof), and one or more terpenes (e.g., 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol, or any combination thereof).

For example, in some cases, a tequila replica can contain added VOCs that include hexanoic acid, lauric acid, decanoic acid, octanoic acid, 1-butanol, propyl alcohol, 2-methyl-1-butanol, isobutyl alcohol, isoamyl alcohol, fuselol, acetaldehyde, isovaleraldehyde, nonanal, butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, octyl acetate, alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, thymol, 2-acetylfuran, and furfuryl alcohol. In some cases, a tequila replica can contain added VOCs that include hexanoic acid, lauric acid, decanoic acid, octanoic acid, 1-butanol, propyl alcohol, 2-methyl-1-butanol, isobutyl alcohol, isoamyl alcohol, fuselol, acetaldehyde, isovaleraldehyde, nonanal, butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, octyl acetate, alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, thymol, 2-acetylfuran, and furfuryl alcohol. In some cases, a tequila replica can contain added VOCs that include hexanoic acid, Jauric acid, decanoic acid, octanoic acid, propyl alcohol, 2-methyl-1-butanol, isobutyl alcohol, isoamyl alcohol, fuselol, phenethyl alcohol, acetaldehyde, isovaleraldehyde, nonanal, butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, octyl acetate, 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol, 2-acetylfuran, and furfuryl alcohol. In some cases, a tequila replica can contain added VOCs that include hexanoic acid, decanoic acid, propyl alcohol, 2-methyl-1-butanol, isobutyl alcohol, isoamyl alcohol, fuselol, phenethyl alcohol, acetaldehyde, isovaleraldehyde, nonanal, butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, octyl acetate, 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, thymol, 2-acetylfuran, and furfuryl alcohol.

In some embodiments, the tequila replicas provided herein can include one or more (e.g., one, two, three, four, five, six, seven eight, nine, ten, or more than ten) VOCs that are not present in a corresponding traditional tequila. Non-limiting examples of such compounds include heptyl acetate, octyl acetate, beta-myrcene, alpha-phellandrene, D-limonene, acetaldehyde, 3-carene, gamma-terpinene, camphene, ethyl benzoate, isoamyl hexanoate, isobutyl hexanoate, beta-pinene, terpinolene, and beta-bisabolene. It is surprising that the tequila replicas described herein include one or more compounds not found in any tested traditional tequila, as it would be expected that to create a tequila replica, one would only think to use compounds found in one or more traditional tequilas. By way of example only, heptyl acetate, on its own, gives off a soapy and/or waxy character. However, in low concentrations in a tequila replica (e.g., any of the tequila replicas provided herein), it can provide an attractive character.

In some cases, the additional VOCs in a tequila replica provided herein can exclude one or more VOCs that are present in a corresponding traditional tequila. Examples of VOCs that may be excluded from the tequila replicas provided herein include, without limitation, Bois de Rose oxide, 1-octen-3-ol, 3-ethyl-4-methylpentan-1-ol, 1-octanol, alpha-3-dimethylstyrene, 1,2,4,5-tetramethylbenzene, linalool ethyl ether, cis-p-mentha-2,8-dien-1-ol, phenethyl acetate, ionone, carvacrol, 2-undecanol, methyl decanoate, (E)-beta-famesene, 1-dodecanol, calamenene, nerolidol, isoamyl decanoate, cadalene, 2,3-dihydrofarnesol, and ethyl myristate. It is surprising that the tequila replicas described herein lack one or more compounds found in every tested traditional tequila, as it would be expected that to create a tequila replica, one would believe that compounds present in every tested traditional tequila to be important to tequila flavor.

In some cases, the number of additional VOCs in a tequila replica can be fewer than the number of additional VOCs in a single corresponding reference tequila. Further, in some embodiments, the tequila replicas provided herein can lack one or more (e.g., one, two, three, four, five, ten, 15, 20, or more than 20) VOCs that are present in a corresponding traditional tequila. In some cases, the overall population of additional (non-ethanol) VOCs in a tequila replica can have less than 95% identity to the VOCs in a corresponding reference tequila (e.g., in a single type of traditionally made tequila corresponding to the replica). For example, the additional VOCs in a tequila replica can have less than 90%, less than 80%, less than 70%, less than 60%, less than 50%, less than 40%, less than 30%, less than 25%, less than 20%, or less than 15% identity to the population of VOCs in a corresponding reference tequila made by traditional methods. In some cases, a percent identity can be calculated by dividing the number of shared additional VOCs by the number of additional VOCs in the corresponding reference tequila. Some tequila replicas may contain at least 3 (e.g., at least 5, at least 10 at least 15, at least 20, at least 25, at least 30, at least 35, at least 40, at least 45, or at least 50) VOCs that are not found in a single reference tequila. Moreover, some tequila replicas may contain no more than 50 (e.g., no more than 45, 40, 35, 30, 25, 20, 15, or 10) VOCs that are present in a single reference tequila. For example, in some embodiments, a tequila replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference tequila; in some embodiments, n can be equal to 5, 6, 7, 8, 9, 10, 11, 12, 13, 14, 15, 16, 17, 18, 19, 20, 25, 30, 35, 40, 45, 50, 55, 60, 65, 70, 75, 80, or 85.

A tequila can include VOCs in any appropriate amount. For example, in some embodiments, the additional VOCs can be present in a total amount of about 100 mg/L to about 10,000 mg/L (e.g., about 100 to about 300 mg/L, about 300 to about 500 mg/L, about 500 to about 700 mg/L, about 700 to about 1000 mg/L, about 1000 to about 3000 mg/L, about 3000 to about 5000 mg/L, about 4000 to about 6000 mg/L, or about 5000 to about 10,000 mg/L).

The presence, absence, and/or amount of VOCs and non-volatile compounds in traditional tequilas and in tequila replicas can be assessed using gas chromatography/mass spectrometry (GC-MS) and liquid chromatography/mass spectrometry (LC-MS) methods as described herein. A volatile or non-volatile compound that is “not present” in a reference tequila is one that is not detected in the reference tequila using the methods set forth in Example 3. Limits of detection for various VOCs are disclosed in TABLES 2A and 2B herein.

In some embodiments, the amount of a particular VOC in a tequila replica can be an amount, based on concentration or percent composition, that is within a range 30% higher and lower than a measured amount for that VOC in a corresponding reference tequila. For example, a VOC can be present in a tequila replica in an amount that is 70 to 90%, 80 to 100%, 90 to 110%, 100 to 120%, 110 to 130%, 70 to 100%, 80 to 110%, 90 to 120%, or 100 to 130% of an amount measured for that VOC in a corresponding reference tequila.

In some embodiments, a percent composition of VOCs can be calculated by dividing the measured amount of a VOC of interest (e.g., in mg/L) by the total measured amount of VOCs (e.g., in mg/L). In some embodiments, the total measured amount of VOCs is based on the VOCs in TABLES 1B-1F. In some embodiments, the total measured amount of VOCs is based on the total measured amount of VOCs in the group that includes 1-butanol, 1-decanol, 1-octen-3-ol, 1-octene, 2,3-butanediol, 2,4,6-trimethylphenol, 2-acetylfuran, 2-heptanol, 2-methyl-1-butanol, 3-carene, 3-methylbutyraldehyde, 4-ethylguaiacol, 5-methylfurfural, acetal, acetaldehyde, acetic acid, acetoin, acetol, acetone, alpha-phellandrene, alpha-pinene, alpha-terpineol, beta-bisabolene, beta-myrcene, beta-pinene, butyl acetate, camphene, carvacrol, caryophyllene, decanoic acid, diethyl succinate, dimethyl disulfide, d-limonene, ethyl acetate, ethyl benzoate, ethyl butyrate, ethyl butyrate, ethyl decanoate, ethyl heptanoate, ethyl hexanoate, ethyl lactate, ethyl laurate, ethyl octanoate, ethyl palmitate, ethyl propionate, eucalyptol, farnesol, furfural, furfuryl alcohol, fuselol, gamma-terpinene, heptyl acetate, heptyl acetate, hexanoic acid, hexyl alcohol, humulene, isoamyl acetate, isoamyl alcohol, isoamyl butyrate, isoamyl hexanoate, isoamyl octanoate, isobutyl acetate, isobutyl alcohol, isobutyl hexanoate, isoamyl hexanoate, isovaleraldehyde, lauric acid, linalool, linalool oxide, linalyl propionate, methyl propionate, methyl sulfide, methylcyclopentenolone, myristic acid, nerolidol, nonanal, octanoic acid, octyl acetate, p-cymene, phenethyl acetate, phenethyl alcohol, phenol, piperine, propionic acid, propyl alcohol, pyridine, terpinolene, thymol, and vanillin.

In some embodiments, the total measured amount of VOCs is based on the total measured amount of VOCs in the group that includes 1-butanol, propyl alcohol, 2-acetylfuran, 2-methyl-1-butanol, isobutyl alcohol, 3-carene, isoamyl alcohol, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl butyrate, isoamyl octanoate, isobutyl acetate, isobutyl hexanoate, isoamyl hexanoate, isovaleraldehyde, lauric acid, linalool, decanoic acid, nonanal, octanoic acid, octyl acetate, p-cymene, phenethyl alcohol, terpinolene, and thymol.

In some embodiments, the total measured amount of VOCs is based on the total measured amount of VOCs in the group that includes 1-butanol, propyl alcohol, 2-acetylfuran, 2-methyl-1-butanol, isobutyl alcohol, 3-carene, isoamyl alcohol, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl octanoate, isobutyl acetate, isobutyl hexanoate, isoamyl hexanoate, isovaleraldehyde, lauric acid, linalool, decanoic acid, nonanal, octanoic acid, octyl acetate, p-cymene, phenethyl alcohol, terpinolene, and thymol. For example, the total measured amount of VOCs can be based on the total measured amount of (a) 1-butanol, propyl alcohol, 2-acetylfuran, 2-methyl-1-butanol, isobutyl alcohol, isoamyl alcohol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl octanoate, isobutyl hexanoate, isoamyl hexanoate, isovaleraldehyde, lauric acid, linalool, decanoic acid, nonanal, nonanal, octanoic acid, octyl acetate, p-cymene, terpinolene, and thymol; (b) the total amount of 1-butanol, propyl alcohol, 2-acetylfuran, 2-methyl-1-butanol, isobutyl alcohol, isoamyl alcohol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl octanoate, isoamyl hexanoate, isovaleraldehyde, lauric acid, linalool, decanoic acid, nonanal, nonanal, octanoic acid, octyl acetate, p-cymene, terpinolene, and thymol; (c) the total amount of propyl alcohol, 2-acetylfuran, 2-methyl-1-butanol, isobutyl alcohol, 3-carene, isoamyl alcohol, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl octanoate, isobutyl acetate, isobutyl hexanoate, isoamyl hexanoate, isovaleraldehyde, lauric acid, linalool, decanoic acid, nonanal, nonanal, octanoic acid, octyl acetate, p-cymene, phenethyl alcohol, terpinolene, and thymol; or (d) the total amount of propyl alcohol, 2-acetylfuran, 2-methyl-1-butanol, isobutyl alcohol, 3-carene, isoamyl alcohol, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl octanoate, isobutyl acetate, isovaleraldehyde, linalool, decanoic acid, nonanal, octyl acetate, p-cymene, phenethyl alcohol, and thymol.

In some cases, the total amount of VOCs in a tequila replica can be less than the total amount of VOCs in a corresponding reference tequila. For example, a tequila replica can have a total VOC content (in mg/L) that is less than 95% (e.g., less than 90%, 85%, 80%, 70%, 60%, 50% or 40%) of the total VOC content (in mg/L) of a corresponding reference tequila. Further, the amount of any particular VOC in a tequila replica may be different than the amount of that VOC in a corresponding reference tequila. In some cases, the amount of a VOC in a tequila replica can be 75% or less (e.g., 70% or less, 60% or less, 50% or less, 40% or less, 30% or less, 20% or less, or 10% or less), by concentration or percent mass, than the amount of the same VOC in a corresponding reference tequila. In some cases, the amount of a VOC in a tequila replica can be 125% or more (e.g., 150% or more, 200% or more, or 300% or more), by concentration or percent mass, than the amount of the same VOC in a corresponding reference tequila.

It will be understood that when both a range (or subrange) and an “at least” or “less than” amount (or percent by mass) are disclosed, these together disclose all ranges that exist in the overlap of the range (or subrange) and one of the “at least” or “less than” values in any combination. By way of example only, if 1-butanol can be present in an amount of about 0.001 mg/L to about 0.8 mg/L and the one or more additional VOCs can include 1-butanol in an amount of at least about 0.17 mg/L, then 1-butanol can be present in an amount of about 0.17 mg/L to about 0.8 mg/L (e.g., about 0.17 to about to about 0.2 mg/L, about 0.17 to about 0.4 mg/L, about 0.17 to about 0.6 mg/L, or about 0.17 to about 0.8 mg/L); 1-butanol can be present in an amount of about 0.2 mg/L to about 0.8 mg/L (e.g., about 0.2 to about 0.4 mg/L, about 0.2 to about 0.6 mg/L, or about 0.2 to about 0.8 mg/L); 1-butanol can be present in an amount of about 0.4 mg/L to about 0.8 mg/L (e.g., about 0.4 to about 0.6 mg/L, or about 0.4 to about 0.8 mg/L); or 1-butanol can be present in an amount of about 0.6 mg/L to about 0.8 mg/L. Further, it will be understood that if both a range and an “at least” or “less than” value are described for a tequila replica, the interpretation will be the largest overlap of those descriptions. For example, if a tequila replica is described with both “1-butanol can be present in an amount of about 0.001 mg/L to about 0.8 mg/L” and “the one or more additional VOCs include 1-butanol in an amount of at least about 0.17 mg/L”, the interpretation shall be that 1-butanol is present in an amount of about 0.17 mg/L to about 0.8 mg/L.

In some embodiments, the one or more VOCs in a tequila replica can include one or more compounds selected from the group consisting of 1-butanol, 1-decanol, 1-octen-3-ol, 1-octene, 2,3-butanediol, 2,4,6-trimethylphenol, 2-acetylfuran, 2-heptanol, 2-methyl-1-butanol, 3-carene, 3-methylbutyraldehyde, 4-ethylguaiacol, 5-methylfurfural, acetal, acetaldehyde, acetic acid, acetoin, acetol, acetone, alpha-phellandrene, alpha-pinene, alpha-terpineol, beta-bisabolene, beta-myrcene, beta-pinene, butyl acetate, camphene, carvacrol, caryophyllene, decanoic acid, diethyl succinate, dimethyl disulfide, d-limonene, ethyl acetate, ethyl benzoate, ethyl butyrate, ethyl butyrate, ethyl decanoate, ethyl heptanoate, ethyl hexanoate, ethyl lactate, ethyl laurate, ethyl octanoate, ethyl palmitate, ethyl propionate, eucalyptol, farnesol, furfural, furfuryl alcohol, fuselol, gamma-terpinene, heptyl acetate, heptyl acetate, hexanoic acid, hexyl alcohol, humulene, isoamyl acetate, isoamyl alcohol, isoamyl butyrate, isoamyl hexanoate, isoamyl octanoate, isobutyl acetate, isobutyl alcohol, isobutyl hexanoate, isoamyl hexanoate, isovaleraldehyde, lauric acid, linalool, linalool oxide, linalyl propionate, methyl propionate, methyl sulfide, methylcyclopentenolone, myristic acid, nerolidol, nonanal, octanoic acid, octyl acetate, p-cymene, phenethyl acetate, phenethyl alcohol, phenol, piperine, propionic acid, propyl alcohol, pyridine, terpinolene, thymol, and vanillin, in any appropriate amount.

In some cases, the one or more additional VOCs in a tequila-like alcoholic beverage can include acetic acid. The acetic acid can be present in a tequila-like alcoholic beverage in an amount of, for example, about 0.0001 wt % to about 0.03 wt % (e.g., about 0.0001 to about 0.0005 wt %, about 0.0005 to about 0.001 wt %, about 0.001 to about 0.005 wt %, about 0.005 to about 0.01 wt %, about 0.01 to about 0.02 wt %, or about 0.02 to about 0.03 wt %). In some cases, the one or more additional VOCs can include no acetic acid.

In some cases, the one or more additional VOCs in a tequila-like alcoholic beverage can include decanoic acid. The decanoic acid can be present in the rum-like alcoholic beverage at a concentration of, for example, about 11 to about 53 mg/L (e.g., about 11 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, about 45 to about 50 mg/L, or about 50 to about 53 mg/L). In some cases, the decanoic acid can be present in a tequila-like alcoholic beverage in an amount of, for example, about 0.0005 wt % to about 0.0055 wt % (e.g., about 0.0005 to about 0.0007 wt %, about 0.007 to about 0.001 wt %, about 0.001 to about 0.002 wt %, about 0.002 to about 0.003 wt %, about 0.003 to about 0.004 wt %, or about 0.004 to about 0.0055 wt %). In some cases, about 0.0055 wt % to about 5 wt % (e.g., about 0.0055 wt % to about 0.05 wt %, about 0.05 wt % to about 0.5 wt %, about 0.5 wt % to about 2 wt %, or about 2 wt % to about 5 wt %) of the one or more additional VOCs can be decanoic acid. In some cases, the one or more additional VOCs can include no decanoic acid.

In some cases, the one or more additional VOCs in a tequila-like alcoholic beverage can include hexanoic acid. The hexanoic acid can be present in the rum-like alcoholic beverage at a concentration of, for example, about 2 to about 63 mg/L (e.g., about 2 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, about 45 to about 50 mg/L, about 50 to about 55 mg/L, about 55 to about 60 mg/L, or about 60 to about 63 mg/L). In some cases, a tequila replica can contain hexanoic acid at a concentration greater than about 23 mg/L (e.g., at least about 25 mg/L, at least about 30 mg/L, at least about 40 mg/L, or at least about 50 mg/L). In some cases, the hexanoic acid can be present in a tequila-like alcoholic beverage in an amount of, for example, about 0.0001 wt % to about 0.0025 wt % (e.g., about 0.0001 to about 0.0003 wt %, about 0.0003 to about 0.0005 wt %, about 0.0005 to about 0.001 wt %, or about 0.001 to about 0.0025 wt %. In some cases, about 0.0025 wt % to about 3 wt % (e.g., about 0.0025 wt % to about 0.02 wt %, about 0.02 wt % to about 0.2 wt %, about 0.2 wt % to about 2 wt %, or about 2 wt % to about 3 wt %) of the one or more additional VOCs can be hexanoic acid. In some cases, the one or more additional VOCs can include no hexanoic acid.

In some cases, the one or more additional VOCs in a tequila-like alcoholic beverage can include lauric acid. The lauric acid can be present in the rum-like alcoholic beverage at a concentration of, for example, about 0.4 to about 30 mg/L (e.g., about 0.4 to about 5 mg/L, about 5 to about 10 mg/L, about 10 to about 15 mg/L, about 15 to about 20 mg/L, about 20 to about 25 mg/L, or about 25 to about 30 mg/L). In some cases, a tequila replica can contain lauric acid at a concentration less than about 1.9 mg/L (e.g., less than about 1.5 mg/L, less than about 1.2 mg/L, less than about 1 mg/L, or less than about 0.7 mg/L). In some cases, the lauric acid can be present in a tequila-like alcoholic beverage in an amount of, for example, about 0.0002 wt % to about 0.002% (e.g., about 0.0002 to about 0.0005 wt %, about 0.0005 to about 0.0008 wt %, about 0.0008 to about 0.001 wt %, or about 0.001 to about 0.002 wt %). In some cases, about 0.002 wt % to about 3 wt % (e.g., about 0.002 wt % to about 0.02 wt %, about 0.02 wt % to about 0.2 wt %, about 0.2 wt % to about 2 wt %, or about 2 wt % to about 3 wt %) of the one or more additional VOCs can be lauric acid. In some cases, the one or more additional VOCs can include no lauric acid.

In some cases, the one or more additional VOCs in a tequila-like alcoholic beverage can include myristic acid. The myristic acid can be present in a tequila-like alcoholic beverage in an amount of, for example, about 0.0001 wt % to about 0.00042 wt % (e.g., from about 0.0001 to about 0.0002 wt %, about 0.0002 to about 0.0003 wt %, or about 0.0003 to about 0.00042 wt %). In some cases, the one or more additional VOCs can include no myristic acid.

In some cases, the one or more additional VOCs in a tequila-like alcoholic beverage can include octanoic acid. The octanoic acid can be present in the rum-like alcoholic beverage at a concentration of, for example, about 2 to about 46 mg/L (e.g., about 2 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 35 to about 40 mg/L, or about 40 to about 46 mg/L). In some cases, a tequila replica can contain octanoic acid at a concentration less than about 5 mg/L (e.g., less than about 4 mg/L, or less than about 3 mg/L). In some cases, the octanoic acid can be present in a tequila-like alcoholic beverage in an amount of, for example, about 0.0003 wt % to about 0.0045 wt % (e.g., about 0.0003 to about 0.0005 wt %, about 0.0005 to about 0.0008 wt %, about 0.0008 to about 0.001 wt %, about 0.001 to about 0.002 wt %, about 0.002 to about 0.003 wt %, or about 0.003 to about 0.0045 wt %). In some cases, about 0.0045 wt % to about 5 wt % (e.g., about 0.0045 wt % to about 0.04 wt %, about 0.04 wt % to about 0.4 wt %, about 0.4 wt % to about 2 wt %, or about 2 wt % to about 5 wt %) of the one or more additional VOCs can be octanoic acid. In some cases, less than about 0.0013 wt % (e.g., less than about 0.001 wt %, less than about 0.0008 wt %, or less than about 0.0005 wt %) of the one or more additional VOCs is octanoic acid. In some cases, the one or more additional VOCs can include no octanoic acid.

In some cases, the one or more additional VOCs in a tequila-like alcoholic beverage can include propionic acid. The propionic acid can be present in a tequila-like alcoholic beverage in an amount of, for example, about 0.000001% to about 0.00016 wt % (e.g., about 0.000001 to about 0.000005 wt %, about 0.000005 to about 0.00001 wt %, about 0.00001 to about 0.00005 wt %, about 0.00005 to about 0.0001 wt %, or about 0.0001 to about 0.00016 wt %). In some cases, the one or more additional VOCs can include no propionic acid.

In some cases, the one or more additional VOCs in a tequila-like alcoholic beverage can include 2-methyl-1-butanol. The 2-methyl-1-butanol can be present in the rum-like alcoholic beverage at a concentration of, for example, about 112 to about 931 mg/L (e.g., about 112 to about 200 mg/L, about 200 to about 300 mg/L, about 300 to about 400 mg/L, about 400 to about 500 mg/L, about 500 to about 600 mg/L, about 600 to about 700 mg/L, about 700 to about 800 mg/L, about 800 to about 900 mg/L, or about 900 to about 931 mg/L). In some cases, the 2-methyl-1-butanol can be present in a tequila-like alcoholic beverage in an amount of, for example, about 0.00002 wt % to about 0.035 wt % (e.g., about 0.00002 to about 0.00005 wt %, about 0.00005 to about 0.0001 wt %, about 0.0001 to about 0.0005 wt %, about 0.0005 to about 0.001 wt %, about 0.001 to about 0.005 wt %, about 0.005 to about 0.01 wt %, about 0.01 to about 0.02 wt %, or about 0.02 to about 0.035 wt %). In some cases, about 0.035 wt % to about 60 wt % (e.g., about 0.035 wt % to about 0.3 wt %, about 0.3 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, or about 55 wt % to about 60 wt %) of the one or more additional VOCs can be 2-methyl-1-butanol. In some cases, the one or more additional VOCs can include no 2-methyl-1-butanol.

In some cases, the one or more additional VOCs in a tequila-like alcoholic beverage can include 1-decanol. The 1-decanol can be present in a tequila-like alcoholic beverage in an amount of, for example, about 0.00004 wt % to about 0.0003 wt % (e.g., about 0.00004 to about 0.00007 wt %, about 0.00007 to about 0.0001 wt %, about 0.0001 to about 0.0002 wt %, or about 0.0002 to about 0.0003 wt %. In some cases, the one or more additional VOCs can include no 1-decanol.

In some cases, the one or more additional VOCs in a tequila-like alcoholic beverage can include 1-octen-3-ol. The 1-octen-3-ol can be present in a tequila-like alcoholic beverage in an amount of, for example, about 0.000025 wt % to about 0.00011 wt % (e.g., about 0.000025 to about 0.00005 wt %, about 0.00005 to about 0.000075 wt %, or about 0.000075 to about 0.00011 wt %). In some cases, the one or more additional VOCs can include no 1-octen-3-ol.

In some cases, the one or more additional VOCs in a tequila-like alcoholic beverage can include 2-heptanol. The 2-heptanol can be present in a tequila-like alcoholic beverage in an amount of, for example, about 0.00005 wt % to about 0.00021 wt % (e.g., about 0.00005 to about 0.000075 wt %, about 0.000075 to about 0.0001 wt %, about 0.0001 to about 0.00015 wt %, or about 0.00015 to about 0.00021 wt %). In some cases, the one or more additional VOCs can include no 2-heptanol.

In some cases, the one or more additional VOCs in a tequila-like alcoholic beverage can include 2,3-butanediol. The 2,3-butanediol can be present in a tequila-like alcoholic beverage in an amount of, for example, about 0.00008 wt % to about 0.00032% (e.g., about 0.00008 to about 0.00012 wt %, about 0.00012 to about 0.00018 wt %, about 0.00018 to about 0.00025 wt %, or about 0.00025 to about 0.00032 wt %). In some cases, the one or more additional VOCs can include no 2,3-butanediol.

In some cases, the one or more additional VOCs in a tequila-like alcoholic beverage can include 2,4,6-trimethylphenol. The 2,4,6-trimethylphenol can be present in a tequila-like alcoholic beverage in an amount of, for example, about 0.00007 wt % to about 0.00016 wt % (e.g., about 0.00007 to about 0.00008 wt %, about 0.00008 to about 0.00009 wt %, about 0.00009 to about 0.0001 wt %, about 0.0001 to about 0.00013 wt %, or about 0.00013 to about 0.00016 wt %). In some cases, the one or more additional VOCs can include no 2,4,6-trimethylphenol.

In some cases, the one or more additional VOCs in a tequila-like alcoholic beverage can include 4-ethylguaiacol alcohol. The 4-ethylguaiacol can be present in a tequila-like alcoholic beverage in an amount of, for example, about 0.000005 wt % to about 0.000022 wt % (e.g., about 0.000005 to about 0.00001 wt %, about 0.00001 to about 0.000015 wt %, or about 0.000015 to about 0.000022 wt %). In some cases, the one or more additional VOCs can include no 4-ethylguaiacol.

In some cases, the one or more additional VOCs in a tequila-like alcoholic beverage can include carvacrol. The carvacrol can be present in a tequila-like alcoholic beverage in an amount of, for example, about 0.00006 wt % to about 0.00013 wt % (e.g., about 0.00006 to about 0.00008 wt %, about 0.00008 to about 0.0001 wt %, about 0.0001 to about 0.00011 wt %, about 0.00011 to about 0.00012 wt %, or about 0.00012 to about 0.00013 wt %. In some cases, the one or more additional VOCs can include no carvacrol.

In some cases, the one or more additional VOCs in a tequila-like alcoholic beverage can include farnesol. The farnesol can be present in a tequila-like alcoholic beverage in an amount of, for example, about 0.00005 wt % to about 0.00021 wt % (e.g., about 0.00005 to about 0.000075 wt %, about 0.000075 to about 0.0001 wt %, about 0.0001 to about 0.00015 wt %, or about 0.00015 to about 0.00021 wt %). In some cases, the one or more additional VOCs can include no famesol.

In some cases, the one or more additional VOCs in a tequila-like alcoholic beverage can include furfuryl alcohol. The furfuryl alcohol can be present in the rum-like alcoholic beverage at a concentration of, for example, about 0.5 to about 15 mg/L (e.g., about 0.5 to about 2 mg/L, about 2 to about 4 mg/L, about 4 to about 6 mg/L, about 6 to about 8 mg/L, about 8 to about 10 mg/L, about 10 to about 12 mg/L, about 12 to about 14 mg/L, or about 14 to about 15 mg/L). In some cases, a tequila replica can contain furfuryl alcohol at a concentration greater than about 8.5 mg/L (e.g., at least about 9 mg/L, at least about 10 mg/L, at least about 12 mg/L, or at least about 14 mg/L). In some cases, the furfuryl alcohol can be present in a tequila-like alcoholic beverage in an amount of, for example, about 0.00115 wt % to about 0.0017 wt % (e.g., about 0.00115 to about 0.00125 wt %, about 0.00125 to about 0.0014 wt %, about 0.0014 to about 0.0015 wt %, or about 0.0015 to about 0.0017 wt %. In some cases, about 0.0017 wt % to about 1 wt % (e.g., about 0.0017 wt % to about 0.01 wt %, about 0.01 wt % to about 0.1 wt %, or about 0.1 wt % to about 1 wt %) of the one or more additional VOCs can be furfuryl alcohol. In some cases, greater than about 0.0086 wt % (e.g., at least about 0.01 wt %, at least about 0.05 wt %, at least about 0.1 wt %, or at least about 0.5 wt %) of the one or more additional VOCs is furfuryl alcohol. In some cases, the one or more additional VOCs can include no furfuryl alcohol.

In some cases, the one or more additional VOCs in a tequila-like alcoholic beverage can include hexyl alcohol. The hexyl alcohol can be present in a tequila-like alcoholic beverage in an amount of, for example, about 0.0001 wt % to about 0.00035 wt % (e.g., about 0.0001 to about 0.00015 wt %, about 0.00015 to about 0.0002 wt %, about 0.0002 to about 0.00025 wt %, about 0.00025 to about 0.0003 wt %, or about 0.0003 to about 0.00035 wt %). In some cases, the one or more additional VOCs can include no hexyl alcohol.

In some cases, the one or more additional VOCs in a tequila-like alcoholic beverage can include isoamyl alcohol. The isoamyl alcohol can be present at a concentration of, for example, about 4 to about 873 mg/L (e.g. about 4 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, about 400 to about 450 mg/L, about 450 to about 500 mg/L, about 500 to about 550 mg/L, about 550 to about 600 mg/L, about 600 to about 650 mg/L, about 650 to about 700 mg/L, about 700 to about 750 mg/L, about 750 to about 800 mg/L, about 800 to about 850 mg/L, or about 850 to about 873 mg/L). In some cases, a tequila replica can contain isoamyl alcohol at a concentration less than about 100 mg/L (e.g., less than about 80 mg/L, less than about 50 mg/L, less than about 30 mg/L, or less than about 10 mg/L). In some cases, the isoamyl alcohol can be present in a tequila-like alcoholic beverage in an amount of, for example, about 0.0005 wt % to about 0.051 wt % (e.g., about 0.0005 to about 0.001 wt %, about 0.001 to about 0.005 wt %, about 0.005 to about 0.01 wt %, or about 0.01 to about 0.025 wt %, or about 0.025 to about 0.051 wt %). In some cases, about 0.051 wt % to about 60 wt % (e.g. about 0.051 wt % to about 0.3 wt %, about 0.3 wt % to about 10 wt %, about 10 wt % to about 20 wt %, about 20 wt % to about 30 wt %, about 30 wt % to about 40 wt %, about 40 wt % to about 50 wt %, or about 50 wt % to about 60 wt %) of the one or more additional VOCs can be isoamyl alcohol. In some cases, less than about 0.03 wt % (e.g., less than about 0.01 wt %, less than about 0.005 wt %, or less than about 0.001 wt %) of the one or more additional VOCs is isoamyl alcohol. In some cases, the one or more additional VOCs can include no isoamyl alcohol.

In some cases, the one or more additional VOCs in a tequila-like alcoholic beverage can include isobutyl alcohol. The isobutyl alcohol can be present at a concentration of, for example, about 45 to about 5600 mg/L (e.g. about 45 to about 250 mg/L, about 250 to about 500 mg/L, about 500 to about 1000 mg/L, about 1000 to about 1500 mg/L, about 1500 to about 2000 mg/L, about 2000 to about 2500 mg/L, about 2500 to about 3000 mg/L, about 3000 to about 4000 mg/L, about 4000 to about 5000 mg/L, or about 5000 to about 5600 mg/L). In some cases, a tequila replica can contain isobutyl alcohol at a concentration greater than about 650 mg/L (e.g., at least about 750 mg/L, at least about 1000 mg/L, at least about 2500 mg/L, or at least about 5000 mg/L). In some cases, about 1 wt % to about 100 wt % (e.g. about 1 wt % to about 10 wt %, about 10 wt % to about 20 wt %, about 20 wt % to about 30 wt %, about 30 wt % to about 40 wt %, about 40 wt % to about 50 wt %, about 50 wt % to about 60 wt %, about 60 wt % to about 70 wt %, about 70 wt % to about 80 wt %, about 80 wt % to about 90 wt %, or about 90 wt % to about 100 wt %) of the one or more additional VOCs can be isobutyl alcohol. In some cases, greater than about 0.52 wt % (at least about 1 wt %, at least about 10 wt %, at least about 25 wt %, or at least about 50 wt %) of the one or more additional VOCs is isobutyl alcohol. In some cases, the one or more additional VOCs can include no isobutyl alcohol.

In some cases, the one or more additional VOCs in a tequila-like alcoholic beverage can include phenethyl alcohol. The phenethyl alcohol can be present in the rum-like alcoholic beverage at a concentration of, for example, about 12 to about 49 mg/L (e.g., about 12 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, or about 45 to about 49 mg/L). In some cases, the phenethyl alcohol can be present in a tequila-like alcoholic beverage in an amount of, for example, about 0.004 wt % to about 0.016 wt % (e.g., about 0.004 to about 0.008 wt %, about 0.008 to about 0.012 wt %, or about 0.012 to about 0.016 wt %). In some cases, about 0.016 wt % to about 5 wt % (e.g., about 0.016 wt % to about 0.1 wt %, about 0.1 wt % to about 1 wt %, about 1 wt % to about 3 wt %, or about 3 wt % to about 5 wt %) of the one or more additional VOCs can be phenethyl alcohol. In some cases, the one or more additional VOCs can include no phenethyl alcohol.

In some cases, the one or more additional VOCs in a tequila-like alcoholic beverage can include phenol. The phenol can be present in a tequila-like alcoholic beverage in an amount of, for example, about 0.0001 wt % to about 0.00042 wt % (e.g., about 0.0001 to about 0.0002 wt %, about 0.0002 to about 0.0003 wt %, or about 0.0003 to about 0.0004 wt %). In some cases, the one or more additional VOCs can include no phenol.

In some cases, the one or more additional VOCs in a tequila-like alcoholic beverage can include propyl alcohol. The propyl alcohol can be present at a concentration of, for example, about 167 to about 617 mg/L (e.g. about 167 to about 200 mg/L, about 200 to about 250 mg/L, about 250 to about 300 mg/L, about 300 to about 350 mg/L, about 350 to about 400 mg/L, about 400 to about 450 mg/L, about 450 to about 500 mg/L, about 500 to about 550 mg/L, about 550 to about 600 mg/L, or about 600 to about 617 mg/L). In some cases, the propyl alcohol can be present in a tequila-like alcoholic beverage in an amount of, for example, about 0.00006 wt % to about 0.02 wt % (e.g., about 0.00006 to about 0.0001 wt %, about 0.0001 to about 0.0005 wt %, about 0.0005 to about 0.001 wt %, about 0.001 to about 0.005 wt %, about 0.005 to about 0.01 wt %, or about 0.01 to about 0.02 wt %. In some cases, about 0.02 wt % to about 50 wt % (e.g. about 0.02 wt % to about 3 wt %, about 3 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, or about 45 wt % to about 50 wt %) of the one or more additional VOCs can be propyl alcohol. In some cases, the one or more additional VOCs can include no propyl alcohol.

In some cases, the one or more additional VOCs in a tequila-like alcoholic beverage can include thymol. The thymol can be present in the rum-like alcoholic beverage at a concentration of, for example, about 0.02 to about 9 mg/L (e.g., about 0.02 to about 0.2 mg/L, about 0.2 to about 2 mg/L, about 2 to about 4 mg/L, about 4 to about 6 mg/L, about 6 to about 8 mg/L, or about 8 to about 9 mg/L). In some cases, a tequila replica can contain thymol at a concentration greater than about 0.5 mg/L (e.g., at least about 0.8 mg/L, at least about 1 mg/L, at least about 3 mg/L, at least about 5 mg/L, or at least about 7 mg/L). In some cases, the thymol can be present in a tequila-like alcoholic beverage in an amount of, for example, about 0.00001 wt % to about 0.00032 wt % (e.g., about 0.00001 to about 0.00005 wt %, about 0.00005 to about 0.0001 wt %, about 0.0001 to about 0.0002 wt %, or about 0.0002 to about 0.0003 wt %). In some cases, about 0.0003 wt % to about 0.7 wt % (e.g., about 0.0003 wt % to about 0.003 wt %, about 0.003 wt % to about 0.03 wt %, about 0.03 wt % to about 0.3 wt %, or about 0.3 wt % to about 0.7 wt %) of the one or more additional VOCs can be thymol. In some cases, greater than about 0.00053 wt % (e.g., at least about 0.001 wt %, at least about 0.01 wt %, at least about 0.05 wt %, or at least about 0.1 wt %) of the one or more additional VOCs is thymol. In some cases, the one or more additional VOCs can include no thymol. In some cases, the one or more additional VOCs in a tequila-like alcoholic beverage can include nerolidol. The nerolidol can be present in a tequila-like alcoholic beverage in an amount of, for example, about 0.00007 wt % to about 0.00028 wt % (e.g., about 0.00007 to about 0.0001 wt %, about 0.0001 to about 0.00016 wt %, about 0.00016 to about 0.00022 wt %, or about 0.00022 to about 0.00028 wt %). In some cases, the one or more additional VOCs can include no nerolidol.

In some cases, the one or more additional VOCs in a tequila-like alcoholic beverage can include 3-methylbutyraldehyde. The 3-methylbutyraldehyde can be present in a tequila-like alcoholic beverage in an amount of, for example, about 0.00003 wt % to about 0.000045 wt % (e.g., about 0.00003 to about 0.000033 wt %, about 0.000033 to about 0.000036 wt %, about 0.000036 to about 0.000039 wt %, about 0.000039 to about 0.000042 wt %, or about 0.000042 to about 0.000045 wt %). In some cases, the one or more additional VOCs can include no 3-methylbutyraldehyde.

In some cases, the one or more additional VOCs in a tequila-like alcoholic beverage can include 5-methylfurfural. The 5-methylfrufural can be present in a tequila-like alcoholic beverage in an amount of, for example, about 0.00008 wt % to about 0.00033 wt % (e.g., about 0.00008 to about 0.00013 wt %, about 0.00013 to about 0.00018 wt %, about 0.00018 to about 0.00023 wt %, about 0.00023 to about 0.00028 wt %, or about 0.00028 to about 0.00033 wt %). In some cases, the one or more additional VOCs can include no 5-methylfurfural.

In some cases, the one or more additional VOCs in a tequila-like alcoholic beverage can include acetal. The acetal can be present in a tequila-like alcoholic beverage in an amount of, for example, about 0.0001 wt % to about 0.0055 wt % (e.g., about 0.0001 to about 0.0005 wt %, about 0.0005 to about 0.0008 wt %, about 0.0008 to about 0.001 wt %, about 0.001 to about 0.003 wt %, or about 0.003 to about 0.0055 wt %). In some cases, the one or more additional VOCs can include no acetal.

In some cases, the one or more additional VOCs in a tequila-like alcoholic beverage can include acetaldehyde. The acetaldehyde can be present in the rum-like alcoholic beverage at a concentration of, for example, about 3 to about 32 mg/L (e.g., about 3 to about 6 mg/L, about 6 to about 8 mg/L, about 8 to about 10 mg/L, about 10 to about 12 mg/L, about 12 to about 14 mg/L, about 14 to about 16 mg/L, about 16 to about 18 mg/L, about 18 to about 20 mg/L, about 20 to about 22 mg/L, about 22 to about 24 mg/L, about 24 to about 26 mg/L, about 26 to about 28 mg/L, about 28 to about 30 mg/L, or about 30 to about 32 mg/L). In some cases, the acetaldehyde can be present in a tequila-like alcoholic beverage in an amount of, for example, about 0.001 wt % to about 0.0052 wt % (e.g., about 0.001 to about 0.002 wt %, about 0.002 to about 0.003 wt %, about 0.003 to about 0.004 wt %, or about 0.004 to about 0.0052 wt %). In some cases, about 0.0052 wt % to about 2 wt % (e.g., about 0.0052 wt % to about 0.05 wt %, about 0.05 wt % to about 0.5 wt %, or about 0.5 wt % to about 2 wt %) of the one or more additional VOCs can be acetaldehyde. In some cases, the one or more additional VOCs can include no acetaldehyde.

In some cases, the one or more additional VOCs in a tequila-like alcoholic beverage can include furfural. The furfural can be present in a tequila-like alcoholic beverage in an amount of, for example, about 0.0003 wt % to about 0.0022 wt % (e.g., about 0.0003 to about 0.0005 wt %, about 0.0005 to about 0.0008 wt %, about 0.0008 to about 0.001 wt %, about 0.001 to about 0.0015 wt %, or about 0.0015 to about 0.0022 wt %). In some cases, the one or more additional VOCs can include no furfural.

In some cases, the one or more additional VOCs in a tequila-like alcoholic beverage can include vanillin. The vanillin can be present in a tequila-like alcoholic beverage in an amount of, for example, about 0.0001 wt % to about 0.00053 wt % (e.g., about 0.0001 to about 0.0002 wt %, about 0.0002 to about 0.0003 wt %, about 0.0003 to about 0.0004 wt %, or about 0.0004 to about 0.00053 wt %). In some cases, the one or more additional VOCs can include no vanillin.

In some cases, the one or more additional VOCs in a tequila-like alcoholic beverage can include diethyl succinate. The diethyl succinate can be present in the rum-like alcoholic beverage at a concentration of, for example, about 0.02 to about 8 mg/L (e.g., about 0.02 to about 0.2 mg/L, about 0.2 to about 2 mg/L, about 2 to about 4 mg/L, about 4 to about 6 mg/L, or about 6 to about 8 mg/L). In some cases, a tequila replica can contain diethyl succinate at a concentration greater than about 2.3 mg/L (e.g., at least about 2.5 mg/L, at least about 3 mg/L, at least about 5 mg/L, or at least about 7 mg/L). In some cases, the diethyl succinate can be present in a tequila-like alcoholic beverage in an amount of, for example, about 0.00045 wt % to about 0.00075 wt % (e.g., about 0.00045 to about 0.00055 wt %, about 0.00055 to about 0.00065 wt %, or about 0.00065 to about 0.00075 wt %). In some cases, about 0.00075 wt % to about 0.7 wt % (e.g., about 0.00075 wt % to about 0.007 wt %, about 0.007 wt % to about 0.07 wt %, or about 0.07 wt % to about 0.7 wt %) of the one or more additional VOCs can be diethyl succinate. In some cases, greater than about 0.0023 wt % (e.g., at least about 0.005 wt %, at least about 0.01 wt %, at least about 0.1 wt %, or at least about 0.5 wt %) of the one or more additional VOCs is diethyl succinate. In some cases, the one or more additional VOCs can include no diethyl succinate.

In some cases, the one or more additional VOCs in a tequila-like alcoholic beverage can include ethyl acetate. The ethyl acetate can be present in the rum-like alcoholic beverage at a concentration of, for example, about 17 to about 266 mg/L (e.g., about 17 to about 40 mg/L, about 40 to about 60 mg/L, about 60 to about 80 mg/L, about 80 to about 100 mg/L, about 100 to about 120 mg/L, about 120 to about 140 mg/L, about 140 to about 160 mg/L, about 160 to about 180 mg/L, about 180 to about 200 mg/L, about 200 to about 220 mg/L, about 220 to about 240 mg/L, about 240 to about 260 mg/L, or about 260 to about 266 mg/L). In some cases, the ethyl acetate can be present in a tequila-like alcoholic beverage in an amount of, for example, about 0.0015 wt % to about 0.009 wt % (e.g., about 0.0015 to about 0.0025 wt %, about 0.0025 to about 0.005 wt %, about 0.005 to about 0.007 wt %, or about 0.007 to about 0.009 wt %). In some cases, about 0.009 wt % to about 23 wt % (e.g., about 0.009 wt % to about 0.09 wt %, about 0.09 wt % to about 0.9 wt %, about 0.9 wt % to about 2 wt %, about 2 wt % to about 4 wt %, about 4 wt % to about 6 wt %, about 6 wt % to about 8 wt %, about 8 wt % to about 10 wt %, about 10 wt % to about 12 wt %, about 12 wt % to about 14 wt %, about 14 wt % to about 16 wt %, about 16 wt % to about 18 wt %, about 18 wt % to about 20 wt %, about 20 wt % to about 22 wt %, or about 22 wt % to about 23 wt %) of the one or more additional VOCs can be ethyl acetate. In some cases, the one or more additional VOCs can include no ethyl acetate.

In some cases, the one or more additional VOCs in a tequila-like alcoholic beverage can include ethyl benzoate. The ethyl benzoate can be present in the rum-like alcoholic beverage at a concentration of, for example, about 0.01 to about 0.1 mg/L. In some cases, the ethyl benzoate can be present in a tequila-like alcoholic beverage in an amount of, for example, about 0.00001 wt % to about 0.000055 wt % (e.g., about 0.00001 to about 0.00002 wt %, about 0.00002 to about 0.00003 wt %, about 0.00003 to about 0.00004 wt %, or about 0.00004 to about 0.000055 wt %). In some cases, about 0.000055 wt % to about 0.01 wt % (e.g., about 0.000055 wt % to about 0.0005 wt %, about 0.0005 wt % to about 0.005 wt %, or about 0.005 wt % to about 0.01 wt) of the one or more additional VOCs can be ethyl benzoate. In some cases, the one or more additional VOCs can include no ethyl benzoate.

In some cases, the one or more additional VOCs in a tequila-like alcoholic beverage can include ethyl butyrate. The ethyl butyrate can be present in the rum-like alcoholic beverage at a concentration of, for example, about 0.06 to about 12 mg/L (e.g., about 0.06 wt % to about 0.6 wt %, about 0.6 wt % to about 2 wt %, about 2 to about 4 mg/L, about 4 to about 6 mg/L, about 6 to about 8 mg/L, about 8 to about 10 mg/L, or about 10 to about 12 mg/L). In some cases, a tequila replica can contain ethyl butyrate at a concentration greater than about 1.6 mg/L (e.g., at least about 2 mg/L, at least about 4 mg/L, at least about 7 mg/L, or at least about 10 mg/L). In some cases, the ethyl butyrate can be present in a tequila-like alcoholic beverage in an amount of, for example, about 0.0005 wt % to about 0.0022 wt % (e.g., about 0.0005 to about 0.0008 wt %, about 0.0008 to about 0.001 wt %, about 0.001 to about 0.0015 wt %, or about 0.0015 to about 0.0022 wt %). In some cases, about 0.0022 wt % to about 1 wt % (e.g., about 0.0022 wt % to about 0.02 wt %, about 0.02 wt % to about 0.2 wt %, or about 0.2 wt % to about 1 wt %) of the one or more additional VOCs can be ethyl butyrate. In some cases, greater than about 0.0017 wt % (e.g., at least about 0.005 wt %, at least about 0.01 wt %, at least about 0.05 wt %, at least about 0.1 wt %, or at least about 0.5 wt %) of the one or more additional VOCs is ethyl butyrate. In some cases, the one or more additional VOCs can include no ethyl butyrate.

In some cases, the one or more additional VOCs in a tequila-like alcoholic beverage can include ethyl decanoate. The ethyl decanoate can be present in the rum-like alcoholic beverage at a concentration of, for example, about 0.0007 to about 2 mg/L (e.g., about 0.0007 to about 0.007 mg/L, about 0.007 to about 0.07 mg/L, about 0.07 to about 0.7 mg/L, or about 0.7 to about 2 mg/L). In some cases, a tequila replica can contain ethyl decanoate at a concentration less than about 0.007 mg/L (e.g., less than about 0.003 mg/L, less than about 0.001 mg/L, or less than about 0.0008 mg/L). In some cases, about 0.00001 wt % to 0.0001 wt % of the one or more additional VOCs can be ethyl decanoate. In some cases, the ethyl decanoate can be present in a tequila-like alcoholic beverage in an amount of, for example, about 0.0001 wt % to about 0.001 wt % (e.g., about 0.0001 to about 0.0003 wt %, about 0.0003 to about 0.0005 wt %, about 0.0005 to about 0.0007 wt %, about 0.0007 to about 0.0008 wt %, or about 0.0008 to about 0.001 wt %). In some cases, about 0.001 wt % to about 0.2 wt % (e.g., about 0.001 wt % to about 0.01 wt % or about 0.01 wt % to about 0.2 wt %) of the one or more additional VOCs can be ethyl decanoate. In some cases, less than about 0.0000017 wt % (e.g., less than about 0.000001 wt %, or less than about 0.0000001 wt %) of the one or more additional VOCs is ethyl decanoate. In some cases, the one or more additional VOCs can include no ethyl decanoate.

In some cases, the one or more additional VOCs in a tequila-like alcoholic beverage can include ethyl heptanoate. The ethyl heptanoate can be present in a tequila-like alcoholic beverage in an amount of, for example, about 0.000018 wt % to about 0.000074 wt % (e.g., about 0.000018 to about 0.000032 wt %, about 0.000032 to about 0.000046 wt %, about 0.000046 to about 0.000062 wt %, or about 0.000062 to about 0.000074 wt %). In some cases, the one or more additional VOCs can include no ethyl heptanoate.

In some cases, the one or more additional VOCs in a tequila-like alcoholic beverage can include ethyl hexanoate. The ethyl hexanoate can be present in the rum-like alcoholic beverage at a concentration of, for example, about 0.06 to about 1 mg/L (e.g., about 0.06 to about 0.6 or about 0.6 to about 1 mg/L). In some cases, the ethyl hexanoate can be present in a tequila-like alcoholic beverage in an amount of, for example, about 0.000018 wt % to about 0.000074 wt % (e.g., about 0.000018 to about 0.000032 wt %, about 0.000032 to about 0.000046 wt %, about 0.000046 to about 0.000062 wt %, or about 0.000062 to about 0.000074 wt %). In some cases, about 0.000074 wt % to about 0.1 wt % (e.g., about 0.000074 wt % to about 0.0007 wt %, about 0.0007 wt % to about 0.007 wt %, about 0.007 wt % to about 0.07 wt %, or about 0.07 wt % to about 0.1 wt %) of the one or more additional VOCs can be ethyl hexanoate. In some cases, the one or more additional VOCs can include no ethyl hexanoate.

In some cases, the one or more additional VOCs in a tequila-like alcoholic beverage can include ethyl lactate. The ethyl lactate can be present in the rum-like alcoholic beverage at a concentration of, for example, about 1 to about 204 mg/L (e.g., about 1 to about 20 mg/L, about 20 to about 40 mg/L, about 40 to about 60 mg/L, about 60 to about 80 mg/L, about 80 to about 100 mg/L, about 100 to about 120 mg/L, about 120 to about 140 mg/L, about 140 to about 160 mg/L, about 160 to about 180 mg/L, about 180 to about 200 mg/L, or about 200 to about 204 mg/L). In some cases, the ethyl lactate can be present in a tequila-like alcoholic beverage in an amount of, for example, about 0.0003 wt % to about 0.0016 wt % (e.g., about 0.0003 to about 0.0005 wt %, about 0.0005 to about 0.0008 wt %, about 0.0008 to about 0.001 wt %, about 0.001 to about 0.0013 wt %, or about 0.0013 to about 0.0016 wt %). In some cases, about 0.0016 wt % to about 18 wt % (e.g., about 0.0016 wt % to about 0.01 wt %, about 0.01 wt % to about 0.1 wt %, about 0.1 wt % to about 2 wt %, about 2 wt % to about 4 wt %, about 4 wt % to about 6 wt %, about 6 wt % to about 8 wt %, about 8 wt % to about 10 wt %, about 10 wt % to about 12 wt %, about 12 wt % to about 14 wt %, about 14 wt % to about 16 wt %, or about 16 wt % to about 18 wt %) of the one or more additional VOCs can be ethyl lactate. In some cases, the one or more additional VOCs can include no ethyl lactate.

In some cases, the one or more additional VOCs in a tequila-like alcoholic beverage can include ethyl laurate. The ethyl laurate can be present in the rum-like alcoholic beverage at a concentration of, for example, about 0.06 to about 0.7 mg/L. In some cases, the ethyl laurate can be present in a tequila-like alcoholic beverage in an amount of, for example, about 0.00007 wt % to about 0.001 wt % (e.g., about 0.00007 to about 0.0001 wt %, about 0.0001 to about 0.0005 wt %, about 0.0005 to about 0.0008 wt %, or about 0.0008 to about 0.001 wt %). In some cases, about 0.001 wt % to about 0.07 wt % (e.g., about 0.001 wt % to about 0.01 wt %, or about 0.01 wt % to about 0.07 wt %) of the one or more additional VOCs can be ethyl laurate. In some cases, the one or more additional VOCs can include no ethyl laurate.

In some cases, the one or more additional VOCs in a tequila-like alcoholic beverage can include ethyl octanoate. The ethyl octanoate can be present in the rum-like alcoholic beverage at a concentration of, for example, about 0.2 to about 12 mg/L (e.g., about 0.2 to about 2 mg/L, about 2 to about 4 mg/L, about 4 to about 6 mg/L, about 6 to about 8 mg/L, about 8 to about 10 mg/L, or about 10 to about 12 mg/L). In some cases, a tequila replica can contain ethyl octanoate at a concentration greater than about 8 mg/L (e.g., at least about 9 mg/L, at least about 10 mg/L, or at least about 11 mg/L). In some cases, the ethyl octanoate can be present in a tequila-like alcoholic beverage in an amount of, for example, about 0.0001 wt % to about 0.00045 wt % (e.g., about 0.0001 to about 0.0002 wt %, about 0.0002 to about 0.0003 wt %, about 0.0003 to about 0.0004 wt %, or about 0.0004 to about 0.00045 wt %). In some cases, about 0.00045 wt % to about 0.5 wt % (e.g., about 0.00045 wt % to about 0.004 wt %, about 0.004 wt % to about 0.04 wt %, or about 0.04 wt % to about 0.5 wt %) of the one or more additional VOCs can be ethyl octanoate. In some cases, the one or more additional VOCs can include no ethyl octanoate.

In some cases, the one or more additional VOCs in a tequila-like alcoholic beverage can include ethyl palmitate. The ethyl palmitate can be present in a tequila-like alcoholic beverage in an amount of, for example, about 0.0001 wt % to about 0.00042 wt % (e.g., about 0.0001 to about 0.0002 wt %, about 0.0002 to about 0.0003 wt %, or about 0.0003 to about 0.0004 wt %). In some cases, the one or more additional VOCs can include no ethyl palmitate.

In some cases, the one or more additional VOCs in a tequila-like alcoholic beverage can include ethyl propionate. The ethyl propionate can be present in the rum-like alcoholic beverage at a concentration of, for example, about 0.09 to about 10 mg/L (e.g., about 0.09 to about 0.9 mg/L, about 0.9 to about 2 mg/L, about 2 to about 4 mg/L, about 4 to about 6 mg/L, about 6 to about 8 mg/L, or about 8 to about 10 mg/L). In some cases, the ethyl propionate can be present in a tequila-like alcoholic beverage in an amount of, for example, about 0.0002 wt % to about 0.0055 wt % (e.g., about 0.0002 to about 00005 wt %, about 0.0005 to about 0.001 wt %, about 0.001 to about 0.002 wt %, about 0.002 to about 0.004 wt %, or about 0.004 to about 0.0055 wt %). In some cases, about 0.0055 wt % to about 1 wt % (e.g., about 0.0055 wt % to about 0.05 wt %, about 0.05 wt % to about 0.5 wt %, or about 0.5 wt % to about 1 wt %) of the one or more additional VOCs can be ethyl propionate. In some cases, the one or more additional VOCs can include no ethyl propionate.

In some cases, the one or more additional VOCs in a tequila-like alcoholic beverage can include heptyl acetate. The heptyl acetate can be present in the rum-like alcoholic beverage at a concentration of, for example, about 0.1 to about 0.2 mg/L. In some cases, the heptyl acetate can be present in a tequila-like alcoholic beverage in an amount of, for example, about 0.000025 wt % to about 0.00032 wt % (e.g., about 0.000025 to about 0.00005 wt %, about 0.00005 to about 0.0001 wt %, about 0.0001 to about 0.0002 wt %, or about 0.0002 to about 0.00032 wt %). In some cases, about 0.00032 wt % to about 0.2 wt % (e.g., about 0.00032 wt % to about 0.003 wt % or about 0.003 wt % to about 0.02 wt %) of the one or more additional VOCs can be heptyl acetate. In some cases, the one or more additional VOCs can include no heptyl acetate.

In some cases, the one or more additional VOCs in a tequila-like alcoholic beverage can include isoamyl acetate. The isoamyl acetate can be present in the rum-like alcoholic beverage at a concentration of, for example, about 0.3 to about 11 mg/L (e.g., about 0.3 to about 2 mg/L, about 2 to about 4 mg/L, about 4 to about 6 mg/L, about 6 to about 8 mg/L, about 8 to about 10 mg/L, or about 10 to about 11 mg/L). In some cases, a tequila replica can contain isoamyl acetate at a concentration greater than about 6 mg/L (e.g., at least about 7 mg/L, at least about 8 mg/L, or at least about 10 mg/L). In some cases, the isoamyl acetate can be present in a tequila-like alcoholic beverage in an amount of, for example, about 0.000025 wt % to about 0.00011 wt % (e.g., about 0.000025 to about 0.00005 wt %, about 0.00005 to about 0.000075 wt %, or about 0.000075 to about 0.00011 wt %). In some cases, about 0.00011 wt % to about 0.4 wt % (e.g., about 0.00011 wt % to about 0.001 wt %, about 0.001 wt % to about 0.01 wt %, about 0.01 wt % to about 0.1 wt %, or about 0.1 wt % to about 0.4 wt %) of the one or more additional VOCs can be isoamyl acetate. In some cases, the one or more additional VOCs can include no isoamyl acetate.

In some cases, the one or more additional VOCs in a tequila-like alcoholic beverage can include isoamyl hexanoate. The isoamyl hexanoate can be present in the rum-like alcoholic beverage at a concentration of, for example, about 0.6 to about 2 mg/L (e.g., about 0.6 to about mg/L or about 1 to about 2 mg/L). In some cases, the isoamyl hexanoate can be present in a tequila-like alcoholic beverage in an amount of, for example, about 0.00026 wt % to about 0.0015 wt % (e.g., about 0.00026 to about 0.0005 wt %, about 0.0005 to about 0.0008 wt %, about 0.0008 to about 0.0012 wt %, or about 0.0012 to about 0.0015 wt %). In some cases, about 0.0015 wt % to about 0.2 wt % (e.g., about 0.0015 wt % to about 0.01 wt %, about 0.01 wt % to about 0.1 wt %, or about 0.1 wt % to about 0.2 wt %) of the one or more additional VOCs can be isoamyl hexanoate. In some cases, the one or more additional VOCs can include no isoamyl hexanoate.

In some cases, the one or more additional VOCs in a tequila-like alcoholic beverage can include isoamyl octanoate. The isoamyl octanoate can be present in the rum-like alcoholic beverage at a concentration of, for example, about 0.03 to about 2 mg/L (e.g., about 0.03 to about 0.3 mg/L or about 0.3 to about 2 mg/L). In some cases, a tequila replica can contain isoamyl octanoate at a concentration greater than about 0.6 mg/L (e.g., at least about 0.8 mg/L, at least about 1 mg/L, or at least about 1.5 mg/L. In some cases, the isoamyl octanoate can be present in a tequila-like alcoholic beverage in an amount of, for example, about 0.00037 wt % to about 0.0015 wt % (e.g., about 0.00037 to about 0.00075 wt %, about 0.00075 to about 0.001 wt %, about 0.001 to about 0.0012 wt %, or about 0.0012 to about 0.0015 wt %). In some cases, about 0.0015 wt % to about 0.1 wt % (e.g., about 0.0015 wt % to about 0.01 wt % or about 0.01 wt % to about 0.1 wt %) of the one or more additional VOCs can be isoamyl octanoate. In some cases, greater than about 0.0006 wt % (e.g., at least about 0.001 wt %, at least about 0.005 wt %, at least about 0.01 wt %, or at least about 0.05 wt %) of the one or more additional VOCs is isoamyl octanoate. In some cases, the one or more additional VOCs can include no isoamyl octanoate.

In some cases, the one or more additional VOCs in a tequila-like alcoholic beverage can include isobutyl acetate. The isobutyl acetate can be present in the rum-like alcoholic beverage at a concentration of, for example, about 0.3 to about 3 mg/L. In some cases, the isobutyl acetate can be present in a tequila-like alcoholic beverage in an amount of, for example, about 0.00026 wt % to about 0.0015 wt % (e.g., about 0.00026 to about 0.0005 wt %, about 0.0005 to about 0.0008 wt %, about 0.0008 to about 0.0012 wt %, or about 0.0012 to about 0.0015 wt %). In some cases, about 0.0015 wt % to about 0.2 wt % (e.g., about 0.0015 wt % to about 0.01 wt %, about 0.01 wt % to about 0.1 wt %, or about 0.1 wt % to about 0.2 wt %) of the one or more additional VOCs can be isobutyl acetate. In some cases, the one or more additional VOCs can include no isobutyl acetate.

In some cases, the one or more additional VOCs in a tequila-like alcoholic beverage can include linalyl propionate. The linalyl propionate can be present in a tequila-like alcoholic beverage in an amount of, for example, about 0.00013 wt % to about 0.00052 wt % (e.g., about 0.00013 to about 0.0026 wt %, about 0.0026 to about 0.0039 wt %, or about 0.0039 to about 0.0052 wt %). In some cases, the one or more additional VOCs can include no linalyl propionate.

In some cases, the one or more additional VOCs in a tequila-like alcoholic beverage can include methyl propionate. The methyl propionate can be present in a tequila-like alcoholic beverage in an amount of, for example, about 0.00005 wt % to about 0.00021 wt % (e.g., about 0.00005 to about 0.000075 wt %, about 0.000075 to about 0.0001 wt %, about 0.0001 to about 0.00015 wt %, or about 0.00015 to about 0.00021 wt %). In some cases, the one or more additional VOCs can include no methyl propionate.

In some cases, the one or more additional VOCs in a tequila-like alcoholic beverage can include octyl acetate. The octyl acetate can be present in the rum-like alcoholic beverage at a concentration of, for example, about 0.2 to about 0.7 mg/L (e.g., about 0.2 to about 0.4 mg/L or about 0.4 to about 0.7 mg/L). In some cases, the octyl acetate can be present in a tequila-like alcoholic beverage in an amount of, for example, about 0.00006 wt % to about 0.00016 wt % (e.g., about 0.00006 to about 0.00008 wt %, about 0.00008 to about 0.0001 wt %, about 0.0001 to about 0.00013 wt %, or about 0.00013 to about 0.00016 wt %). In some cases, about 0.00016 wt % to about 0.05 wt % (e.g., about 0.00016 wt % to about 0.001 wt %, about 0.001 wt % to about 0.01 wt %, or about 0.01 wt % to about 0.05 wt %) of the one or more additional VOCs can be octyl acetate. In some cases, the one or more additional VOCs can include no octyl acetate.

In some cases, the one or more additional VOCs in a tequila-like alcoholic beverage can include phenethyl acetate. The phenethyl acetate can be present in a tequila-like alcoholic beverage in an amount of, for example, about 0.00001 wt % to about 0.00075 wt % (e.g., about 0.00001 to about 0.00005 wt %, about 0.00005 to about 0.0001 wt %, about 0.0001 to about 0.0003 wt %, about 0.0003 to about 0.0005 wt %, or about 0.0005 to about 0.00075 wt %). In some cases, the one or more additional VOCs can include no phenethyl acetate.

In some cases, the one or more additional VOCs in a tequila-like alcoholic beverage can include acetoin. The acetoin can be present in a tequila-like alcoholic beverage in an amount of, for example, about 0.0002 wt % to about 0.00032 wt % (e.g., about 0.0002 to about 0.00023 wt %, about 0.00023 to about 0.00026 wt %, about 0.00026 to about 0.00029 wt %, or about 0.00029 to about 0.00032 wt %). In some cases, the one or more additional VOCs can include no acetoin.

In some cases, the one or more additional VOCs in a tequila-like alcoholic beverage can include acetone. The acetone can be present in a tequila-like alcoholic beverage in an amount of, for example, about 0.00002 wt % to about 0.00008 wt % (e.g., about 0.00002 to about 0.00004 wt %, about 0.00004 to about 0.00006 wt %, or about 0.00006 to about 0.00008 wt %). In some cases, the one or more additional VOCs can include no acetone.

In some cases, the one or more additional VOCs in a tequila-like alcoholic beverage can include methylcyclopentenolone. The methylcyclopentenolone can be present in a tequila-like alcoholic beverage in an amount of, for example, about 0.00003 wt % to about 0.00013 wt % (e.g., about 0.00003 to about 0.0001 wt %, about 0.0001 to about 0.00011 wt %, about 0.00011 to about 0.00012 wt %, or about 0.00012 to about 0.00013 wt %). In some cases, the one or more additional VOCs can include no methylcyclopentenolone.

In some cases, the one or more additional VOCs in a tequila-like alcoholic beverage can include piperine. The piperine can be present in a tequila-like alcoholic beverage in an amount of, for example, about 0.00002 wt % to about 0.000135 wt % (e.g., about 0.00002 to about 0.00005 wt %, about 0.00005 to about 0.00008 wt %, about 0.00008 to about 0.0001 wt %, about 0.0001 to about 0.00012 wt %, or about 0.00012 to about 0.000135 wt %). In some cases, the one or more additional VOCs can include no piperine.

In some cases, the one or more additional VOCs in a tequila-like alcoholic beverage can include dimethyl disulfide. The dimethyl disulfide can be present in a tequila-like alcoholic beverage in an amount of, for example, about 0.000004 wt % to about 0.000007 wt % (e.g., about 0.000004 to about 0.000005 wt %, about 0.000005 to about 0.000006 wt %, or about 0.000006 to about 0.000007 wt %). In some cases, the one or more additional VOCs can include no dimethyl disulfide.

In some cases, the one or more additional VOCs in a tequila-like alcoholic beverage can include methyl sulfide. The methyl sulfide can be present in a tequila-like alcoholic beverage in an amount of, for example, about 0.000002 wt % to about 0.000008 wt % (e.g., about 0.000002 to about 0.000004 wt %, about 0.000004 to about 0.000006 wt %, or about 0.000006 to about 0.000008 wt %). In some cases, the one or more additional VOCs can include no methyl sulfide.

In some cases, the one or more additional VOCs in a tequila-like alcoholic beverage can include pyridine. The pyridine can be present in a tequila-like alcoholic beverage in an amount of, for example, about 0.0000025 wt % to about 0.00001 wt % (e.g., about 0.0000025 to about 0.000005 wt %, about 0.000005 to about 0.0000075 wt %, or about 0.0000075 to about 0.00001 wt %). In some cases, the one or more additional VOCs can include no pyridine.

In some cases, the one or more additional VOCs in a tequila-like alcoholic beverage can include 1-octene. The 1-octene can be present in a tequila-like alcoholic beverage in an amount of, for example, about 0.0000005 wt % to about 0.000002 wt % (e.g., about 0.0000005 to about 0.000001 wt %, about 0.000001 to about 0.0000015 wt %, or about 0.0000015 to about 0.000002 wt %). In some cases, the one or more additional VOCs can include no 1-octene.

In some cases, the one or more additional VOCs in a tequila-like alcoholic beverage can include d-limonene. The d-limonene can be present in the rum-like alcoholic beverage at a concentration of, for example, about 0.3 to about 2 mg/L (e.g., about 0.3 to about 1 mg/L or about 1 to about 2 mg/L). In some cases, the d-limonene can be present in a tequila-like alcoholic beverage in an amount of, for example, about 0.00002 wt % to about 0.00016 wt % (e.g., about 0.00002 to about 0.00005 wt %, about 0.00005 to about 0.00008 wt %, about 0.00008 to about 0.0001 wt %, about 0.0001 to about 0.00013 wt %, or about 0.00013 to about 0.00016 wt %). In some cases, about 0.00016 wt % to about 0.05 wt % (e.g., about 0.00016 wt % to about 0.001 wt %, about 0.001 wt % to about 0.01 wt %, or about 0.01 wt % to about 0.05 wt %) of the one or more additional VOCs can be d-limonene. In some cases, the one or more additional VOCs can include no d-limonene.

In some cases, the one or more additional VOCs in a tequila-like alcoholic beverage can include linalool. The linalool can be present in the rum-like alcoholic beverage at a concentration of, for example, about 0.03 to about 9 mg/L (e.g., about 0.03 to about 0.3 mg/L, about 0.3 to about 2 mg/L, about 2 to about 4 mg/L, about 4 to about 6 mg/L, about 6 to about 8 mg/L, or about 8 to about 9 mg/L). In some cases, the linalool can be present in a tequila-like alcoholic beverage in an amount of, for example, about 0.00001 wt % to about 0.00055 wt % (e.g., about 0.00001 to about 0.00005 wt %, about 0.00005 to about 0.0001 wt %, about 0.0001 to about 0.0003 wt %, or about 0.0003 to about 0.00055 wt %). In some cases, about 0.00055 wt % to about 0.9 wt % (e.g., about 0.00055 wt % to about 0.005 wt %, about 0.005 wt % to about 0.05 wt %, about 0.05 wt % to about 0.5 wt %, or about 0.5 wt % to about 0.9 wt %) of the one or more additional VOCs can be linalool. In some cases, the one or more additional VOCs can include no linalool.

In some cases, the one or more additional VOCs in a tequila-like alcoholic beverage can include linalool oxide. The linalool oxide can be present in a tequila-like alcoholic beverage in an amount of, for example, about 0.00006 wt % to about 0.00027 wt % (e.g., about 0.00006 to about 0.00008 wt %, about 0.00008 to about 0.0001 wt %, about 0.0001 to about 0.0002 wt %, or about 0.0002 to about 0.00027 wt %). In some cases, the one or more additional VOCs can include no linalool oxide.

In some cases, the one or more additional VOCs in a tequila-like alcoholic beverage can include beta-myrcene. The beta-myrcene can be present in the rum-like alcoholic beverage at a concentration of, for example, about 0.1 to about 0.4 mg/L (e.g., about 0.1 to about 0.2 mg/L or about 0.2 to about 0.4 mg/L). In some cases, the beta-myrcene can be present in a tequila-like alcoholic beverage in an amount of, for example, about 0.000015 wt % to about 0.000065 wt % (e.g., about 0.000015 to about 0.000025 wt %, about 0.000025 to about 0.000035 wt %, about 0.000035 to about 0.000045 wt %, about 0.000045 to about 0.000055 wt %, or about 0.000055 to about 0.000065 wt %). In some cases, about 0.000065 wt % to about 0.02 wt % (e.g., about 0.000065 wt % to about 0.0006 wt %, about 0.0006 wt % to about 0.006 wt %, or about 0.006 wt % to about 0.02 wt %) of the one or more additional VOCs can be beta-myrcene. In some cases, the one or more additional VOCs can include no beta-myrcene.

In some cases, the one or more additional VOCs in a tequila-like alcoholic beverage can include p-cymene. The p-cymene can be present in the rum-like alcoholic beverage at a concentration of, for example, about 0.003 to about 2 mg/L (e.g., about 0.003 to about 0.03 mg/L, about 0.03 to about 0.3 mg/L, or about 0.3 to about 2 mg/L). In some cases, a tequila replica can contain p-cymene at a concentration greater than about 0.0085 mg/L (e.g., at least about 0.01 mg/L, at least about 0.05 mg/L, at least about 0.1 mg/L, or at least about 1 mg/L). In some cases, the p-cymene can be present in a tequila-like alcoholic beverage in an amount of, for example, about 0.00004 wt % to about 0.00032 wt % (e.g., about 0.00004 to about 0.00007 wt %, about 0.00007 to about 0.0001 wt %, about 0.0001 to about 0.0002 wt %, or about 0.0002 to about 0.00032 wt %). In some cases, about 0.00032 wt % to about 0.05 wt % (e.g., about 0.00032 wt % to about 0.003 wt %, about 0.003 wt % to about 0.03 wt %, or about 0.03 wt % to about 0.05 wt %) of the one or more additional VOCs can be p-cymene. In some cases, greater than about 0.0000087 wt % (e.g., at least about 0.00001 wt %, at least about 0.0001 wt %, at least about 0.001 wt %, or at least about 0.01 wt %) of the one or more additional VOCs is p-cymene. In some cases, the one or more additional VOCs can include no p-cymene.

In some cases, the one or more additional VOCs in a tequila-like alcoholic beverage can include acetol, isoamyl butyrate, or a combination thereof.

In some cases, the one or more additional VOCs in a tequila-like alcoholic beverage can include 1-butanol. The 1-butanol can be present at a concentration of, for example, about 3 to about 218 mg/L (e.g. about 3 to about 20 mg/L, about 20 to about 40 mg/L, about 40 to about 60 mg/L, about 60 to about 80 mg/L, about 80 to about 100 mg/L, about 100 to about 120 mg/L, about 120 to about 140 mg/L, about 140 to about 160 mg/L, about 160 to about 180 mg/L, about 180 to about 200 mg/L, or about 200 to about 218 mg/L). In some cases, about 0.09 wt % to about 19 wt % (e.g. about 0.09 wt % to about 0.9 wt %, about 0.9 wt % to about 2 wt %, about 2 wt % to about 4 wt %, about 4 wt % to about 6 wt %, about 6 wt % to about 8 wt %, about 8 wt % to about 10 wt %, about 10 wt % to about 12 wt %, about 12 wt % to about 14 wt %, about 14 wt % to about 16 wt %, about 16 wt % to about 18 wt %, or about 18 wt % to about 19 wt %) of the one or more additional VOCs can be 1-butanol. In some cases, the one or more additional VOCs can include no 1-butanol.

In some cases, the one or more additional VOCs in a tequila-like alcoholic beverage can include alpha-phellandrene. The alpha-phellandrene can be present at a concentration of, for example, about 1 to about 4 mg/L (e.g. about 1 to about 2 mg/L, about 2 to about 3 mg/L, or about 3 to about 4 mg/L). In some cases, about 0.04 wt % to about 0.2 wt % (e.g. about 0.04 wt % to about 0.1 wt %, or about 0.1 wt % to about 0.2 wt %) of the one or more additional VOCs can be alpha-phellandrene. In some cases, the one or more additional VOCs can include no alpha-phellandrene.

In some cases, the one or more additional VOCs in a tequila-like alcoholic beverage can include caryophyllene. The caryophyllene can be present at a concentration of, for example, about 0.001 to about 1 mg/L (e.g. about 0.001 to about 0.01 mg/L or about 0.01 to about 0.1 mg/L). In some cases, a tequila replica can contain caryophyllene at a concentration greater than about 0.007 mg/L. (e.g., at least about 0.01 mg/L, or at least about 0.05 mg/L). In some cases, about 0.00004 wt % to about 0.09 wt % (e.g. about 0.00004 wt % to about 0.0004 wt %, about 0.0004 wt % to about 0.004 wt %, about 0.004 wt % to about 0.04 wt %, or about 0.04 wt % to about 0.09 wt %) of the one or more additional VOCs can be caryophyllene. In some cases, greater than about 0.0000067 wt % (at least about 0.00001 wt %, at least about 0.0001 wt %, at least about 0.001 wt %, or at least about 0.01 wt %) of the one or more additional VOCs is caryophyllene. In some cases, the one or more additional VOCs can include no caryophyllene.

In some cases, the one or more additional VOCs in a tequila-like alcoholic beverage can include butyl acetate. The butyl acetate can be present at a concentration of, for example, about 0.004 to about 0.7 mg/L (e.g. about 0.004 to about 0.04 mg/L, about 0.04 to about 0.4 mg/L, or about 0.4 to about 0.7 mg/L). In some cases, about 0.0001 wt % to about 0.07 wt % (e.g. about 0.0001 wt % to about 0.001 wt %, about 0.001 wt % to about 0.01 wt %, or about 0.01 wt % to about 0.07 wt %) of the one or more additional VOCs can be butyl acetate. In some cases, the one or more additional VOCs can include no butyl acetate.

In some cases, the one or more additional VOCs in a tequila-like alcoholic beverage can include eucalyptol. The eucalyptol can be present at a concentration of, for example, about 0.003 to about 0.3 mg/L (e.g. about 0.003 to about 0.03 mg/L or about 0.03 to about 0.3 mg/L). In some cases, about 0.00008 wt % to about 0.03 wt % (e.g. about 0.00008 wt % to about 0.0008 wt %, about 0.0008 wt % to about 0.008 wt %, or about 0.008 wt % to about 0.03 wt %) of the one or more additional VOCs can be eucalyptol. In some cases, the one or more additional VOCs can include no eucalyptol.

In some cases, the one or more additional VOCs in a tequila-like alcoholic beverage can include nonanal. The nonanal can be present at a concentration of, for example, about 0.004 to about 0.3 mg/L (e.g. about 0.004 to about 0.04 mg/L or about 0.04 to about 0.3 mg/L). In some cases, a tequila replica can contain nonanal at a concentration greater than about 0.06 mg/L (e.g., at least about 0.08 mg/L, at least about 0.1 mg/L, or at least about 0.2 mg/L). In some cases, about 0.0001 wt % to about 0.005 wt % (e.g. about 0.0001 wt % to about 0.001 wt % or about 0.001 wt % to about 0.005 wt %) of the one or more additional VOCs can be nonanal. In some cases, the one or more additional VOCs can include no nonanal.

In some cases, the one or more additional VOCs in a tequila-like alcoholic beverage can include alpha-pinene. The alpha-pinene can be present at a concentration of, for example, about 0.002 to about 0.08 mg/L (e.g. about 0.002 to about 0.005 mg/L or about 0.005 to about 0.08 mg/L). In some cases, a tequila replica can contain alpha-pinene at a concentration greater than about 0.01 mg/L (at least about 0.02 mg/L, at least about 0.04 mg/L, or at least about 0.06 mg/L). In some cases, about 0.00005 wt % to about 0.001 wt % (e.g. about 0.00005 wt % to about 0.0005 wt % or about 0.0005 wt % to about 0.001 wt %) of the one or more additional VOCs can be alpha-pinene. In some cases, greater than about 0.000009 wt % (at least about 0.00001 wt %, at least about 0.0001 wt %, or at least about 0.0005 wt %) of the one or more additional VOCs is alpha-pinene. In some cases, the one or more additional VOCs can include no alpha-pinene.

In some cases, the one or more additional VOCs in a tequila-like alcoholic beverage can include 3-carene. The 3-carene can be present at a concentration of, for example, about 0.02 to about 0.1 mg/L. In some cases, about 0.0005 wt % to about 0.002 wt % of the one or more additional VOCs can be 3-carene. In some cases, the one or more additional VOCs can include no 3-carene.

In some cases, the one or more additional VOCs in a tequila-like alcoholic beverage can include gamma-terpinene. The gamma-terpinene can be present at a concentration of, for example, about 0.0008 to about 0.1 mg/L (e.g. about 0.0008 to about 0.008 mg/L, about 0.008 to about 0.08 mg/L, or about 0.08 to about 0.1 mg/L). In some cases, about 0.00007 wt % to about 0.002 wt % (e.g. about 0.00007 wt % to about 0.0007 wt % or about 0.0007 wt % to about 0.002 wt %) of the one or more additional VOCs can be gamma-terpinene. In some cases, the one or more additional VOCs can include no gamma-terpinene.

In some cases, the one or more additional VOCs in a tequila-like alcoholic beverage can include camphene. The camphene can be present at a concentration of, for example, about 0.004 to about 0.007 mg/L. In some cases, about 0.00007 wt % to about 0.0001 wt % of the one or more additional VOCs can be camphene. In some cases, the one or more additional VOCs can include no camphene.

In some cases, the one or more additional VOCs in a tequila-like alcoholic beverage can include humulene. The humulene can be present at a concentration of, for example, about 0.004 to about 0.02 mg/L. In some cases, a tequila replica can contain humulene at a concentration greater than about 0.01 mg/L (at least about 0.015 mg/L). In some cases, about 0.0001 wt % to about 0.0007 wt % (e.g. about 0.0001 wt % to about 0.0004 wt % or 0.0004 wt % to about 0.0007 wt %) of the one or more additional VOCs can be humulene. In some cases, the one or more additional VOCs can include no humulene.

In some cases, the one or more additional VOCs in a tequila-like alcoholic beverage can include isobutyl hexanoate. The isobutyl hexanoate can be present at a concentration of, for example, about 0.003 to about 0.009 mg/L (e.g. about 0.003 to about 0.006 mg/L or about 0.006 to about 0.009 mg/L). In some cases, about 0.00005 wt % to about 0.0006 wt % of the one or more additional VOCs can be isobutyl hexanoate. In some cases, the one or more additional VOCs can include no isobutyl hexanoate.

In some cases, the one or more additional VOCs in a tequila-like alcoholic beverage can include isovaleraldehyde. The isovaleraldehyde can be present at a concentration of, for example, about 0.08 to about 25 mg/L (e.g. about 0.08 to about 5 mg/L, about 5 to about 10 mg/L, about 10 to about 15 mg/L, about 15 to about 20 mg/L, or about 20 to about 25 mg/L). In some cases, about 0.002 wt % to about 2 wt % (e.g. about 0.002 wt % to about 0.02 wt %, about 0.02 wt % to about 0.2 wt %, or about 0.2 wt % to about 2 wt %) of the one or more additional VOCs can be isovaleraldehyde. In some cases, the one or more additional VOCs can include no isovaleraldehyde.

In some cases, the one or more additional VOCs in a tequila-like alcoholic beverage can include 2-acetylfuran. The 2-acetylfuran can be present at a concentration of, for example, about 0.01 to about 6 mg/L (e.g. about 0.01 to about 0.1 mg/L, about 0.1 to about 1 mg/L, about 1 to about 2 mg/L, about 2 to about 4 mg/L, or about 4 to about 6 mg/L). In some cases, a tequila replica can contain 2-acetylfuran at a concentration less than about 0.05 mg/L (e.g., less than about 0.03 mg/L, or less than about 0.02 mg/L). In some cases, about 0.0009 wt % to about 0.3 wt % (e.g. about 0.0009 wt % to about 0.009 wt %, about 0.009 wt % to about 0.09 wt %, or about 0.09 wt % to about 0.3 wt %) of the one or more additional VOCs can be 2-acetylfuran. In some cases, the one or more additional VOCs can include no 2-acetylfuran.

In some cases, the one or more additional VOCs in a tequila-like alcoholic beverage can include alpha-terpincol. The alpha-terpineol can be present at a concentration of, for example, about 0.1 to about 15 mg/L (e.g. about 0.1 to about 2 mg/L, about 2 to about 4 mg/L, about 4 to about 6 mg/L, about 6 to about 8 mg/L, about 8 to about 10 mg/L, about 10 to about 12 mg/L, about 12 to about 14 mg/L, or about 14 to about 15 mg/L). In some cases, a tequila replica can contain alpha-terpineol at a concentration less than about 0.24 mg/L (e.g., less than about 0.2 mg/L, or less than about 0.15 mg/L). In some cases, about 0.002 wt % to about 2 wt % (e.g. about 0.002 wt % to about 0.02 wt %, about 0.02 wt % to about 0.2 wt %, or about 0.2 wt % to about 2 wt %) of the one or more additional VOCs can be alpha-terpineol. In some cases, less than about 0.00006 wt % (e.g., less than about 0.00001 wt %, or less than about 0.000005 wt %) of the one or more additional VOCs is alpha-terpineol. In some cases, the one or more additional VOCs can include no alpha-terpineol.

In some cases, the one or more additional VOCs in a tequila-like alcoholic beverage can include beta-pinene. The beta-pinene can be present at a concentration of, for example, about 0.04 to about 0.2 mg/L. In some cases, about 0.0009 wt % to about 0.01 wt % (e.g. about 0.0009 wt % to about 0.009 wt % or about 0.009 wt % to about 0.01 wt %) of the one or more additional VOCs can be beta-pinene. In some cases, the one or more additional VOCs can include no beta-pinene.

In some cases, the one or more additional VOCs in a tequila-like alcoholic beverage can include terpinolene. The terpinolene can be present at a concentration of, for example, about 0.008 to about 0.08 mg/L. In some cases, about 0.0001 wt % to about 0.006 wt % (e.g. about 0.0001 wt % to about 0.001 wt % or about 0.001 wt % to about 0.006 wt %) of the one or more additional VOCs can be terpinolene. In some cases, the one or more additional VOCs can include no terpinolene.

In some cases, the one or more additional VOCs in a tequila-like alcoholic beverage can include beta-bisabolene. The beta-bisabolene can be present at a concentration of, for example, about 0.009 to about 0.1 mg/L (e.g. about 0.009 to about 0.09 mg/L or about 0.09 to about 0.1 mg/L). In some cases, about 0.0002 wt % to about 0.01 wt % (e.g. about 0.0002 wt % to about 0.002 wt % or about 0.002 wt % to about 0.01 wt %) of the one or more additional VOCs can be beta-bisabolene. In some cases, the one or more additional VOCs can include no beta-bisabolene.

In some cases, the one or more additional VOCs in a tequila-like alcoholic beverage can include fuselol. The fuselol can be present at a concentration of, for example, about 168 to about 1250 mg/L (e.g. about 168 to about 200 mg/L, about 200 to about 250 mg/L, about 250 to about 300 mg/L, about 300 to about 350 mg/L, about 350 to about 400 mg/L, about 400 to about 450 mg/L, about 450 to about 500 mg/L, about 500 to about 550 mg/L, about 550 to about 600 mg/L, about 600 to about 650 mg/L, about 650 to about 700 mg/L, about 700 to about 750 mg/L, about 750 to about 800 mg/L, about 800 to about 850 mg/L, about 850 to about 900 mg/L, about 900 to about 950 mg/L, about 950 to about 1000 mg/L, about 1000 to about 1050 mg/L, about 1050 to about 1100 mg/L, about 1100 to about 1150 mg/L, about 1150 to about 1200 mg/L, or about 1200 to about 1250 mg/L). In some cases, the fuselol can be present in a tequila-like alcoholic beverage in an amount of, for example, about 0.00025 wt % to about 0.0025 wt % (e.g., about 0.00025 to about 0.0005 wt %, about 0.0005 to about 0.0007 wt %, about 0.0007 to about 0.001 wt %, about 0.001 to about 0.0015 wt %, or about 0.0015 to about 0.0025 wt %). In some cases, the one or more additional VOCs can include no fuselol. In some cases, about 3 wt % to about 73 wt % (e.g. about 3 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, or about 70 wt % to about 73 wt %) of the one or more additional VOCs can be fuselol. In some cases, the one or more additional VOCs can include no fuselol.

In some cases, the tequila replicas provided herein can include one or more non-volatile compounds. A non-limiting example of a non-volatile compound that can be included in a tequila replica is a coloring agent (e.g., a caramel coloring agent, a Food, Drugs and Cosmetics (FD&C) color, or a naturally-sourced color from a fruit or a vegetable). The non-volatile compound(s) can be present at any suitable amount within a tequila replica. In some cases, for example, added non-volatile compound(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a tequila replica. In some cases, a tequila replica can include no added non-volatile compounds.

In some embodiments, the non-volatile compounds can include one or more non-volatile compounds that are not present in a corresponding traditional tequila. For example, a tequila replica provided herein can include one or more (e.g., one, two, three, four, five, six, seven, eight, nine, ten, 15, 20, or more than 20) non-volatile compounds that are not present in a corresponding traditional tequila. It is surprising that the tequila replicas described herein include one or more compounds not found in any tested traditional tequila, as it would be expected that to create a tequila replica, one would only think to use compounds found in one or more traditional tequilas.

In some embodiments, the non-volatile compounds can exclude one or more non-volatile compounds that are present in a corresponding traditional tequila. It is surprising that the tequila replicas described herein lack one or more compounds found in every tested traditional tequilas, as one would believe that compounds present in every tested traditional tequila to be important to tequila flavor.

The non-volatile compounds present in a tequila replica can include compounds that fall into any of several categories, including sugars, sugar alcohols, or any combination thereof; amino acids, amino acid derivatives, or any combination thereof; pH-modifying salts; organic acids; nucleobases, nucleotides, or any combination thereof; nitrogen-containing heterocycles; phenolic compounds. Additional categories can include lipids, vitamins, other flavorants, colors, tannin components, salt (e.g., NaCl). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

Again, non-volatile compounds can be detected in traditional tequilas using any suitable method, including the LC-MS method described in Example 3 herein. A non-volatile compound that is “not present” in a reference tequila is one that is not detected in the reference tequila using the methods set forth in Example 3.

A tequila replica can include any appropriate number of non-volatile compounds. For example, a tequila replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, the number of non-volatile compounds in a tequila replica can be less than the number of non-volatile compounds in a single corresponding reference tequila.

Further, in some embodiments, the tequila replicas provided herein can lack one or more (e.g., one, two, three, four, five, six, seven, eight, nine, ten, or more than ten) non-volatile compounds that are present in corresponding traditional tequilas. In some cases, the overall population of non-volatile compounds in a tequila replica can have less than 95% identity to the non-volatile compounds in a corresponding reference tequila (e.g., in a single type of traditionally made tequila corresponding to the replica). For example, the non-volatile compounds in a tequila replica can have less than 90%, less than 80%, less than 70%, less than 60%, less than 50%, less than 40%, less than 30%, or less than 25% identity to the population of non-volatile compounds in a corresponding reference tequila. Some tequila replicas may contain at least 1 (e.g., at least 2, at least 5, at least 10, at least 15, at least 20, at least 25, or at least 30) non-volatile compounds that are not found in a single reference tequila. Moreover, some tequila replicas may contain no more than 50 (e.g., no more than 45, 40, 35, 30, 25, 20, 15, or 10) non-volatile compounds that are present in a single reference tequila. For example, in some embodiments, a tequila replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference tequila; in some embodiments, m can be equal to 5, 6, 7, 8, 9, 10, 11, 12, 13, 14, 15, 16, 17, 18, 19, 20, 25, 30, 35, 40, 45, 50, 55, or 60.

As noted above, the amounts of non-volatile compounds in reference tequilas are measured using the LC-MS methods described herein. In some embodiments, the amount of a particular non-volatile compound in a tequila replica can be an amount, based on concentration or percent composition, that is within a range 30% higher and lower than a measured amount for that non-volatile compound in a corresponding reference tequila. For example, a non-volatile compound can be present in a tequila replica in an amount that is 70 to 90%, 80 to 100%, 90 to 110%, 100 to 120%, 110 to 130%, 70 to 100%, 80 to 110%, 90 to 120%, or 100 to 130% of an amount measured for that non-volatile compound in a corresponding reference tequila.

In some cases, the amount of any particular non-volatile compound in a tequila replica may be different than the amount of that non-volatile compound in a corresponding reference tequila. In some cases, the amount of a non-volatile compound in a tequila replica can be 75% or less (e.g., 70% or less, 60% or less, 50% or less, 40% or less, 30% or less, 20% or less, or 10% or less), by concentration or percent mass, than the amount of the same non-volatile compound in a corresponding reference tequila. In some cases, the amount of a non-volatile compound in a tequila replica can be 125% or more (e.g., 150% or more, 200% or more, or 300% or more), by concentration or percent mass, than the amount of the same non-volatile compound in a corresponding reference tequila.

Because of the methods by which they are made, the tequila-like alcoholic beverages provided herein can lack contaminants and other detrimental compounds that sometimes are encountered in traditional alcoholic beverages. These include, without limitation, organisms such as Escherichia coli, Salmonella sp., Brettanomyces sp., Lactobacillus, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogemim, Penicillium citreonigrum, Penicillin decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, and heavy metals.

It is noted that while tequila replicas can include volatile and non-volatile compounds as listed herein, the added compounds may react with one another to generate additional compounds, or to change the effective amount of one or more of the added compounds within the tequila replica formulation.

This document also provides methods for making tequila replicas. In some cases, the methods provided herein can be carried out by first mixing water with ethanol (e.g., a grain neutral spirit and optionally a traditional tequila, where the traditional tequila (if included) is added in an amount such that it makes up about 10 wt % or less (e.g., about 1 wt % or less) of the tequila replica product), glycerin, optionally an oak extract and/or one or more plant oils, and adding small quantities of diluted VOCs and, optionally, non-volatile compounds. In general, the water, ethanol, glycerin, oak extract and/or plant oil(s) (when included), and added VOCs and non-volatile compounds (when included) are all used to generate a final product having the characteristics of a traditionally-produced tequila.

In some cases, a method of making a tequila replica provided herein can include providing an aqueous solution and adding to the aqueous solution ingredients including ethanol (e.g., a grain neutral spirit and a traditional tequila, where the traditional tequila is added in an amount such that it makes up about 10 wt % or less (e.g., about 5 wt % or less, or about 1 wt % or less) of the tequila replica product), glycerin, optionally an oak extract and/or a plant oil, optionally one or more nonvolatile compounds (e.g., coloring agents), and one or more (e.g., five or more, 10 or more, 15 or more, 20 or more, 25, or more, 30 or more, 35 or more, 40 or more, 45 or more, 50 or more, 55 or more, or 60 or more) additional VOCs, where the added VOCs include an acid, an alcohol, an aldehyde, an ester, a terpene, a furan, optionally a ketone, and optionally another VOC that does not fall into one of these categories. For example, the added VOCs that are combined with the other ingredients can be selected from acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene, where the added VOCs include an acid, an alcohol, an aldehyde, an ester, a ketone, a terpene, and another VOC that does not fall into one of these categories. In some cases, the added VOCs that are combined with the other ingredients can be selected from 1-butanol, 1-decanol, 1-octen-3-ol, 1-octene, 2,3-butanediol, 2,4,6-trimethylphenol, 2-acetylfuran, 2-heptanol, 2-methyl-1-butanol, 3-carene, 3-methylbutyraldehyde, 4-ethylguaiacol, 5-methylfurfural, acetal, acetaldehyde, acetic acid, acetoin, acetol, acetone, alpha-phellandrene, alpha-pinene, alpha-terpineol, beta-bisabolene, beta-myrcene, beta-pinene, butyl acetate, camphene, carvacrol, caryophyllene, decanoic acid, diethyl succinate, dimethyl disulfide, d-limonene, ethyl acetate, ethyl benzoate, ethyl butyrate, ethyl butyrate, ethyl decanoate, ethyl heptanoate, ethyl hexanoate, ethyl lactate, ethyl laurate, ethyl octanoate, ethyl palmitate, ethyl propionate, eucalyptol, farnesol, furfural, furfuryl alcohol, fuselol, gamma-terpinene, heptyl acetate, heptyl acetate, hexanoic acid, hexyl alcohol, humulene, isoamyl acetate, isoamyl alcohol, isoamyl butyrate, isoamyl hexanoate, isoamyl octanoate, isobutyl acetate, isobutyl alcohol, isobutyl hexanoate, isoamyl hexanoate, isovaleraldehyde, lauric acid, linalool, linalool oxide, linalyl propionate, methyl propionate, methyl sulfide, methylcyclopentenolone, myristic acid, nerolidol, nonanal, octanoic acid, octyl acetate, p-cymene, phenethyl acetate, phenethyl alcohol, phenol, piperine, propionic acid, propyl alcohol, pyridine, terpinolene, thymol, and vanillin. In some cases, the added VOCs that are combined with the other ingredients can be selected from 1-butanol, propyl alcohol, 2-acetylfuran, 2-methyl-1-butanol, isobutyl alcohol, 3-carene, isoamyl alcohol, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl butyrate, isoamyl octanoate, isobutyl acetate, isobutyl hexanoate, isoamyl hexanoate, isovaleraldehyde, lauric acid, linalool, decanoic acid, nonanal, octanoic acid, octyl acetate, p-cymene, phenethyl alcohol, terpinolene, and thymol. In some cases, the added VOCs that are combined with the other ingredients can be selected from 1-butanol, propyl alcohol, 2-acetylfuran, 2-methyl-1-butanol, isobutyl alcohol, 3-carene, isoamyl alcohol, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl octanoate, isobutyl acetate, isobutyl hexanoate, isoamyl hexanoate, isovaleraldehyde, lauric acid, linalool, decanoic acid, nonanal, octanoic acid, octyl acetate, p-cymene, phenethyl alcohol, terpinolene, and thymol.

This document also provides methods for generating concentrated versions of any tequila-like alcoholic beverage, where the concentrated versions include glycerin, optionally an oak extract and/or one or more plant oils, added VOCs and non-volatile components (if any) of the final product, and optionally a traditional tequila, but without the full bulk of the ethanol and water (and in some cases, without the traditional tequila). Such concentrates can be manufactured and then shipped to a second location, where water and ethanol (e.g., grain neutral spirits and, optionally, traditional tequila) can be added at the appropriate ABV and volume to create a finished product.

Any suitable concentration of traditional tequila (if included), glycerin, optional oak extract, optional plant oil(s), and additional VOCs and (if included) non-volatile compounds can be used. For example, a concentrated tequila-like alcoholic beverage can include traditional tequila, glycerin, optionally an oak extract, optionally one or more plant oils, additional VOCs, and non-volatile components (if any) at concentrations that are at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold) greater than their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic components that are present in the final product. In general, such concentrates can be prepared in much the same way as a non-concentrated tequila-like alcoholic beverage, by combining the desired amounts of ingredients but omitting the water and the bulk of the ethanol. It is noted that in some cases, some amount of ethanol can be included in the concentrate in order to facilitate dissolution of the added VOCs and, if any, non-volatile compounds.

### Exemplary Embodiments

Embodiment 1 is an agave spirit replica comprising, consisting essentially of, or consisting of water; a grain neutral spirit; optionally, a agave spirit, wherein said agave spirit replica comprises no more than about 10 wt % of said agave spirit; glycerin; optionally, an oak extract; optionally, a plant oil; and at least ten added VOCs, wherein said added VOCs comprise at least one acid, at least one additional alcohol, at least one aldehyde, at least one ester, at least one terpene, and at least one furan, and wherein said added VOCs comprise about 0.001 wt % to about 1 wt % of said agave spirit replica.

Embodiment 2 is the agave spirit replica of embodiment 1, wherein said at least one acid comprises one or more of decanoic acid, hexanoic acid, lauric acid, and octanoic acid.

Embodiment 3 is the agave spirit replica of embodiment 1, wherein said at least one acid comprises hexanoic acid and decanoic acid.

Embodiment 4 is the agave spirit replica of embodiment 1, wherein said at least one acid comprises decanoic acid, hexanoic acid, lauric acid, and octanoic acid.

Embodiment 5 is the agave spirit replica of any one of embodiments 1 to 4, wherein said at least one additional alcohol comprises one or more of 1-butanol, propyl alcohol, 2-methyl-1-butanol, isobutyl alcohol, isoamyl alcohol, fuselol, and phenethyl alcohol.

Embodiment 6 is the agave spirit replica of embodiment 5, wherein said at least one additional alcohol comprises 1-butanol, propyl alcohol, 2-methyl-1-butanol, isobutyl alcohol, isoamyl alcohol, and fuselol.

Embodiment 7 is the agave spirit replica of embodiment 5, wherein said at least one additional alcohol comprises propyl alcohol, 2-methyl-1-butanol, isobutyl alcohol, isoamyl alcohol, fuselol, and phenethyl alcohol.

Embodiment 8 is the agave spirit replica of any one of embodiments 1 to 7, wherein said at least one aldehyde comprises one or more of acetaldehyde, isovaleraldehyde, and nonanal.

Embodiment 9 is the agave spirit replica of embodiment 8, wherein said at least one aldehyde comprises acetaldehyde, isovaleraldehyde, and nonanal.

Embodiment 10 is the agave spirit replica of any one of embodiments 1 to 9, wherein said at least one ester comprises one or more of butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate.

Embodiment 11 is the agave spirit replica of embodiment 10, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate.

Embodiment 12 is the agave spirit replica of embodiment 10, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate.

Embodiment 13 is the agave spirit replica of embodiment 10, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate.

Embodiment 14 is the agave spirit replica of embodiment 10, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate.

Embodiment 15 is the agave spirit replica of any one of embodiments 1 to 14, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol.

Embodiment 16 is the agave spirit replica of embodiment 15, wherein said at least one terpene comprises alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol.

Embodiment 17 is the agave spirit replica of embodiment 15, wherein said at least one terpene comprises 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol.

Embodiment 18 is the agave spirit replica of embodiment 15, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol.

Embodiment 19 is the agave spirit replica of any one of embodiments 1 to 18, wherein said at least one terpene comprises one or both of 2-acetylfuran and furfuryl alcohol.

Embodiment 20 is the agave spirit replica of any one of embodiments 1 to 19, wherein said added VOCs comprise ten or more compounds selected from the group consisting of 1-butanol, 2-acetylfuran, 2-methyl-1-butanol, 3-carene, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl butyrate, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 21 is the agave spirit replica of any one of embodiments 1 to 20, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 22 is the agave spirit replica of any one of embodiments 1 to 20, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 23 is the agave spirit replica of embodiment 1, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

Embodiment 24 is the agave spirit replica of embodiment 1, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

Embodiment 25 is the agave spirit replica of embodiment 1, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

Embodiment 26 is the agave spirit replica of embodiment 1, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

Embodiment 27 is the agave spirit replica of embodiment 1, comprising from about 5 wt % to about 70 wt % water; from about 30 wt % to about 95 wt % grain neutral spirits; not more than about 5 wt % agave spirit; from about 0.1 wt % to about 5 wt % glycerin; and from about 0.001 wt % to about 1 wt % added VOCs, wherein said added VOCs comprise ten or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 28 is the agave spirit replica of embodiment 27, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

Embodiment 29 is the agave spirit replica of embodiment 27, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

Embodiment 30 is the agave spirit replica of embodiment 27, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

Embodiment 31 is the agave spirit replica of embodiment 27, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

Embodiment 32 is the agave spirit replica of embodiment 27, wherein said added VOCs comprise isoamyl acetate, and wherein said isoamyl acetate is present in said agave spirit replica at a concentration greater than about 6 mg/L.

Embodiment 33 is the agave spirit replica of embodiment 27, wherein said added VOCs comprise hexanoic acid, and wherein said hexanoic acid is present in said agave spirit replica at a concentration greater than about 23 mg/L.

Embodiment 34 is the agave spirit replica of embodiment 27, wherein said added VOCs comprise octanoic acid, and wherein said octanoic acid is present in said agave spirit replica at a concentration less than about 5 mg/L.

Embodiment 35 is the agave spirit replica of embodiment 27, wherein said added VOCs comprise lauric acid, and wherein said lauric acid is present in said agave spirit replica at a concentration less than about 1.9 mg/L.

Embodiment 36 is the agave spirit replica of embodiment 27, wherein said added VOCs comprise thymol, and wherein said thymol is present in said agave spirit replica at a concentration greater than about 0.5 mg/L.

Embodiment 37 is the agave spirit replica of embodiment 27, wherein said added VOCs comprise ethyl octanoate, and wherein said ethyl octanoate is present in said agave spirit replica at a concentration greater than about 8 mg/L.

Embodiment 38 is the agave spirit replica of embodiment 27, wherein said added VOCs comprise isoamyl alcohol, and wherein said isoamyl alcohol is present in said agave spirit replica at a concentration less than about 100 mg/L.

Embodiment 39 is the agave spirit replica of embodiment 27, wherein said added VOCs comprise p-cymene, and wherein said p-cymene is present in said agave spirit replica at a concentration greater than about 0.0085 mg/L.

Embodiment 40 is the agave spirit replica of embodiment 27, wherein said added VOCs comprise caryophyllene, and wherein said caryophyllene is present in said agave spirit replica at a concentration greater than about 0.007 mg/L.

Embodiment 41 is the agave spirit replica of embodiment 27, wherein said added VOCs comprise isobutyl alcohol, and wherein said isobutyl alcohol is present in said agave spirit replica at a concentration greater than about 650 mg/L.

Embodiment 42 is the agave spirit replica of embodiment 27, wherein said added VOCs comprise furfuryl alcohol, and wherein said furfuryl alcohol is present in said agave spirit replica at a concentration greater than about 8.5 mg/L.

Embodiment 43 is the agave spirit replica of embodiment 27, wherein said added VOCs comprise nonanal, and wherein said nonanal is present in said agave spirit replica at a concentration greater than about 0.06 mg/L.

Embodiment 44 is the agave spirit replica of embodiment 27, wherein said added VOCs comprise alpha-pinene, and wherein said alpha-pinene is present in said agave spirit replica at a concentration greater than about 0.01 mg/L.

Embodiment 45 is the agave spirit replica of embodiment 27, wherein said added VOCs comprise humulene, and wherein said humulene is present in said agave spirit replica at a concentration greater than about 0.01 mg/L.

Embodiment 46 is the agave spirit replica of embodiment 27, wherein said added VOCs comprise ethyl butyrate, and wherein said ethyl butyrate is present in said agave spirit replica at a concentration greater than about 1.6 mg/L.

Embodiment 47 is the agave spirit replica of embodiment 27, wherein said added VOCs comprise isoamyl octanoate, and wherein said isoamyl octanoate is present in said agave spirit replica at a concentration greater than about 0.6 mg/L.

Embodiment 48 is the agave spirit replica of embodiment 27, wherein said added VOCs comprise ethyl decanoate, and wherein said ethyl decanoate is present in said agave spirit replica at a concentration less than about 0.007 mg/L.

Embodiment 49 is the agave spirit replica of embodiment 27, wherein said added VOCs comprise 2-acetylfuran, and wherein said 2-acetylfuran is present in said agave spirit replica at a concentration less than about 0.05 mg/L.

Embodiment 50 is the agave spirit replica of embodiment 27, wherein said added VOCs comprise diethyl succinate, and wherein said diethyl succinate is present in said agave spirit replica at a concentration greater than about 2.3 mg/L.

Embodiment 51 is the agave spirit replica of embodiment 27, wherein said added VOCs comprise alpha-terpineol, and wherein said alpha-terpineol is present in said agave spirit replica at a concentration less than about 0.24 mg/L.

Embodiment 52 is the agave spirit replica of embodiment 27, wherein said added VOCs comprise octanoic acid, and wherein less than about 0.0013 wt % of the one or more additional VOCs is octanoic acid.

Embodiment 53 is the agave spirit replica of embodiment 27, wherein said added VOCs comprise thymol, and wherein greater than about 0.00053 wt % of the one or more additional VOCs is thymol.

Embodiment 54 is the agave spirit replica of embodiment 27, wherein said added VOCs comprise isoamyl alcohol, and wherein less than about 0.03 wt % of the one or more additional VOCs is isoamyl alcohol.

Embodiment 55 is the agave spirit replica of embodiment 27, wherein said added VOCs comprise p-cymene, and wherein greater than about 0.0000087 wt % of the one or more additional VOCs is p-cymene.

Embodiment 56 is the agave spirit replica of embodiment 27, wherein said added VOCs comprise caryophyllene, and wherein greater than about 0.0000067 wt % of the one or more additional VOCs is caryophyllene.

Embodiment 57 is the agave spirit replica of embodiment 27, wherein said added VOCs comprise isobutyl alcohol, and wherein greater than about 0.52 wt % of the one or more additional VOCs is isobutyl alcohol.

Embodiment 58 is the agave spirit replica of embodiment 27, wherein said added VOCs comprise furfuryl alcohol, and wherein greater than about 0.0086 wt % of the one or more additional VOCs is furfuryl alcohol.

Embodiment 59 is the agave spirit replica of embodiment 27, wherein said added VOCs comprise alpha-pinene, and wherein greater than about 0.000009 wt % of the one or more additional VOCs is alpha-pinene.

Embodiment 60 is the agave spirit replica of embodiment 27, wherein said added VOCs comprise ethyl butyrate, and wherein greater than about 0.0017 wt % of the one or more additional VOCs is ethyl butyrate.

Embodiment 61 is the agave spirit replica of embodiment 27, wherein said added VOCs comprise isoamyl octanoate, and wherein greater than about 0.0006 wt % of the one or more additional VOCs is isoamyl octanoate.

Embodiment 62 is the agave spirit replica of embodiment 27, wherein said added VOCs comprise ethyl decanoate, and wherein less than about 0.0000017 wt % of the one or more additional VOCs is ethyl decanoate.

Embodiment 63 is the agave spirit replica of embodiment 27, wherein said added VOCs comprise diethyl succinate, and wherein greater than about 0.0023 wt % of the one or more additional VOCs is diethyl succinate.

Embodiment 64 is the agave spirit replica of embodiment 27, wherein said added VOCs comprise alpha-terpineol, and wherein less than about 0.00006 wt % of the one or more additional VOCs is alpha-terpincol.

Embodiment 65 is a method for making an agave spirit replica, wherein said method comprises, or consists essentially of, combining water; a grain neutral spirit; optionally, an agave spirit, wherein said agave spirit replica comprises no more than about 10 wt % of said agave spirit, glycerin; optionally, an oak extract; optionally, a plant oil; and at least ten added VOCs, wherein said VOCs are provided as separate ingredients and comprise at least one acid, at least one additional alcohol, at least one aldehyde, at least ester, at least one terpene, and at least one furan, and wherein said added VOCs comprise about 0.001 wt % to about 1 wt % of said agave spirit replica.

Embodiment 66 is the method of embodiment 65, wherein said at least one acid comprises one or more of decanoic acid, hexanoic acid, lauric acid, and octanoic acid.

Embodiment 67 is the method of embodiment 65, wherein said at least one acid comprises hexanoic acid and decanoic acid.

Embodiment 68 is the method of embodiment 65, wherein said at least one acid comprises decanoic acid, hexanoic acid, lauric acid, and octanoic acid.

Embodiment 69 is the method of any one of embodiments 65 to 68, wherein said at least one additional alcohol comprises one or more of 1-butanol, propyl alcohol, 2-methyl-1-butanol, isobutyl alcohol, isoamyl alcohol, fuselol, and phenethyl alcohol.

Embodiment 70 is the method of embodiment 69, wherein said at least one additional alcohol comprises 1-butanol, propyl alcohol, 2-methyl-1-butanol, isobutyl alcohol, isoamyl alcohol, and fuselol.

Embodiment 71 is the method of embodiment 69, wherein said at least one additional alcohol comprises propyl alcohol, 2-methyl-1-butanol, isobutyl alcohol, isoamyl alcohol, fuselol, and phenethyl alcohol.

Embodiment 72 is the method of any one of embodiments 65 to 71, wherein said at least one aldehyde comprises one or more of acetaldehyde, isovaleraldehyde, and nonanal.

Embodiment 73 is the method of embodiment 72, wherein said at least one aldehyde comprises acetaldehyde, isovaleraldehyde, and nonanal.

Embodiment 74 is the method of any one of embodiments 65 to 73, wherein said at least one ester comprises one or more of butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate.

Embodiment 75 is the method of embodiment 74, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate.

Embodiment 76 is the method of embodiment 74, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate.

Embodiment 77 is the method of embodiment 74, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate.

Embodiment 78 is the method of embodiment 74, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate.

Embodiment 79 is the method of any one of embodiments 65 to 78, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol.

Embodiment 80 is the method of embodiment 79, wherein said at least one terpene comprises alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol.

Embodiment 81 is the method of embodiment 79, wherein said at least one terpene comprises 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol.

Embodiment 82 is the method of embodiment 79, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol.

Embodiment 83 is the method of any one of embodiments 65 to 82, wherein said at least one terpene comprises one or both of 2-acetylfuran and furfuryl alcohol.

Embodiment 84 is the method of any one of embodiments 65 to 83, wherein said added VOCs comprise ten or more compounds selected from the group consisting of 1-butanol, 2-acetylfuran, 2-methyl-1-butanol, 3-carene, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl butyrate, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 85 is the method of any one of embodiments 65 to 84, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 86 is the method of any one of embodiments 65 to 84, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 87 is the method of embodiment 65, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

Embodiment 88 is the method of embodiment 65, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

Embodiment 89 is the method of embodiment 65, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

Embodiment 90 is the method of embodiment 65, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

Embodiment 91 is the method of embodiment 65, wherein said agave spirit replica comprises from about 5 wt % to about 70 wt % water; from about 30 wt % to about 95 wt % grain neutral spirits; not more than about 5 wt % agave spirit; from about 0.0001 wt % to about 5 wt % glycerin; and from about 0.001 wt % to about 1 wt % added VOCs, wherein said added VOCs comprise ten or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

Embodiment 92 is the method of embodiment 91, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

Embodiment 93 is the method of embodiment 91, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

Embodiment 94 is the method of embodiment 91, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

Embodiment 95 is the method of embodiment 91, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

Embodiment 96 is the method of embodiment 91, wherein said added VOCs comprise isoamyl acetate, and wherein said isoamyl acetate is present in said agave spirit replica at a concentration greater than about 6 mg/L.

Embodiment 97 is the method of embodiment 91, wherein said added VOCs comprise hexanoic acid, and wherein said hexanoic acid is present in said agave spirit replica at a concentration greater than about 23 mg/L.

Embodiment 98 is the method of embodiment 91, wherein said added VOCs comprise octanoic acid, and wherein said octanoic acid is present in said agave spirit replica at a concentration less than about 5 mg/L.

Embodiment 99 is the method of embodiment 91, wherein said added VOCs comprise lauric acid, and wherein said lauric acid is present in said agave spirit replica at a concentration less than about 1.9 mg/L.

Embodiment 100 is the method of embodiment 91, wherein said added VOCs comprise thymol, and wherein said thymol is present in said agave spirit replica at a concentration greater than about 0.5 mg/L.

Embodiment 101 is the method of embodiment 91, wherein said added VOCs comprise ethyl octanoate, and wherein said ethyl octanoate is present in said agave spirit replica at a concentration greater than about 8 mg/L.

Embodiment 102 is the method of embodiment 91, wherein said added VOCs comprise isoamyl alcohol, and wherein said isoamyl alcohol is present in said agave spirit replica at a concentration less than about 100 mg/L.

Embodiment 103 is the method of embodiment 91, wherein said added VOCs comprise p-cymene, and wherein said p-cymene is present in said agave spirit replica at a concentration greater than about 0.0085 mg/L.

Embodiment 104 is the method of embodiment 91, wherein said added VOCs comprise caryophyllene, and wherein said caryophyllene is present in said agave spirit replica at a concentration greater than about 0.007 mg/L.

Embodiment 105 is the method of embodiment 91, wherein said added VOCs comprise isobutyl alcohol, and wherein said isobutyl alcohol is present in said agave spirit replica at a concentration greater than about 650 mg/L.

Embodiment 106 is the method of embodiment 91, wherein said added VOCs comprise furfuryl alcohol, and wherein said furfuryl alcohol is present in said agave spirit replica at a concentration greater than about 8.5 mg/L.

Embodiment 107 is the method of embodiment 91, wherein said added VOCs comprise nonanal, and wherein said nonanal is present in said agave spirit replica at a concentration greater than about 0.06 mg/L.

Embodiment 108 is the method of embodiment 91, wherein said added VOCs comprise alpha-pinene, and wherein said alpha-pinene is present in said agave spirit replica at a concentration greater than about 0.01 mg/L.

Embodiment 109 is the method of embodiment 91, wherein said added VOCs comprise humulene, and wherein said humulene is present in said agave spirit replica at a concentration greater than about 0.01 mg/L.

Embodiment 110 is the method of embodiment 91, wherein said added VOCs comprise ethyl butyrate, and wherein said ethyl butyrate is present in said agave spirit replica at a concentration greater than about 1.6 mg/L.

Embodiment 111 is the method of embodiment 91, wherein said added VOCs comprise isoamyl octanoate, and wherein said isoamyl octanoate is present in said agave spirit replica at a concentration greater than about 0.6 mg/L.

Embodiment 112 is the method of embodiment 91, wherein said added VOCs comprise ethyl decanoate, and wherein said ethyl decanoate is present in said agave spirit replica at a concentration less than about 0.007 mg/L.

Embodiment 113 is the method of embodiment 91, wherein said added VOCs comprise 2-acetylfuran, and wherein said 2-acetylfuran is present in said agave spirit replica at a concentration less than about 0.05 mg/L.

Embodiment 114 is the method of embodiment 91, wherein said added VOCs comprise diethyl succinate, and wherein said diethyl succinate is present in said agave spirit replica at a concentration greater than about 2.3 mg/L.

Embodiment 115 is the method of embodiment 91, wherein said added VOCs comprise alpha-terpineol, and wherein said alpha-terpineol is present in said agave spirit replica at a concentration less than about 0.24 mg/L.

Embodiment 116 is the method of embodiment 91, wherein said added VOCs comprise octanoic acid, and wherein less than about 0.0013 wt % of the one or more additional VOCs is octanoic acid.

Embodiment 117 is the method of embodiment 91, wherein said added VOCs comprise thymol, and wherein greater than about 0.00053 wt % of the one or more additional VOCs is thymol.

Embodiment 118 is the method of embodiment 91, wherein said added VOCs comprise isoamyl alcohol, and wherein less than about 0.03 wt % of the one or more additional VOCs is isoamyl alcohol.

Embodiment 119 is the method of embodiment 91, wherein said added VOCs comprise p-cymene, and wherein greater than about 0.0000087 wt % of the one or more additional VOCs is p-cymene.

Embodiment 120 is the method of embodiment 91, wherein said added VOCs comprise caryophyllene, and wherein greater than about 0.0000067 wt % of the one or more additional VOCs is caryophyllene.

Embodiment 121 is the method of embodiment 91, wherein said added VOCs comprise isobutyl alcohol, and wherein greater than about 0.52 wt % of the one or more additional VOCs is isobutyl alcohol.

Embodiment 122 is the method of embodiment 91, wherein said added VOCs comprise furfuryl alcohol, and wherein greater than about 0.0086 wt % of the one or more additional VOCs is furfuryl alcohol.

Embodiment 123 is the method of embodiment 91, wherein said added VOCs comprise alpha-pinene, and wherein greater than about 0.000009 wt % of the one or more additional VOCs is alpha-pinene.

Embodiment 124 is the method of embodiment 91, wherein said added VOCs comprise ethyl butyrate, and wherein greater than about 0.0017 wt % of the one or more additional VOCs is ethyl butyrate.

Embodiment 125 is the method of embodiment 91, wherein said added VOCs comprise isoamyl octanoate, and wherein greater than about 0.0006 wt % of the one or more additional VOCs is isoamyl octanoate.

Embodiment 126 is the method of embodiment 91, wherein said added VOCs comprise ethyl decanoate, and wherein less than about 0.0000017 wt % of the one or more additional VOCs is ethyl decanoate.

Embodiment 127 is the method of embodiment 91, wherein said added VOCs comprise diethyl succinate, and wherein greater than about 0.0023 wt % of the one or more additional VOCs is diethyl succinate.

Embodiment 128 is the method of embodiment 91, wherein said added VOCs comprise alpha-terpineol, and wherein less than about 0.00006 wt % of the one or more additional VOCs is alpha-terpineol.

Embodiment 129 is an agave spirit replica produced by the method of any one of embodiments 65 to 128.

Embodiment 130 is a tequila-like alcoholic beverage concentrate comprising, consisting essentially of, or consisting of glycerin; optionally, a tequila, wherein said alcoholic beverage, after dilution to produce a final product, comprises no more than about 10 wt % of said tequila; optionally, an oak extract; optionally, a plant oil; and at least ten added VOCs, wherein said added VOCs comprise at least one acid, at least one additional alcohol, at least one aldehyde, at least one ester, at least one terpene, and at least one furan, and wherein at least one of said added VOCs is present in a concentration of at least about 2-fold the concentration of the same VOC in a corresponding traditional tequila or a corresponding non-concentrate tequila.

Embodiment 131 is the tequila-like alcoholic beverage concentrate of embodiment 130, wherein at least one of said added VOCs is present in the concentrate in a concentration of at least about 5-fold the concentration of the same VOCs in a corresponding traditional tequila or a corresponding non-concentrate tequila.

Embodiment 132 is the tequila-like alcoholic beverage concentrate of embodiment 130, wherein at least one of said added VOCs is present in the concentrate in a concentration of at least about 10-fold the concentration of the same VOCs in a corresponding traditional tequila or a corresponding non-concentrate tequila.

Embodiment 133 is the tequila-like alcoholic beverage concentrate of embodiment 130, wherein at least one of said added VOCs is present in the concentrate in a concentration of at least about 15-fold the concentration of the same VOCs in a corresponding traditional tequila or a corresponding non-concentrate tequila.

Embodiment 134 is the tequila-like alcoholic beverage concentrate of any one of embodiments 130 to 133, wherein upon dilution of said tequila-like beverage concentrate to a tequila-like alcoholic beverage, the tequila-like alcoholic beverage is the agave spirit replica of any one of embodiments 1 to 64.

Embodiment 135 is a method for making a tequila-like alcoholic beverage concentrate, the method comprising, or consisting essentially of, combining: glycerin; optionally, a tequila, wherein said alcoholic beverage, after dilution to produce a final product, comprises no more than about 10 wt % of said tequila; optionally, an oak extract; optionally, a plant oil; and at least ten added VOCs, wherein said added VOCs comprise at least one acid, at least one additional alcohol, at least one aldehyde, at least one ester, at least one terpene, and at least one furan, and wherein at least one of said added VOCs is present in a concentration of at least about 2-fold the concentration of the same VOC in a corresponding traditional tequila or a corresponding non-concentrate tequila.

Embodiment 136 is the method of embodiment 135, wherein at least one of said added VOCs is present in the concentrate in a concentration of at least about 5-fold the concentration of the same VOCs in a corresponding traditional tequila or a corresponding non-concentrate tequila.

Embodiment 137 is the method of embodiment 135, wherein at least one of said added VOCs is present in the concentrate in a concentration of at least about 10-fold the concentration of the same VOCs in a corresponding traditional tequila or a corresponding non-concentrate tequila.

Embodiment 138 is the method of embodiment 135, wherein at least one of said added VOCs is present in the concentrate in a concentration of at least about 15-fold the concentration of the same VOCs in a corresponding traditional tequila or a corresponding non-concentrate tequila.

Embodiment 139 is the method of any one of embodiments 135 to 138, wherein upon dilution of the tequila-like beverage concentrate to a tequila-like alcoholic beverage, the tequila-like alcoholic beverage is the agave spirit replica of any one of embodiments 1 to 64.

Embodiment 140 is an alcoholic beverage comprising (or consisting essentially of or consisting of) water; a grain neutral spirit, a tequila, wherein the alcoholic beverage comprises no more than about 10 wt % of the tequila; glycerin; optionally, an oak extract; optionally, a plant oil; and at least ten added VOCs, wherein the added VOCs comprise at least one acid, at least one additional alcohol, at least one aldehyde, at least one ester, at least one ketone, and at least one terpene, and wherein the added VOCs comprise about 0.001 wt % to about 0.1 wt % of the alcoholic beverage.

Embodiment 141 is the alcoholic beverage of embodiment 140, wherein the at least one acid comprises one or more of acetic acid, decanoic acid, hexanoic acid, lauric acid, myristic acid, octanoic acid, and propionic acid.

Embodiment 142 is the alcoholic beverage of embodiment 140 or embodiment 141, wherein the at least one additional alcohol comprises one or more of 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, and nerolidol.

Embodiment 143 is the alcoholic beverage of any one of embodiments 140 to 142, wherein the at least one aldehyde comprises one or more of 3-methylbutyraldehyde, 5-methylfurfural, acetal, acetaldehyde, furfural, and vanillin.

Embodiment 144 is the alcoholic beverage of any one of embodiments 140 to 143, wherein the at least one ester comprises one or more of diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, and phenethyl acetate.

Embodiment 145 is the alcoholic beverage of any one of embodiments 140 to 144, wherein the at least one ketone comprises one or more of acetoin, acetone, methylcyclopentenolone, and piperine.

Embodiment 146 is the alcoholic beverage of any one of embodiments 140 to 145, wherein the at least one terpene comprises one or more of 1-octene, d-limonene, linalool, linalool oxide, myrcene, and p-cymene.

Embodiment 147 is the alcoholic beverage of any one of embodiments 140 to 146, wherein the added VOCs further comprise one or more of dimethyl disulfide, methyl sulfide, and pyridine.

Embodiment 148 is the alcoholic beverage of any one of embodiments 140 to 147, wherein the added VOCs comprise ten or more compounds selected from the group consisting of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 149 is the alcoholic beverage of any one of embodiments 140 to 147, wherein the added VOCs comprise 20 or more compounds selected from the group consisting of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 150 is the alcoholic beverage of any one of embodiments 140 to 149, comprising from about 5 wt % to about 70 wt % water; from about 30 wt % to about 95 wt % grain neutral spirits; not more than about 5 wt % tequila; from about 0.1 wt % to about 5 wt % glycerin; and from about 0.001 wt % to about 1 wt % added VOCs, wherein the added VOCs comprise ten or more compounds selected from the group consisting of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 151 is the alcoholic beverage of embodiment 150, wherein the added VOCs consist of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 152 is a method for making an alcoholic beverage, wherein the method comprises (or consists essentially of or consists of) combining water; a grain neutral spirit; a tequila, wherein the alcoholic beverage comprises no more than about 10 wt % of the tequila; glycerin; optionally, an oak extract; optionally, a plant oil; and at least ten added VOCs, wherein the VOCs are provided as separate ingredients and comprise at least one acid, at least one additional alcohol, at least one aldehyde, at least ester, at least one ketone, and at least one terpene, and wherein the added VOCs comprise about 0.001 wt % to about 1 wt % of the alcoholic beverage.

Embodiment 153 is the method of embodiment 152, wherein the at least one acid comprises one or more of acetic acid, decanoic acid, hexanoic acid, lauric acid, myristic acid, octanoic acid, and propionic acid.

Embodiment 154 is the method of embodiment 152 or embodiment 153, wherein the at least one additional alcohol comprises one or more of 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, and nerolidol.

Embodiment 155 is the method of any one of embodiments 152 to 154, wherein the at least one aldehyde comprises one or more of 3-methylbutyraldehyde, 5-methylfurfural, acetal, acetaldehyde, furfural, and vanillin.

Embodiment 156 is the method of any one of embodiments 152 to 155, wherein the at least one ester comprises one or more of diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, and phenethyl acetate.

Embodiment 157 is the method of any one of embodiments 152 to 156, wherein the at least one ketone comprises one or more of acetoin, acetone, methylcyclopentenolone, and piperine.

Embodiment 158 is the method of any one of embodiments 152 to 157, wherein the at least one terpene comprises one or more of 1-octene, d-limonene, linalool, linalool oxide, myrcene, p-cymene.

Embodiment 159 is the method of any one of embodiments 152 to 158, wherein the added VOCs further comprise one or more of dimethyl disulfide, methyl sulfide, and pyridine.

Embodiment 160 is the method of any one of embodiments 152 to 159, wherein the added VOCs comprise ten or more compounds selected from the group consisting of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 161 is the alcoholic beverage of any one of embodiments 152 to 159, wherein the added VOCs comprise 20 or more compounds selected from the group consisting of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 162 is the method of any one of embodiments 152 to 161, wherein the alcoholic beverage comprises (or consists essentially of or consists of) from about 5 wt % to about 70 wt % water; from about 30 wt % to about 95 wt % grain neutral spirits, not more than about 5 wt % tequila; from about 0.0001 wt % to about 5 wt % glycerin; and from about 0.001 wt % to about 1 wt % added VOCs, wherein the added VOCs comprise ten or more compounds selected from the group consisting of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 163 is the method of embodiment 162, wherein the added VOCs consist of acetic acid, decanoic acid, hexanoic acid, lauric acid, myristic acid, octanoic acid, propionic acid, 2-methyl-1-butanol, 1-decanol, 1-octen-3-ol, 2-heptanol, 2,3-butanediol, 2,4,6-trimethylphenol, 4-ethylguaiacol, carvacrol, farnesol, furfuryl alcohol, fuselol, hexyl alcohol, isoamyl alcohol, isobutyl alcohol, phenethyl alcohol, phenol, propyl alcohol, thymol, nerolidol, 3-methylbutyraldehyde, 5-methylfurfural, acetal, acetaldehyde, furfural, vanillin, diethyl succinate, ethyl acetate, ethyl benzoate, ethyl butyrate, ethyl decanoate, ethyl heptanoate, ethyl hexanoate, ethyl lactate, ethyl laurate, ethyl octanoate, ethyl palmitate, ethyl propionate, heptyl acetate, isoamyl acetate, isoamyl hexanoate, isoamyl octanoate, isobutyl acetate, linalyl propionate, methyl propionate, octyl acetate, phenethyl acetate, acetoin, acetone, methylcyclopentenolone, piperine, dimethyl disulfide, methyl sulfide, pyridine, 1-octene, d-limonene, linalool, linalool oxide, myrcene, and p-cymene.

Embodiment 164 is an alcoholic beverage produced by the method of any one of embodiments 152 to 163.

Embodiment 165 is a tequila-like alcoholic beverage concentrate comprising (or consisting essentially of or consisting of) a tequila, wherein the alcoholic beverage, after dilution to produce a final product, comprises no more than about 10 wt % of the tequila; glycerin; optionally, an oak extract; optionally, a plant oil; and at least ten added VOCs, wherein the added VOCs comprise at least one acid, at least one additional alcohol, at least one aldehyde, at least one ester, at least one ketone, and at least one terpene, and wherein at least one of the added VOCs is present in a concentration of at least about 2-fold the concentration of the same VOC in a corresponding traditional tequila or a corresponding non-concentrate tequila.

Embodiment 166 is the tequila-like alcoholic beverage concentrate of embodiment 165, wherein at least one of the added VOCs is present in the concentrate in a concentration of at least about 5-fold the concentration of the same VOCs in a corresponding traditional tequila or a corresponding non-concentrate tequila.

Embodiment 167 is the tequila-like alcoholic beverage concentrate of embodiment 165, wherein at least one of the added VOCs is present in the concentrate in a concentration of at least about 10-fold the concentration of the same VOCs in a corresponding traditional tequila or a corresponding non-concentrate tequila.

Embodiment 168 is the tequila-like alcoholic beverage concentrate of embodiment 165, wherein at least one of the added VOCs is present in the concentrate in a concentration of at least about 15-fold the concentration of the same VOCs in a corresponding traditional tequila or a corresponding non-concentrate tequila.

Embodiment 169 is the tequila-like alcoholic beverage concentrate of any one of embodiments 165 to 168, wherein upon dilution of the tequila-like beverage concentrate to a tequila-like alcoholic beverage, the tequila-like alcoholic beverage is the alcoholic beverage of any one of embodiments 1 to 12.

Embodiment 170 is a method of making a tequila-like alcoholic beverage concentrate, the method comprising (or consisting essentially of or consisting of) combining a tequila, wherein the alcoholic beverage, after dilution to produce a final product, comprises no more than about 10 wt % of the tequila; glycerin; optionally, an oak extract; optionally, a plant oil; and at least ten added VOCs, wherein the added VOCs comprise at least one acid, at least one additional alcohol, at least one aldehyde, at least one ester, at least one ketone, and at least one terpene, and wherein at least one of the added VOCs is present in a concentration of at least about 2-fold the concentration of the same VOC in a corresponding traditional tequila or a corresponding non-concentrate tequila.

Embodiment 171 is the method of embodiment 170, wherein at least one of the added VOCs is present in the concentrate in a concentration of at least about 5-fold the concentration of the same VOCs in a corresponding traditional tequila or a corresponding non-concentrate tequila.

Embodiment 172 is the method of embodiment 170, wherein at least one of the added VOCs is present in the concentrate in a concentration of at least about 10-fold the concentration of the same VOCs in a corresponding traditional tequila or a corresponding non-concentrate tequila.

Embodiment 173 is the method of embodiment 170, wherein at least one of the added VOCs is present in the concentrate in a concentration of at least about 15-fold the concentration of the same VOCs in a corresponding traditional tequila or a corresponding non-concentrate tequila.

Embodiment 174 is the method of any one of embodiments 170 to 173, wherein upon dilution of the tequila-like beverage concentrate to a tequila-like alcoholic beverage, the tequila-like alcoholic beverage is the alcoholic beverage of any one of embodiments 140 to 151.

The invention will be further described in the following examples, which do not limit the scope of the invention described in the claims.

### EXAMPLES

### Example 1—Exemplary Flavored Tequila-Like Alcoholic Beverage

Tequila replicas were prepared using the components listed in TABLE 1A. In some cases, the ingredients included the exemplary VOCs listed in TABLES 1B-1F. The ingredients were added to a mixing tank in no particular order, and were mixed for 15-20 minutes and then held until being placed into the desired containers (e.g., bottles or cans).

The tequila replica had a final ABV of 40%, and was comparable to tequila crafted by traditional methods in terms of its flavor, aroma, mouthfeel, and overall sensory experience.

It also is to be noted that while tequila replicas can include added VOCs and, in some cases, non-volatile compounds, the added compounds may react with one another to generate additional compounds, or to change the effective amount of one or more of the added compounds within the tequila replica formulation.

TABLE 1A
Exemplary tequila replica formulation

| Ingredient | Exemplary wt % |
|---|---|
| Water | 5-70 |
| Alcohol (grain | 30-95 |
| neutral spirits | |
| and traditional | |
| tequila) | |
| Glycerin | 0.1-5 |
| Oak Extract | 0-15 |
| Plant oil(s) | 0-0.002 |
| Total VOCs: | 0.001-0.8 |
| Acid(s) | 0-0.1 |
| Alcohol(s) | 0-0.1 |
| Aldehyde(s) | 0-0.1 |
| Ester(s) | 0-0.1 |
| Ketone(s) | 0-0.1 |
| Terpene(s) | 0-0.1 |

TABLE 1B
Exemplary VOCs in tequila replica

| | Exemplary wt % |
|---|---|
| VOC | (in replica) |
| acetic acid | 0.000105-0.026316 |
| decanoic acid | 0.000526-0.005263 |
| hexanoic acid | 0.000105-0.002105 |
| lauric acid | 0.000211-0.001579 |
| myristic acid | 0.0001-0.00042 |
| octanoic acid | 0.000316-0.004316 |
| propionic acid | 0.000001-0.000158 |
| 2-methyl-1-butanol | 0.000026-0.034632 |
| 1-decanol | 0.000047-0.000263 |
| 1-octen-3-ol | 0.000025-0.00011 |
| 2-heptanol | 0.00005-0.00021 |
| 2,3-butanediol | 0.00008-0.00032 |
| 2,4,6-trimethylphenol | 0.000079-0.000158 |
| 4-ethylguaiacol | 0.000005-0.000022 |
| carvacrol | 0.000063-0.000126 |
| farnesol | 0.00005-0.00021 |
| furfuryl alcohol | 0.001158-0.001684 |
| fuselol | 0.000263-0.002105 |
| hexyl alcohol | 0.000105-0.000326 |
| isoamyl alcohol | 0.000526-0.050737 |
| isobutyl alcohol | 0.001053-0.032526 |
| phenethyl alcohol | 0.004-0.016 |
| phenol | 0.0001-0.00042 |
| propyl alcohol | 0.000063-0.019263 |
| thymol | 0-0.000316 |
| nerolidol | 0.00007-0.00028 |
| 3-methylbutyraldehyde | 0.000032-0.000042 |
| 5-methylfurfural | 0.00008-0.00035 |
| acetal | 0.000105-0.005263 |
| acetaldehyde | 0.001158-0.005137 |
| furfural | 0.000316-0.002105 |
| vanillin | 0.000105-0.000526 |
| diethyl succinate | 0.000495-0.000737 |
| ethyl acetate | 0.001579-0.008737 |
| ethyl benzoate | 0.000011-0.000053 |
| ethyl butyrate | 0.000526-0.002105 |
| ethyl decanoate | 0.000105-0.000947 |
| ethyl heptanoate | 0.000018-0.000074 |
| ethyl hexanoate | 0.000018-0.000074 |
| ethyl lactate | 0.000316-0.001579 |
| ethyl laurate | 0.000074-0.000947 |
| ethyl octanoate | 0.000105-0.000421 |
| ethyl palmitate | 0.0001-0.00042 |
| ethyl propionate | 0.000211-0.005263 |
| heptyl acetate | 0.000026-0.000316 |
| isoamyl acetate | 0.000025-0.00012 |
| isoamyl hexanoate | 0.00025-0.00011 |
| isoamyl octanoate | 0.00037-0.0015 |
| isobutyl acetate | 0.00025-0.0011 |
| linalyl propionate | 0.00013-0.00053 |
| methyl propionate | 0.00005-0.00021 |
| octyl acetate | 0.000063-0.000158 |
| phenethyl acetate | 0.000011-0.000737 |
| acetoin | 0.000211-0.000316 |
| acetone | 0.000018-0.00008 |
| methylcyclopentenolone | 0.00003-0.00013 |
| piperine | 0.000023-0.000132 |
| dimethyl disulfide | 0.000004-0.000007 |
| methyl sulfide | 0.000002-0.000008 |
| pyridine | 0.0000025-0.00001 |
| 1-octene | 0.0000005-0.000002 |
| d-limonene | 0.000021-0.000158 |
| linalool | 0.000011-0.000526 |
| linalool oxide | 0.000063-0.000263 |
| myrcene | 0.000016-0.000063 |
| p-cymene | 0.000042-0.000316 |

TABLE 1C
Exemplary VOCs in tequila replica

| | Exemplary wt % |
|---|---|
| VOC | (in replica) |
| 1-butanol | 0.00279-0.0112 |
| propyl alcohol | 0.0139-0.0557 |
| 2-acetylfuran | 0.000000933-0.00000373 |
| 2-methyl-1-butanol | 0.00969-0.0387 |
| isobutyl alcohol | 0.00698-0.0279 |
| isoamyl alcohol | 0.00843-0.0337 |
| acetaldehyde | 0.00124-0.00495 |
| alpha-phellandrene | 0.00013-0.000522 |
| alpha-terpineol | 0.000000318-0.00000127 |
| beta-bisabolene | 0.0000093-0.0000372 |
| beta-myrcone | 0.000000813-0.00000325 |
| beta-pinene | 0.00000871-0.0000385 |
| butyl acetate | 0.00000542-0.0000217 |
| caryophyllene | 0.0000454-0.000182 |
| diethyl succinate | 0.000287-0.00115 |
| D-limonene | 0.0000283-0.000113 |
| ethyl acetate | 0.00375-0.0150 |
| ethyl benzoate | 0.0000042-0.0000168 |
| ethyl butyrate | 0.00036-0.00144 |
| ethyl decanoate | 0.00000912-0.0000365 |
| ethyl hexanoate | 0.00000908-0.0000363 |
| ethyl lactate | 0.000781-0.00313 |
| ethyl laurate | 0.00000438-0.0000175 |
| ethyl octanoate | 0.0000452-0.000181 |
| ethyl propionate | 0.000387-0.00154 |
| eucalyptol | 0.0000116-0.0000464 |
| furfuryl alcohol | 0.000578-0.00231 |
| fuselol | 0.0152-0.0607 |
| gamma-terpinene | 0.00000025-0.00000100 |
| heptyl acetate | 0.00000835-0.0000334 |
| hexanoic acid | 0.00142-0.00567 |
| isoamyl acetate | 0.0000658-0.000263 |
| isoamyl octanoate | 0.0000574-0.000230 |
| isobutyl hexanoate | 0.000000341-0.00000137 |
| isoamyl hexanoate | 0.0000676-0.000270 |
| isovaleraldehyde | 0.0000251-0.000101 |
| lauric acid | 0.000271-0.00108 |
| linalool | 0.0000456-0.000183 |
| decanoic acid | 0.000947-0.00379 |
| nonanal | 0.000000771-0.00000308 |
| nonanal | 0.00096-0.00384 |
| octanoic acid | 0.0000271-0.000108 |
| octyl acetate | 0.0000265-0.000106 |
| p-cymene | 0.0000251-0.000101 |
| terpinolene | 0.00000192-0.00000768 |
| thymol | 0.000337-0.00135 |

TABLE 1D
Exemplary VOCs in tequila replica

| | Exemplary wt % |
|---|---|
| VOC | (in replica) |
| 1-butanol | 0.00244-0.00976 |
| propyl alcohol | 0.0129-0.0518 |
| 2-acetylfuran | 0.00000125-0.00000499 |
| 2-methyl-1-butanol | 0.00989-0.0396 |
| isobutyl alcohol | 0.00699-0.0280 |
| isoamyl alcohol | 0.000284-0.00113 |
| acetaldehyde | 0.000181-0.000725 |
| alpha-phellandrene | 0.0000992-0.000397 |
| alpha-terpineol | 0.000000261-0.00000105 |
| beta-bisabolene | 0.00000979-0.0000392 |
| beta-myrcene | 0.00000449-0.0000179 |
| beta-pinene | 0.00000835-0.0000334 |
| butyl acetate | 0.00000663-0.0000265 |
| caryophyllene | 0.0000276-0.000110 |
| diethyl succinate | 0.000304-0.00122 |
| D-limonene | 0.0000184-0.0000735 |
| ethyl acetate | 0.00395-0.0158 |
| ethyl benzoate | 0.00000479-0.0000191 |
| ethyl butyrate | 0.000457-0.00183 |
| ethyl decanoate | 0.00000796-0.0000319 |
| ethyl hexanoate | 0.00000956-0.0000383 |
| ethyl lactate | 0.00081-0.00324 |
| ethyl laurate | 0.00000496-0.0000198 |
| ethyl octanoate | 0.0000479-0.000192 |
| ethyl propionate | 0.000327-0.00131 |
| eucalyptol | 0.00000896-0.0000358 |
| furfuryl alcohol | 0.000586-0.00234 |
| fuselol | 0.0163-0.0653 |
| gamma-terpinene | 0.0000000569-0.00000023 |
| heptyl acetate | 0.00000765-0.0000306 |
| hexanoic acid | 0.00131-0.00523 |
| isoamyl acetate | 0.0000464-0.000185 |
| isoamyl octanoate | 0.0000608-0.000243 |
| isoamyl hexanoate | 0.0000939-0.000375 |
| isovaleraldehyde | 0.0000416-0.000166 |
| lauric acid | 0.000184-0.000735 |
| linalool | 0.000046-0.000184 |
| decanoic acid | 0.0008-0.00320 |
| nonanal | 0.000000742-0.00000297 |
| octanoic acid | 0.000977-0.00391 |
| octyl acetate | 0.0000219-0.0000876 |
| p-cymene | 0.0000245-0.0000979 |
| terpinolene | 0.00000298-0.0000119 |
| thymol | 0.000316-0.00126 |

TABLE 1E
Exemplary VOCs in tequila replica

| | Exemplary wt % |
|---|---|
| VOC | (in replica) |
| propyl alcohol | 0.0136-0.0544 |
| 2-acetylfuran | 0.000225-0.000902 |
| 2-methyl-1-butanol | 0.0135-0.0538 |
| isobutyl alcohol | 0.215-0.861 |
| 3-carene | 0.00000475-0.0000190 |
| isoamyl alcohol | 0.00608-0.0243 |
| acetaldehyde | 0.00102-0.00407 |
| alpha-phellandrene | 0.000156-0.000625 |
| alpha-terpineol | 0.0000171-0.0000683 |
| beta-bisabolene | 0.000000622-0.00000249 |
| beta-myrcene | 0.0000156-0.0000624 |
| beta-pinene | 0.00000485-0.0000194 |
| butyl acetate | 0.00000201-0.00000804 |
| camphene | 0.000000255-0.00000102 |
| caryophyllene | 0.0000303-0.000121 |
| diethyl succinate | 0.0000134-0.0000536 |
| D-limonene | 0.0000573-0.000229 |
| ethyl acetate | 0.00185-0.00738 |
| ethyl benzoate | 0.000000702-0.00000281 |
| ethyl butyrate | 0.000141-0.000565 |
| ethyl decanoate | 0.00000241-0.00000963 |
| ethyl hexanoate | 0.0000181-0.0000723 |
| ethyl lactate | 0.000552-0.00221 |
| ethyl octanoate | 0.000452-0.00181 |
| ethyl propionate | 0.000135-0.000539 |
| eucalyptol | 0.00000864-0.0000355 |
| furfuryl alcohol | 0.00055-0.00220 |
| fuselol | 0.0138-0.0551 |
| gamma-terpinene | 0.00000391-0.0000156 |
| hexanoic acid | 0.00244-0.00974 |
| humulene | 0.000000872-0.00000349 |
| isoamyl acetate | 0.000425-0.00170 |
| isoamyl octanoate | 0.0000481-0.000192 |
| isobutyl acetate | 0.000119-0.000475 |
| isobutyl hexanoate | 0.000000192-0.000000770 |
| isoamyl hexanoate | 0.0000464-0.000186 |
| isovaleraldehyde | 0.0000157-0.0000629 |
| lauric acid | 0.0000299-0.000120 |
| linalool | 0.000193-0.000773 |
| decanoic acid | 0.00151-0.00604 |
| nonanal | 0.000011-0.0000440 |
| octanoic acid | 0.000122-0.000489 |
| octyl acetate | 0.0000132-0.0000526 |
| p-cymene | 0.000074-0.000296 |
| phenethyl alcohol | 0.00168-0.00671 |
| terpinolene | 0.000000543-0.00000217 |
| thymol | 0.000274-0.00110 |

TABLE 1F
Exemplary VOCs in tequila replica

| | Exemplary wt % |
|---|---|
| VOC | (in replica) |
| propyl alcohol | 0.0144-0.0575 |
| 2-acetylfuran | 0.000223-0.000891 |
| 2-methyl-1-butanol | 0.0117-0.0468 |
| isobutyl alcohol | 0.202-0.810 |
| 3-carene | 0.00000168-0.00000672 |
| isoamyl alcohol | 0.00719-0.0288 |
| acetaldehyde | 0.00102-0.00408 |
| alpha-phellandrene | 0.000157-0.000628 |
| alpha-pinene | 0.00000182-0.00000729 |
| alpha-terpineol | 0.00000919-0.0000368 |
| beta-bisabolene | 0.00000191-0.00000763 |
| beta-myrcene | 0.0000167-0.0000668 |
| beta-pinene | 0.00000318-0.0000127 |
| butyl acetate | 0.00000114-0.00000455 |
| camphene | 0.000000265-0.00000106 |
| caryophyllene | 0.0000162-0.0000647 |
| diethyl succinate | 0.0000134-0.0000536 |
| D-limonene | 0.0000425-0.000170 |
| ethyl acetate | 0.00177-0.00709 |
| ethyl benzoate | 0.000000898-0.00000359 |
| ethyl butyrate | 0.000196-0.000786 |
| ethyl decanoate | 0.0000000533-0.00000021 |
| ethyl hexanoate | 0.00000922-0.0000369 |
| ethyl lactate | 0.000156-0.000626 |
| ethyl octanoate | 0.000269-0.00108 |
| ethyl propionate | 0.000109-0.000438 |
| eucalyptol | 0.00000919-0.0000368 |
| furfuryl alcohol | 0.000486-0.00195 |
| fuselol | 0.0151-0.0604 |
| gamma-terpinene | 0.000002-0.00000800 |
| hexanoic acid | 0.00224-0.00898 |
| isoamyl acetate | 0.000405-0.00162 |
| isoamyl octanoate | 0.0000393-0.000157 |
| isobutyl acetate | 0.0000211-0.0000842 |
| isovaleraldehyde | 0.0000168-0.0000674 |
| linalool | 0.00018-0.000719 |
| decanoic acid | 0.00121-0.00485 |
| nonanal | 0.000000816-0.00000326 |
| octyl acetate | 0.0000126-0.0000502 |
| p-cymene | 0.0000478-0.000191 |
| phenethyl alcohol | 0.00133-0.00533 |
| thymol | 0.000279-0.00112 |

### Example 2—Scaled Up Production and Generation of Concentrated Tequila Replicas

It is to be noted that the above process, and similar processes using variations of the ingredient list, are scaled up for commercial production of a tequila-like alcoholic beverage. Such scaled up processes (e.g., to generate 1000 L or more) can utilize tanks or vat, for example.

Tequila replica concentrates are made in ˜100 L test batches and held for a minimum of 8 weeks, with periodic sampling at 1, 2, 4, 6, and 8 weeks. Density measurements are taken each week, and three replicate bottles of tequila replicas are produced by adding 43% ABV neutral grain spirits prior to filtering through a 0.45 PVDF vacuum filter. Samples are then submitted for analytical testing versus a corresponding non-concentrated tequila replica, and versus each other, to assess volatile and non-volatile components. Organoleptic comparisons also are conducted. The concentrates are held in HDPE vessels, or in stainless steel at the highest concentration, to ensure that there are no changes in composition due to the storage material.

To find the appropriate volume of concentrate (5×, 10×, or 20×) to add to create a finished product, the following formulas are used:

$$( {C}_{concentrate} ) ( {V}_{concentrate} ) = ( {C}_{final product} ) ( {V}_{final product} )$$

$${V}_{concentrate} = \frac{( 1 ) ( {V}_{final product} )}{( {C}_{concentrate} )}$$

### Where:

C_{final product}=concentration of final product=1 (i.e., 1×)
V_{final product}=desired volume of finished product
C_{concentrate}=concentration of the concentrate (5×, 10×, or 20×)
V_{concentrate}=volume of concentrate to add to create finished product

### Example 3—VOCs and Non-VOCs in Reference Tequila Samples

GC-MS/MS and GC-LECO-TOF-MS were used to assess the amounts of various VOCs in traditional tequilas.

GC-MS/MS Conditions: All analyses were performed using an Agilent 7890B GC interfaced with a 7000D Triple Quadrupole mass spectrometer, and equipped with a PAL RSI 85 autosampler with syringe attachment. The injection volume was 1.0 μL. Liquid injections had a split ratio of 1:20, with a desorption temperature of 250° C. The column was a 30 m×0.25 mm×0.25 Agilent DB-WAX (ultra inert). Helium was used as the carrier gas at a constant flow rate of 1.3 mL/min. The MS ion source temperature and interface temperature were 250° C. The temperature program was as follows: initial temperature 40° C., held for 2 minutes, then increased to 210° C. at a rate of 10° C./min, and held for 5 minutes, for a total run time of 24 minutes.

GC-LECO-TOF-MS Conditions: All analyses were performed using an Agilent 7890B GC interfaced with a 7820 LECO-TOF mass spectrometer and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco, Bellefonte, PA). HS-SPME autosampler conditions were as follows: pre-incubation time of 5 minutes, incubation temperature of 60° C., extraction time of 15 minutes, and desorption time 5 minutes. Post-desorption fiber conditioning time was 30 minutes. SPME injections had a split ratio of 1:20, with a desorption temperature of 250° C. The columns were a 29.69 m×0.25 mm×0.25 Agilent Rxi-5 MS column attached to a 1.09 m×0.25 mm×0.25 Agilent Rxi-17 Sil MS column. Helium was used as the carrier gas at a constant flow rate of 1 mL/min. The MS ion source temperature and interface temperature were 250° C. The temperature program was as follows: initial temperature 40° C., held for 2 minutes, then increased to 90° C. at a rate of 10° C./min and held for 2 min, then increased to 132° C. at a rate of 10° C./min and held for 2 min, then increased to 145° C. at a rate of 10° C./min and held for 2 min, and finally increased to 240° C. at a rate of 10° C./min held for 5 minutes, for a total run time of 33 minutes.

Selection of target compounds and MRM method development: An outline of the general workflow for GC-MS analyses is as follows. Real samples were first analyzed in full scan mode (m/z 15-550) on the GC/MS-LECO to identify potential target compounds. Collected data were analyzed manually using LECO ChromaTOF Software. Multiple Reaction Monitoring (MRM) optimization was performed for commercially available standards. First, full scan experiments were repeated with liquid injection (10 mg/L in either pure MeOH or DCM) to verify retention time and potential precursor ions. Product ion scans were performed using liquid injection and collision energy of 30 V. Optimized MRM transitions and collision energies were selected and are displayed in TABLES 2A and 2B. A dynamic MRM (dMRM) method was developed for the generation of calibration curves, as described below. Compounds were divided into nine methods (TABLES 2A and 2B respectively) to minimize simultaneous transitions (no greater than 6).

Preparation of calibration curves for GC-MS/MS: All calibration solutions were prepared as 1 mL in either pure MeOH or DCM in 2-mL amber vials. The concentration range was originally 1-1000 μg/L and then varied based on LOD and expected concentration per compound.

Preparation of calibration curves for GC-LECO-TOF-MS: All calibration solutions were prepared as 10 mL of 10% EtOH in milli-Q water in 20-mL amber vials, with 3 g of salt added to enhance volatility. This concentration of EtOH minimized swelling of the SPME fiber to maximize signal despite the dilution factor. The concentration range was 0.1-50 mg/L.

Quantification in real samples for GC-MS/MS: All samples (15 mL initial volume) were extracted with 3×5 mL DCM and the combined extract was dried with anhydrous magnesium sulfate. Then 1 mL of dried extract was transferred to a 2 mL amber auto vial and were analyzed using Agilent Quantitative Analysis (for QQQ). Values reported as not detected (ND) may are considered to be below the limits of detection (LODs) listed in TABLE 2A. LODs were approximated based on S/N ratios as generated by the MassHunter software.

Quantification in real samples for GC-LECO-TOF-MS: All samples (reference samples and replica samples) were prepared as 10 mL in 20-mL amber vials with 3 g of salt and were diluted (4×) in milli-Q water to achieve a final concentration of 10% EtOH. Concentrations were later corrected to account for the dilution factor of the sample. All data were collected in triplicate and were analyzed using Chroma-TOF software. Values reported as not detected (ND) are considered to be below the limits of detection (LODs) listed in TABLE 2B. LODs were approximated based on S/N ratios as generated by the Chroma-TOF software.

Various reference tequila samples were assayed by GC-MS; the levels of VOCs therein are shown in TABLES 3A-3C. In these tables, each column is designated by a numeral that refers to a particular tequila.

TABLE 2A
GC/MS/MS Method Transitions and Figures of Merit

| Compound Method | | | | Calibration | |
|---|---|---|---|---|---|
| | RT | | Collision | Range | LOD |
| Name | (min) | Transition | Energy | (mg/L) | (mg/L) |
| isoamyl acetate | 5.816 | 70.0 → 39.0 | 30 | 0.005-1.0 | 0.005 |
| heptyl acetate | 9.54 | 70.0 → 39.0 | 30 | 0.01-1.0 | 0.01 |
| octyl acetate | 10.91 | 70.0 → 40.0 | 30 | 0.1-1.0 | 0.1 |
| butyl acetate | 5.046 | 73.0 → 43.0 | 30 | 0.005-1.0 | 0.005 |
| octanoic acid | 17.574 | 60.0 → 45.0 | 30 | 1.0-100.0 | 1.0 |
| hexanoic acid | 15.364 | 60.0 → 43.0 | 30 | 1.0-100.0 | 1.0 |
| decanoic acid | 19.634 | 73.0 → 46.0 | 30 | 20.0-100.0 | 20.0 |
| lauric acid | 22.374 | 73.0 → 55.0 | 30 | 1.0-100.0 | 1.0 |
| isobutyl alcohol | 5.295 | 43.0 → 39.0 | 30 | 0.001-1.0 | 0.001 |
| 2-methyl-1-butanol | 7.048 | 70.0 → 39.0 | 30 | 0.02-1.0 | 0.02 |
| 1-butanol | 6.085 | 56.0 → 39.0 | 30 | 0.001-1.0 | 0.001 |
| phenethyl alcohol | 15.975 | 91.0 → 65.0 | 30 | 0.02-1.0 | 0.02 |
| 1-decanol | 14.312 | 70.0 → 39.0 | 30 | 0.1-1.0 | 0.1 |
| propyl alcohol | 3.351 | 45.0 → 29.0 | 30 | 0.02-1.0 | 0.02 |
| furfuryl alcohol | 13.198 | 98.0 → 42.0 | 30 | 0.001-1.0 | 0.001 |
| thymol | 18.678 | 135.0 → 91.0 | 30 | 0.001-1.0 | 0.001 |
| nonanal | 9.792 | 98.0 → 41.1 | 30 | 0.005-1.0 | 0.005 |
| alpha-pinene | 4.213 | 93.0 → 51.1 | 30 | 0.001-1.0 | 0.001 |
| 3-carene | 6.126 | 136.0 → 91.1 | 30 | 0.005-1.0 | 0.005 |
| gamma-terpinene | 7.622 | 136.0 → 77.0 | 30 | 0.001-1.0 | 0.001 |
| camphene | 4.838 | 121.0 → 77.0 | 30 | 0.001-1.0 | 0.001 |
| humulene | 13.333 | 147.0 → 105.0 | 30 | 0.005-1.0 | 0.005 |
| ethyl propionate | 3.434 | 57.0 → 27.0 | 30 | 0.001-0.1 | 0.001 |
| ethyl butyrate | 4.501 | 71.0 → 41.0 | 30 | 0.01-1.0 | 0.01 |
| ethyl octanoate | 10.37 | 88.0 → 43.0 | 30 | 0.005-1.0 | 0.005 |
| ethyl laurate | 15.276 | 88.0 → 61.0 | 30 | 0.05-1.0 | 0.05 |
| ethyl hexanoate | 7.514 | 88.0 → 42.0 | 30 | 0.005-1.0 | 0.005 |
| ethyl benzoate | 13.323 | 105.0 → 51.0 | 30 | 0.001-0.1 | 0.001 |
| ethyl lactate | 9.144 | 45.0 → 43.0 | 30 | 0.05-1.0 | 0.05 |
| isoamyl hexanoate | 10.688 | 70.0 → 39.0 | 30 | 0.01-1.0 | 0.01 |
| isoamyl octanoate | 13.189 | 70.0 → 39.0 | 30 | 0.01-1.0 | 0.01 |
| ethyl decanoate | 12.942 | 101.0 → 55.0 | 30 | 0.005-1.0 | 0.005 |
| 2-acetylfuran | 11.313 | 95.0 → 39.0 | 30 | 0.001-0.1 | 0.001 |
| diethyl succinate | 13.437 | 101.0 → 45.0 | 30 | 0.005-1.0 | 0.005 |
| alpha-terpincol | 13.589 | 136.0 → 77.0 | 30 | 0.01-1.0 | 0.01 |
| Fuselol | 7.032 | 70.2 → 39.1 | 30 | 0.02-1.0 | 0.02 |
| beta-pinene | 5.431 | 93.0 → 51.0 | 30 | 0.001-0.1 | 0.001 |
| beta-myrcene | 6.381 | 93.0 → 65.0 | 30 | 0.005-1.0 | 0.005 |
| alpha-phellandrene | 6.355 | 93.0 → 77.0 | 30 | 0.005-1.0 | 0.005 |
| terpinolene | 8.164 | 121.0 → 77.0 | 30 | 0.005-1.0 | 0.005 |
| p-cymene | 7.996 | 119.0 → 91.0 | 30 | 0.001-0.1 | 0.001 |
| D-limonene | 6.879 | 93.0 → 91.0 | 30 | 0.005-1.0 | 0.005 |
| linalool | 11.781 | 93.0 → 51.0 | 30 | 0.01-1.0 | 0.01 |
| caryophyllene | 12.451 | 133.0 → 91.0 | 30 | 0.01-1.0 | 0.01 |
| beta-bisabolene | 13.966 | 93.0 → 77.0 | 30 | 0.01-1.0 | 0.01 |
| eucalyptol | 7.004 | 154.0 → 69.0 | 30 | 0.02-1.0 | 0.02 |

TABLE 2B
GC-LECO-TOF-MS Figures of Merit
Compound Method

| | RT | Collision | Calibration | LOD |
|---|---|---|---|---|
| Name | (min) | Energy | Range (mg/L) | (mg/L) |
| isovaleraldehyde | 2.96 | 70 | 0.5-50.0 | 0.5 |
| ethyl acetate | 2.56 | 70 | 0.5-50.0 | 0.5 |
| isoamyl alcohol | 4.03 | 70 | 0.5-50.0 | 0.5 |

TABLE 3A
VOCs in reference tequilas

| VOC | 1 | 2 | 3 | 4 | 5 | 6 | 7 |
|---|---|---|---|---|---|---|---|
| isoamyl acetate | 1.1237439 | 1.6974562 | 0.971652 | 0.69166 | 0.6520934 | 0.4688 | 1.28709 |
| heptyl acetate | ND | ND | ND | ND | ND | ND | ND |
| octyl acetate | ND | ND | ND | ND | ND | ND | ND |
| hexanoic acid | ND | 6.2332238 | ND | ND | ND | 6.8349 | 4.89839 |
| octanoic acid | 14.7339144 | 20.3128424 | 13.15043 | 11.2628632 | 10.0968916 | 20.534 | 18.1388 |
| lauric acid | 6.9853097 | 11.0465893 | 8.481856 | 6.0882554 | ND | 16.071 | 19.3001 |
| 1-butanol | 63.5607 | 67.1418 | 64.3162 | 6.4827 | 77.7368 | 22.071 | 38.1646 |
| thymol | 0.2010737 | 0.147254 | 0.086296 | 0.0338781 | 0.0306844 | 0.0749 | 0.04165 |
| ethyl propionate | 4.0881798 | 0.8934086 | 0.421624 | 0.7066314 | 0.8159633 | 0.1487 | 0.66366 |
| ethyl octanoate | 1.6055639 | 2.7959971 | 1.486048 | 0.8704421 | 0.2853853 | 0.535 | 1.72487 |
| ethyl acetate | 116.734194 | 142.4267 | 127.1639 | 103.6571439 | 83.0679335 | 24.415 | 75.6492 |
| isoamyl alcohol | 432.7303 | 384.5415 | 310.9868 | 243.1125 | 250.6606 | 298.05 | 338.874 |
| beta-myrcene | ND | ND | ND | ND | ND | ND | ND |
| alpha-phellandrene | ND | ND | ND | ND | ND | ND | ND |
| p-cymene | ND | ND | ND | ND | ND | ND | ND |
| linalool | 0.888957 | 0.4421173 | 1.615069 | 0.285168 | 0.1949745 | 0.6465 | 0.65111 |
| caryophyllene | 0.0022 | ND | 0.0033 | ND | ND | ND | ND |
| D-limonene | ND | ND | ND | ND | ND | ND | ND |
| acetaldehyde | ND | ND | ND | ND | ND | ND | ND |
| butyl acetate | 0.0331049 | 0.0568342 | 0 | 0.5030042 | 0.2690826 | 0.0958 | ND |
| isobutyl acetate | 0.736 | ND | 0.538 | 1.233 | ND | ND | 0.623 |
| decanoic acid | ND | 25.8532788 | 22.558 | ND | 40.7537672 | ND | 24.2904 |
| propyl alcohol | 285.6305 | 440.6776 | 354.1413 | 415.7153 | 398.0309 | 336.9 | 239.043 |
| isobutyl alcohol | 74.5667 | 203.4686 | 213.937 | 220.2982 | 325.9787 | 244.73 | 171.755 |
| 2-methyl-1-butanol | 189.1703 | 489.5517 | 339.0256 | 376.5816 | 334.2677 | 413.74 | 224.14 |
| phenethyl alcohol | ND | 20.9795 | 17.3214 | 20.2156 | ND | ND | ND |
| furfuryl alcohol | ND | 0.9821153 | 1.840649 | 0.9151824 | 1.8907365 | 3.5301 | 0.91515 |
| eucalyptol | 0.0330155 | 0.0168116 | ND | 0.0107277 | ND | ND | 0.01518 |
| acetol | BC | BC | BC | BC | BC | BC | BC |
| nonanal | 0.0061844 | ND | 0.014152 | 0.0166153 | 0.0133605 | 0.0066 | ND |
| alpha-pinene | ND | 0.0033858 | 0.003146 | ND | ND | ND | 0.0029 |
| 3-carene | ND | ND | ND | ND | ND | ND | ND |
| gamma-terpinene | ND | ND | ND | ND | ND | ND | ND |
| camphene | ND | ND | ND | ND | ND | ND | ND |
| humulene | ND | ND | ND | ND | ND | ND | ND |
| ethyl butyrate | 0.0853162 | 0.5268942 | 0.418773 | 0.2021958 | 0.267924 | 0.1288 | 0.13258 |
| ethyl lactate | 1.486661 | 24.1795962 | 81.90646 | 28.1672233 | 25.2659888 | 11.259 | 3.74103 |
| ethyl laurate | ND | 0.2388531 | 0.187725 | ND | ND | 0.2402 | 0.16405 |
| ethyl hexanoate | 0.0836878 | 0.7890573 | 0.146995 | 0.1211619 | 0.1702494 | 0.0836 | 0.15393 |
| ethyl benzoate | ND | ND | ND | ND | ND | ND | ND |
| isoamyl hexanoate | ND | ND | ND | ND | ND | ND | ND |
| isoamyl octanoate | 0.0394291 | 0.0746969 | 0.134391 | 0.1056641 | 0.1289197 | 0.27 | 0.1135 |
| isoamyl butyrate | ND | ND | ND | ND | ND | ND | ND |
| isobutyl hexanoate | ND | ND | ND | ND | ND | ND | ND |
| ethyl decanoate | 0.9828131 | 0.6600572 | 0.161185 | 0.0133023 | 0.8149065 | 0.6683 | 1.41343 |
| acetic acid | BC | BC | BC | BC | BC | BC | BC |
| acetom | BC | BC | BC | BC | BC | BC | BC |
| acetal | BC | BC | BC | BC | BC | BC | BC |
| isovaleraldehyde | 0.60395096 | 0.22830353 | 0.535157 | 0.296181294 | 0.325326278 | 0.4746 | 0.54634 |
| 2-acetylfuran | 0.1528662 | 1.2781917 | 0.823942 | 0.5717747 | 0.4841286 | 1.4974 | 0.63138 |
| diethyl succinate | 0.0665484 | 0.7044592 | 0.215619 | 0.081566 | 0.0793671 | 0.027 | 0.11694 |
| alpha-terpineol | 1.0177104 | 3.2497824 | 2.357125 | 0.4741136 | 0.5783125 | 1.7061 | 1.10482 |
| beta-pinene | ND | ND | ND | ND | ND | ND | ND |
| terpinolene | ND | ND | ND | ND | ND | ND | ND |
| beta-bisabolene | ND | ND | ND | ND | ND | ND | ND |
| fuselol | 411.669917 | 654.842282 | 558.0048 | 407.117236 | 466.1170855 | 518.13 | 451.179 |

TABLE 3B
VOCs in reference tequilas

| VOC | 8 | 9 | 10 | 11 | 12 | 13 | 14 |
|---|---|---|---|---|---|---|---|
| isoamyl acetate | 1.695308 | 1.502571 | 3.0794317 | 1.8857881 | 1.1464 | 2.221189 | 0.8503 |
| heptyl acetate | ND | ND | ND | ND | ND | ND | ND |
| octyl acetate | ND | ND | ND | ND | ND | ND | ND |
| hexanoic acid | 6.630898 | 11.80796 | 9.5097497 | ND | ND | ND | ND |
| octanoic acid | 13.76476 | 19.56491 | 21.378415 | 19.336347 | 9.8203 | 13.84224 | 18.682 |
| lauric acid | 9.832682 | 8.82697 | 7.5888365 | 5.1274715 | 3.9914 | 3.718034 | 11.027 |
| 1-butanol | 75.6064 | 44.8273 | 94.5195 | 167.5672 | 65.319 | 48.1791 | 58 |
| thymol | 0.262425 | 0.171503 | 0.0928427 | 0.0827208 | 0.071 | 0.053085 | 0.0984 |
| ethyl propionate | 0.619582 | 7.43987 | 0.2507051 | 0.2887309 | 0.3561 | 0.27749 | 0.6417 |
| ethyl octanoate | 1.164528 | 4.072906 | 1.237059 | 1.0549893 | 1.0579 | 0.852492 | 1.2102 |
| ethyl acetate | 154.3546 | 204.8892 | 58.152671 | 70.375981 | 61.8 | 53.20335 | 96.05 |
| isoamyl alcohol | 635.6524 | 549.1162 | 379.754 | 671.7553 | 233.57 | 437.778 | 200.35 |
| beta-myrcene | ND | ND | ND | ND | ND | ND | ND |
| alpha-phellandrene | ND | ND | ND | ND | ND | ND | ND |
| p-cymene | 0.00404 | 0.00431 | ND | ND | ND | ND | ND |
| linalool | 2.172257 | 0.987379 | 0.4569252 | 1.0728029 | 0.0428 | 0.301333 | 0.5489 |
| caryophyllene | ND | ND | ND | ND | ND | ND | ND |
| D-limonene | ND | ND | ND | ND | ND | ND | ND |
| acetaldehyde | ND | ND | ND | ND | ND | ND | ND |
| butyl acetate | ND | ND | 0.0206307 | 0.1425365 | ND | ND | 0.0077 |
| isobutyl acetate | ND | ND | ND | ND | ND | 0.618 | ND |
| decanoic acid | 20.31387 | 20.88552 | ND | 17.313632 | ND | ND | 29.765 |
| propyl alcohol | 330.1123 | 474.3502 | 263.3854 | 355.8373 | 276.09 | 442.2266 | 453.1 |
| isobutyl alcohol | 156.8204 | 234.8296 | 184.8531 | 149.9049 | 104.37 | 164.1325 | 300.08 |
| 2-methyl-1-butanol | 317.9252 | 524.7318 | 287.7507 | 318.977 | 160.17 | 246.4342 | 484.18 |
| phenethyl alcohol | ND | 37.5622 | ND | ND | ND | ND | ND |
| furfuryl alcohol | 3.007454 | 3.681301 | 2.1321877 | 0.9245422 | ND | ND | 1.5086 |
| eucalyptol | ND | 0.062179 | 0.0542324 | 0.0213068 | ND | 0.025248 | 0.0129 |
| acetol | BC | BC | BC | BC | BC | BC | BC |
| nonanal | 0.012666 | 0.012113 | ND | ND | ND | 0.020098 | 0.0138 |
| alpha-pinene | 0.004229 | 0.003373 | ND | ND | 0.0028 | 0.003884 | 0.0047 |
| 3-carene | ND | ND | ND | ND | ND | ND | ND |
| gamma-terpinene | ND | ND | ND | ND | ND | ND | ND |
| camphene | ND | ND | ND | ND | ND | ND | ND |
| humulene | 0.00569 | ND | ND | ND | ND | ND | ND |
| ethyl butyrate | 0.340819 | 0.688996 | 0.5326882 | 0.3325192 | 0.3261 | 0.220106 | 0.3438 |
| ethyl lactate | 134.5807 | 157.0256 | 3.6769187 | 3.4233661 | 2.7797 | 3.739077 | 5.3593 |
| etbyl laurate | 0.107174 | 0.113621 | ND | ND | 0.1517 | ND | 0.1005 |
| ethyl hexanoate | 0.150006 | 0.314255 | 0.5393873 | 0.4166525 | 0.282 | 0.586151 | 0.2693 |
| ethyl benzoate | ND | ND | ND | ND | ND | ND | ND |
| isoamyl hexanoate | ND | ND | ND | ND | ND | ND | ND |
| isoamyl octanoate | 0.217229 | 0.204473 | 0.1858685 | 0.1047819 | ND | ND | 0.07 |
| isoamyl butyrate | ND | ND | ND | ND | ND | ND | ND |
| isobutyl hexanoate | ND | ND | ND | ND | ND | ND | ND |
| ethyl decanoate | 0.555916 | 0.188291 | 0.1322777 | 0.4486977 | 0.1846 | 0.251846 | 0.4386 |
| acetic acid | BC | BC | BC | BC | BC | BC | BC |
| acetoin | BC | BC | BC | BC | BC | BC | BC |
| acetal | BC | BC | BC | BC | BC | BC | BC |
| isovaleraldehyde | 0.509047 | 0.404849 | 0.1180248 | 0.1353688 | 0.309 | 0.30134 | 0.2687 |
| 2-acetylfuran | 0.948833 | 2.192789 | 1.0368988 | 1.1960014 | 0.092 | 0.31982 | 0.373 |
| dicthyl succinate | 0.271163 | 0.464509 | 0.030325 | 0.0714556 | 0.1023 | 0.138816 | 0.0418 |
| alpha-terpineol | 5.958037 | 2.07249 | 2.1652049 | 3.0682107 | 0.7851 | 1.281138 | 1.519 |
| beta-pinene | ND | ND | ND | ND | ND | ND | ND |
| terpinolene | ND | ND | ND | ND | ND | ND | ND |
| beta-bisabolene | ND | ND | ND | ND | ND | ND | ND |
| fuselol | 613.5318 | 836.7976 | 491.80812 | 472.22494 | 239.45 | 427.6557 | 621.37 |

TABLE 3C
VOCs in reference tequilas

| Voc | 15 | 16 | 17 | 18 | 19 | 20 |
|---|---|---|---|---|---|---|
| isoamyl acetate | 2.889 | 0.36567 | 0.50492 | 0.87346 | 1.7298 | 1.11992 |
| heptyl acetate | ND | ND | ND | ND | ND | ND |
| octyl acetate | ND | ND | ND | ND | ND | ND |
| hexanoic acid | ND | ND | ND | ND | 3.28909 | ND |
| octanoic acid | 12.916 | 12.0136 | 15.6313 | 13.9628 | 16.0726 | 19.4708 |
| lauric acid | 4.1441 | 7.26632 | 9.78021 | 6.76242 | 6.55516 | 9.47986 |
| 1-butanol | 4.7591 | 58.6545 | 44.7441 | 54.3711 | 47.5393 | 69.0256 |
| thymol | 0.0254 | 0.08636 | 0.15805 | 0.12316 | 0.05347 | 0.20083 |
| ethyl propionate | 0.244 | 2.80942 | 2.40213 | 0.65153 | 0.38601 | 0.20224 |
| ethyl octanoate | 0.6313 | 0.83524 | 1.30593 | 0.73208 | 1.16211 | 1.16006 |
| ethyl acetate | 64.041 | 141.167 | 189.127 | 96.0948 | 77.2889 | 54.0547 |
| isoamyl alcohol | 250.65 | 392.876 | 384.881 | 396.354 | 286.593 | 499.841 |
| beta-myrcene | ND | ND | ND | ND | ND | ND |
| alpha-phellandrene | ND | ND | ND | ND | ND | ND |
| p-cymene | ND | ND | ND | ND | ND | ND |
| linalool | 0.3137 | 0.90051 | 1.6153 | 0.61937 | 0.41189 | 6.8969 |
| caryophyllene | ND | ND | ND | ND | ND | ND |
| D-limonene | ND | ND | ND | ND | ND | ND |
| acetaldehyde | ND | ND | ND | ND | ND | ND |
| butyl acetate | ND | 0.16326 | 0.07965 | ND | 0.1225 | 0.25918 |
| isobutyl acetate | ND | ND | ND | ND | ND | ND |
| decanoic acid | ND | 24.5864 | 38.3137 | 18.408 | 32.7215 | 24.2526 |
| propyl alcohol | 419.11 | 411.989 | 307.507 | 404.405 | 314.938 | 313.048 |
| isobutyl alcohol | 238.96 | 293.695 | 214.995 | 242.481 | 154.245 | 176.647 |
| 2-methyl-1-butanol | 369.39 | 716.077 | 497.359 | 383.007 | 266.584 | 338.697 |
| phenethyl alcohol | ND | 32.2794 | ND | ND | ND | ND |
| furfuryl alcohol | 1.9393 | 1.90101 | 4.27042 | 0.92414 | 1.23893 | 1.01808 |
| eucalyptol | 0.028 | 0.00422 | ND | 0.05924 | 0.04446 | 0.23529 |
| acetol | BC | BC | BC | BC | BC | BC |
| nonanal | ND | 0.01045 | 0.00648 | 0.01797 | 0.0118 | 0.02934 |
| alpha-pinene | ND | 0.00311 | 0.00354 | 0.00439 | ND | 0.00375 |
| 3-carene | ND | ND | ND | ND | ND | ND |
| gamma-terpinene | ND | ND | ND | ND | ND | ND |
| camphene | ND | ND | ND | ND | ND | ND |
| humulene | ND | ND | ND | ND | ND | ND |
| ethyl butyrate | 0.2659 | 0.37913 | 0.16455 | 0.18522 | 0.82575 | 0.24879 |
| ethyl lactate | 42.607 | 66.6559 | 26.6456 | 88.2127 | 6.62787 | 12.2732 |
| ethyl laurate | ND | 0.22903 | 0.19921 | 0.09492 | 0.08383 | 0.13228 |
| ethyl hexanoate | 0.1399 | 0.17105 | 0.12345 | 0.09503 | 0.50376 | 0.42309 |
| ethyl benzoate | ND | ND | ND | ND | ND | ND |
| isoamyl hexanoate | ND | ND | ND | ND | ND | ND |
| isoamyl octanoate | 0.1946 | 0.15926 | 0.29712 | 0.07631 | 0.09614 | 0.11615 |
| isoamyl butyrate | ND | ND | ND | ND | ND | ND |
| isobutyl hexanoate | ND | ND | ND | ND | ND | ND |
| ethyl decanoate | 0.8378 | 0.52871 | 0.26297 | 0.45824 | 0.40874 | 0.18338 |
| acetic acid | BC | BC | BC | BC | BC | BC |
| acetoin | BC | BC | BC | BC | BC | BC |
| acetal | BC | BC | BC | BC | BC | BC |
| isovaleraldehyde | 0.1137 | 0.28274 | 0.30064 | 0.33119 | 0.27131 | 0.601 |
| 2-acetylfuran | 0.8299 | 1.04576 | 2.47515 | 0.66399 | 1.52187 | 1.63437 |
| diethyl succinate | 0.8336 | 1.13344 | 0.32409 | 0.4368 | 0.15367 | 0.06781 |
| alpha-terpineol | 5.4568 | 4.2259 | 2.45093 | 2.09763 | 3.63409 | 11.3042 |
| beta-pinene | ND | ND | ND | ND | ND | ND |
| terpinolene | ND | ND | ND | ND | ND | ND |
| beta-bisabolene | ND | ND | ND | ND | ND | ND |
| fuselol | 960.99 | 752.72 | 777.834 | 655.82 | 540.321 | 742.897 |

LC-MS was used to ascertain the existence of various non-volatile compounds in several reference tequila samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:
Polarity: positive or negative mode, as indicated for each method
Resolution: 70,000
Scan range: 60-900 m/z for all methods
Isolation window: 1.5 m/z
MS/MS collision energy: 30

Qualitative analysis was done in Compound Discoverer to gather which LC/MS compounds were present in all reference tequilas.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An agave spirit replica comprising:
water,
a grain neutral spirit,
optionally, a agave spirit, wherein said agave spirit replica comprises no more than about 10 wt % of said agave spirit,
glycerin,
optionally, an oak extract,
optionally, a plant oil, and
at least ten added volatile organic compounds (VOCs), wherein said added VOCs comprise at least one acid, at least one additional alcohol, at least one aldehyde, at least one ester, at least one terpene, and at least one furan, and wherein said added VOCs comprise about 0.001 wt % to about 1 wt % of said agave spirit replica.

2. The agave spirit replica of claim 1, wherein said at least one acid comprises one or more of decanoic acid, hexanoic acid, lauric acid, and octanoic acid.

3. The agave spirit replica of claim 1, wherein said at least one acid comprises hexanoic acid and decanoic acid.

4. The agave spirit replica of claim 1, wherein said at least one acid comprises decanoic acid, hexanoic acid, lauric acid, and octanoic acid.

5. The agave spirit replica of any one of claims 1 to 4, wherein said at least one additional alcohol comprises one or more of 1-butanol, propyl alcohol, 2-methyl-1-butanol, isobutyl alcohol, isoamyl alcohol, fuselol, and phenethyl alcohol.

6. The agave spirit replica of claim 5, wherein said at least one additional alcohol comprises 1-butanol, propyl alcohol, 2-methyl-1-butanol, isobutyl alcohol, isoamyl alcohol, and fuselol.

7. The agave spirit replica of claim 5, wherein said at least one additional alcohol comprises propyl alcohol, 2-methyl-1-butanol, isobutyl alcohol, isoamyl alcohol, fuselol, and phenethyl alcohol.

8. The agave spirit replica of any one of claims 1 to 7, wherein said at least one aldehyde comprises one or more of acetaldehyde, isovaleraldehyde, and nonanal.

9. The agave spirit replica of claim 8, wherein said at least one aldehyde comprises acetaldehyde, isovaleraldehyde, and nonanal.

10. The agave spirit replica of any one of claims 1 to 9, wherein said at least one ester comprises one or more of butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate.

11. The agave spirit replica of claim 10, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate.

12. The agave spirit replica of claim 10, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate.

13. The agave spirit replica of claim 10, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate.

14. The agave spirit replica of claim 10, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate.

15. The agave spirit replica of any one of claims 1 to 14, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol.

16. The agave spirit replica of claim 15, wherein said at least one terpene comprises alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol.

17. The agave spirit replica of claim 15, wherein said at least one terpene comprises 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol.

18. The agave spirit replica of claim 15, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol.

19. The agave spirit replica of any one of claims 1 to 18, wherein said at least one terpene comprises one or both of 2-acetylfuran and furfuryl alcohol.

20. The agave spirit replica of any one of claims 1 to 19, wherein said added VOCs comprise ten or more compounds selected from the group consisting of 1-butanol, 2-acetylfuran, 2-methyl-1-butanol, 3-carene, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl butyrate, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

21. The agave spirit replica of any one of claims 1 to 20, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

22. The agave spirit replica of any one of claims 1 to 20, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

23. The agave spirit replica of claim 1, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

24. The agave spirit replica of claim 1, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

25. The agave spirit replica of claim 1, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

26. The agave spirit replica of claim 1, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

27. The agave spirit replica of claim 1, comprising:
from about 5 wt % to about 70 wt % water,
from about 30 wt % to about 95 wt % grain neutral spirits,
not more than about 5 wt % agave spirit,
from about 0.1 wt % to about 5 wt % glycerin, and
from about 0.001 wt % to about 1 wt % added VOCs, wherein said added VOCs comprise ten or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

28. The agave spirit replica of claim 27, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

29. The agave spirit replica of claim 27, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

30. The agave spirit replica of claim 27, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

31. The agave spirit replica of claim 27, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

32. The agave spirit replica of claim 27, wherein said added VOCs comprise isoamyl acetate, and wherein said isoamyl acetate is present in said agave spirit replica at a concentration greater than about 6 mg/L.

33. The agave spirit replica of claim 27, wherein said added VOCs comprise hexanoic acid, and wherein said hexanoic acid is present in said agave spirit replica at a concentration greater than about 23 mg/L.

34. The agave spirit replica of claim 27, wherein said added VOCs comprise octanoic acid, and wherein said octanoic acid is present in said agave spirit replica at a concentration less than about 5 mg/L.

35. The agave spirit replica of claim 27, wherein said added VOCs comprise lauric acid, and wherein said lauric acid is present in said agave spirit replica at a concentration less than about 1.9 mg/L.

36. The agave spirit replica of claim 27, wherein said added VOCs comprise thymol, and wherein said thymol is present in said agave spirit replica at a concentration greater than about 0.5 mg/L.

37. The agave spirit replica of claim 27, wherein said added VOCs comprise ethyl octanoate, and wherein said ethyl octanoate is present in said agave spirit replica at a concentration greater than about 8 mg/L.

38. The agave spirit replica of claim 27, wherein said added VOCs comprise isoamyl alcohol, and wherein said isoamyl alcohol is present in said agave spirit replica at a concentration less than about 100 mg/L.

39. The agave spirit replica of claim 27, wherein said added VOCs comprise p-cymene, and wherein said p-cymene is present in said agave spirit replica at a concentration greater than about 0.0085 mg/L.

40. The agave spirit replica of claim 27, wherein said added VOCs comprise caryophyllene, and wherein said caryophyllene is present in said agave spirit replica at a concentration greater than about 0.007 mg/L.

41. The agave spirit replica of claim 27, wherein said added VOCs comprise isobutyl alcohol, and wherein said isobutyl alcohol is present in said agave spirit replica at a concentration greater than about 650 mg/L.

42. The agave spirit replica of claim 27, wherein said added VOCs comprise furfuryl alcohol, and wherein said furfuryl alcohol is present in said agave spirit replica at a concentration greater than about 8.5 mg/L.

43. The agave spirit replica of claim 27, wherein said added VOCs comprise nonanal, and wherein said nonanal is present in said agave spirit replica at a concentration greater than about 0.06 mg/L.

44. The agave spirit replica of claim 27, wherein said added VOCs comprise alpha-pinene, and wherein said alpha-pinene is present in said agave spirit replica at a concentration greater than about 0.01 mg/L.

45. The agave spirit replica of claim 27, wherein said added VOCs comprise humulene, and wherein said humulene is present in said agave spirit replica at a concentration greater than about 0.01 mg/L.

46. The agave spirit replica of claim 27, wherein said added VOCs comprise ethyl butyrate, and wherein said ethyl butyrate is present in said agave spirit replica at a concentration greater than about 1.6 mg/L.

47. The agave spirit replica of claim 27, wherein said added VOCs comprise isoamyl octanoate, and wherein said isoamyl octanoate is present in said agave spirit replica at a concentration greater than about 0.6 mg/L.

48. The agave spirit replica of claim 27, wherein said added VOCs comprise ethyl decanoate, and wherein said ethyl decanoate is present in said agave spirit replica at a concentration less than about 0.007 mg/L.

49. The agave spirit replica of claim 27, wherein said added VOCs comprise 2-acetylfuran, and wherein said 2-acetylfuran is present in said agave spirit replica at a concentration less than about 0.05 mg/L.

50. The agave spirit replica of claim 27, wherein said added VOCs comprise diethyl succinate, and wherein said diethyl succinate is present in said agave spirit replica at a concentration greater than about 2.3 mg/L.

51. The agave spirit replica of claim 27, wherein said added VOCs comprise alpha-terpineol, and wherein said alpha-terpineol is present in said agave spirit replica at a concentration less than about 0.24 mg/L.

52. The agave spirit replica of claim 27, wherein said added VOCs comprise octanoic acid, and wherein less than about 0.0013 wt % of the one or more additional VOCs is octanoic acid.

53. The agave spirit replica of claim 27, wherein said added VOCs comprise thymol, and wherein greater than about 0.00053 wt % of the one or more additional VOCs is thymol.

54. The agave spirit replica of claim 27, wherein said added VOCs comprise isoamyl alcohol, and wherein less than about 0.03 wt % of the one or more additional VOCs is isoamyl alcohol.

55. The agave spirit replica of claim 27, wherein said added VOCs comprise p-cymene, and wherein greater than about 0.0000087 wt % of the one or more additional VOCs is p-cymene.

56. The agave spirit replica of claim 27, wherein said added VOCs comprise caryophyllene, and wherein greater than about 0.0000067 wt % of the one or more additional VOCs is caryophyllene.

57. The agave spirit replica of claim 27, wherein said added VOCs comprise isobutyl alcohol, and wherein greater than about 0.52 wt % of the one or more additional VOCs is isobutyl alcohol.

58. The agave spirit replica of claim 27, wherein said added VOCs comprise furfuryl alcohol, and wherein greater than about 0.0086 wt % of the one or more additional VOCs is furfuryl alcohol.

59. The agave spirit replica of claim 27, wherein said added VOCs comprise alpha-pinene, and wherein greater than about 0.000009 wt % of the one or more additional VOCs is alpha-pinene.

60. The agave spirit replica of claim 27, wherein said added VOCs comprise ethyl butyrate, and wherein greater than about 0.0017 wt % of the one or more additional VOCs is ethyl butyrate.

61. The agave spirit replica of claim 27, wherein said added VOCs comprise isoamyl octanoate, and wherein greater than about 0.0006 wt % of the one or more additional VOCs is isoamyl octanoate.

62. The agave spirit replica of claim 27, wherein said added VOCs comprise ethyl decanoate, and wherein less than about 0.0000017 wt % of the one or more additional VOCs is ethyl decanoate.

63. The agave spirit replica of claim 27, wherein said added VOCs comprise diethyl succinate, and wherein greater than about 0.0023 wt % of the one or more additional VOCs is diethyl succinate.

64. The agave spirit replica of claim 27, wherein said added VOCs comprise alpha-terpineol, and wherein less than about 0.00006 wt % of the one or more additional VOCs is alpha-terpineol.

65. A method for making an agave spirit replica, wherein said method comprises combining:
water,
a grain neutral spirit,
optionally, an agave spirit, wherein said agave spirit replica comprises no more than about 10 wt % of said agave spirit,
glycerin,
optionally, an oak extract,
optionally, a plant oil, and
at least ten added VOCs, wherein said VOCs are provided as separate ingredients and comprise at least one acid, at least one additional alcohol, at least one aldehyde, at least ester, at least one terpene, and at least one furan, and wherein said added VOCs comprise about 0.001 wt % to about 1 wt % of said agave spirit replica.

66. The method of claim 65, wherein said at least one acid comprises one or more of decanoic acid, hexanoic acid, lauric acid, and octanoic acid.

67. The method of claim 65, wherein said at least one acid comprises hexanoic acid and decanoic acid.

68. The method of claim 65, wherein said at least one acid comprises decanoic acid, hexanoic acid, lauric acid, and octanoic acid.

69. The method of any one of claims 65 to 68, wherein said at least one additional alcohol comprises one or more of 1-butanol, propyl alcohol, 2-methyl-1-butanol, isobutyl alcohol, isoamyl alcohol, fuselol, and phenethyl alcohol.

70. The method of claim 69, wherein said at least one additional alcohol comprises 1-butanol, propyl alcohol, 2-methyl-1-butanol, isobutyl alcohol, isoamyl alcohol, and fuselol.

71. The method of claim 69, wherein said at least one additional alcohol comprises propyl alcohol, 2-methyl-1-butanol, isobutyl alcohol, isoamyl alcohol, fuselol, and phenethyl alcohol.

72. The method of any one of claims 65 to 71, wherein said at least one aldehyde comprises one or more of acetaldehyde, isovaleraldehyde, and nonanal.

73. The method of claim 72, wherein said at least one aldehyde comprises acetaldehyde, isovaleraldehyde, and nonanal.

74. The method of any one of claims 65 to 73, wherein said at least one ester comprises one or more of butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl acetate, isobutyl hexanoate, and octyl acetate.

75. The method of claim 74, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, isobutyl hexanoate, and octyl acetate.

76. The method of claim 74, wherein said at least one ester comprises butyl acetate, diethyl succinate, ethyl acetate, ethyl benzoate, ethyl butyrate, ethyl decanoate, ethyl hexanoate, ethyl lactate, ethyl laurate, ethyl octanoate, ethyl propionate, heptyl acetate, isoamyl acetate, isoamyl hexanoate, isoamyl octanoate, and octyl acetate.

77. The method of claim 74, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl hexanoate, isoamyl octanoate, isobutyl acetate, isobutyl hexanoate, and octyl acetate.

78. The method of claim 74, wherein said at least one ester comprises butyl acetate, diethyl succinate, ethyl acetate, ethyl benzoate, ethyl butyrate, ethyl decanoate, ethyl hexanoate, ethyl lactate, ethyl octanoate, ethyl propionate, isoamyl acetate, isoamyl octanoate, isobutyl acetate, and octyl acetate.

79. The method of any one of claims 65 to 78, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, thymol.

80. The method of claim 79, wherein said at least one terpene comprises alpha-phellandrene, alpha-pinene, alpha-terpineol, beta-bisabolene, beta-myrcene, beta-pinene, caryophyllene, D-limonene, eucalyptol, gamma-terpinene, linalool, p-cymene, terpinolene, and thymol.

81. The method of claim 79, wherein said at least one terpene comprises 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, humulene, linalool, p-cymene, terpinolene, and thymol.

82. The method of claim 79, wherein said at least one terpene comprises one or more of 3-carene, alpha-phellandrene, alpha-pinene, alpha-terpineol, beta-bisabolene, beta-myrcene, beta-pinene, camphene, caryophyllene, D-limonene, eucalyptol, gamma-terpinene, linalool, p-cymene, and thymol.

83. The method of any one of claims 65 to 82, wherein said at least one terpene comprises one or both of 2-acetylfuran and furfuryl alcohol.

84. The method of any one of claims 65 to 83, wherein said added VOCs comprise ten or more compounds selected from the group consisting of 1-butanol, 2-acetylfuran, 2-methyl-1-butanol, 3-carene, acetal, acetaldehyde, acetic acid, acetoin, acetol, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl butyrate, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

85. The method of any one of claims 65 to 84, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

86. The method of any one of claims 65 to 84, wherein said added VOCs comprise 10 or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

87. The method of claim 65, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

88. The method of claim 65, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

89. The method of claim 65, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

90. The method of claim 65, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

91. The method of claim 65, wherein said agave spirit replica comprises:
from about 5 wt % to about 70 wt % water,
from about 30 wt % to about 95 wt % grain neutral spirits,
not more than about 5 wt % agave spirit,
from about 0.0001 wt % to about 5 wt % glycerin, and
from about 0.001 wt % to about 1 wt % added VOCs, wherein said added VOCs comprise ten or more compounds selected from the group consisting of 1-butanol, 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, octanoic acid, octyl acetate, p-cymene, phenethyl alcohol, propyl alcohol, terpinolene, and thymol.

92. The method of claim 91, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isobutyl hexanoate, isovaleraldehyde, lauric acid, linalool, decanoic acid, nonanal, nonanal, octanoic acid, octyl acetate, p-cymene, propyl alcohol, terpinolene, and thymol.

93. The method of claim 91, wherein said added VOCs comprise 1-butanol, 2-acetylfuran, 2-methyl-1-butanol, acetaldehyde, alpha-phellandrene, alpha-terpineol, beta-bisabolene, beta-myrcene, beta-pinene, butyl acetate, caryophyllene, diethyl succinate, D-limonene, ethyl acetate, ethyl benzoate, ethyl butyrate, ethyl decanoate, ethyl hexanoate, ethyl lactate, ethyl laurate, ethyl octanoate, ethyl propionate, eucalyptol, furfuryl alcohol, fuselol, gamma-terpinene, heptyl acetate, hexanoic acid, isoamyl acetate, isoamyl alcohol, isoamyl hexanoate, isoamyl octanoate, isobutyl alcohol, isovaleraldehyde, lauric acid, linalool, decanoic acid, nonanal, nonanal, octanoic acid, octyl acetate, p-cymene, propyl alcohol, terpinolene, and thymol.

94. The method of claim 91, wherein said added VOCs comprise 2-acetylfuran, 2-methyl-1-butanol, 3-carene, acetaldehyde, alpha-phellandrene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, humulene, isoamyl acetate, isoamyl alcohol, isoamyl hexanoate, isoamyl octanoate, isobutyl acetate, isobutyl alcohol, isobutyl hexanoate, isovaleraldehyde, lauric acid, linalool, decanoic acid, nonanal, nonanal, octanoic acid, octyl acetate, p-cymene, phenethyl alcohol, propyl alcohol, terpinolene, and thymol.

95. The method of claim 91, wherein said added VOCs comprise 2-acetylfuran, 2-methyl-1-butanol, 3-carene, acetaldehyde, alpha-phellandrene, alpha-pinene, alpha-terpineol, beta-bisabolene, beta-myrcene, beta-pinene, butyl acetate, camphene, caryophyllene, diethyl succinate, D-limonene, ethyl acetate, ethyl benzoate, ethyl butyrate, ethyl decanoate, ethyl hexanoate, ethyl lactate, ethyl octanoate, ethyl propionate, eucalyptol, furfuryl alcohol, fuselol, gamma-terpinene, hexanoic acid, isoamyl acetate, isoamyl alcohol, isoamyl octanoate, isobutyl acetate, isobutyl alcohol, isovaleraldehyde, linalool, decanoic acid, nonanal, octyl acetate, p-cymene, phenethyl alcohol, propyl alcohol, and thymol.

96. The method of claim 91, wherein said added VOCs comprise isoamyl acetate, and wherein said isoamyl acetate is present in said agave spirit replica at a concentration greater than about 6 mg/L.

97. The method of claim 91, wherein said added VOCs comprise hexanoic acid, and wherein said hexanoic acid is present in said agave spirit replica at a concentration greater than about 23 mg/L.

98. The method of claim 91, wherein said added VOCs comprise octanoic acid, and wherein said octanoic acid is present in said agave spirit replica at a concentration less than about 5 mg/L.

99. The method of claim 91, wherein said added VOCs comprise lauric acid, and wherein said lauric acid is present in said agave spirit replica at a concentration less than about 1.9 mg/L.

100. The method of claim 91, wherein said added VOCs comprise thymol, and wherein said thymol is present in said agave spirit replica at a concentration greater than about 0.5 mg/L.

101. The method of claim 91, wherein said added VOCs comprise ethyl octanoate, and wherein said ethyl octanoate is present in said agave spirit replica at a concentration greater than about 8 mg/L.

102. The method of claim 91, wherein said added VOCs comprise isoamyl alcohol, and wherein said isoamyl alcohol is present in said agave spirit replica at a concentration less than about 100 mg/L.

103. The method of claim 91, wherein said added VOCs comprise p-cymene, and wherein said p-cymene is present in said agave spirit replica at a concentration greater than about 0.0085 mg/L.

104. The method of claim 91, wherein said added VOCs comprise caryophyllene, and wherein said caryophyllene is present in said agave spirit replica at a concentration greater than about 0.007 mg/L.

105. The method of claim 91, wherein said added VOCs comprise isobutyl alcohol, and wherein said isobutyl alcohol is present in said agave spirit replica at a concentration greater than about 650 mg/L.

106. The method of claim 91, wherein said added VOCs comprise furfuryl alcohol, and wherein said furfuryl alcohol is present in said agave spirit replica at a concentration greater than about 8.5 mg/L.

107. The method of claim 91, wherein said added VOCs comprise nonanal, and wherein said nonanal is present in said agave spirit replica at a concentration greater than about 0.06 mg/L.

108. The method of claim 91, wherein said added VOCs comprise alpha-pinene, and wherein said alpha-pinene is present in said agave spirit replica at a concentration greater than about 0.01 mg/L.

109. The method of claim 91, wherein said added VOCs comprise humulene, and wherein said humulene is present in said agave spirit replica at a concentration greater than about 0.01 mg/L.

110. The method of claim 91, wherein said added VOCs comprise ethyl butyrate, and wherein said ethyl butyrate is present in said agave spirit replica at a concentration greater than about 1.6 mg/L.

111. The method of claim 91, wherein said added VOCs comprise isoamyl octanoate, and wherein said isoamyl octanoate is present in said agave spirit replica at a concentration greater than about 0.6 mg/L.

112. The method of claim 91, wherein said added VOCs comprise ethyl decanoate, and wherein said ethyl decanoate is present in said agave spirit replica at a concentration less than about 0.007 mg/L.

113. The method of claim 91, wherein said added VOCs comprise 2-acetylfuran, and wherein said 2-acetylfuran is present in said agave spirit replica at a concentration less than about 0.05 mg/L.

114. The method of claim 91, wherein said added VOCs comprise diethyl succinate, and wherein said diethyl succinate is present in said agave spirit replica at a concentration greater than about 2.3 mg/L.

115. The method of claim 91, wherein said added VOCs comprise alpha-terpineol, and wherein said alpha-terpineol is present in said agave spirit replica at a concentration less than about 0.24 mg/L.

116. The method of claim 91, wherein said added VOCs comprise octanoic acid, and wherein less than about 0.0013 wt % of the one or more additional VOCs is octanoic acid.

117. The method of claim 91, wherein said added VOCs comprise thymol, and wherein greater than about 0.00053 wt % of the one or more additional VOCs is thymol.

118. The method of claim 91, wherein said added VOCs comprise isoamyl alcohol, and wherein less than about 0.03 wt % of the one or more additional VOCs is isoamyl alcohol.

119. The method of claim 91, wherein said added VOCs comprise p-cymene, and wherein greater than about 0.0000087 wt % of the one or more additional VOCs is p-cymene.

120. The method of claim 91, wherein said added VOCs comprise caryophyllene, and wherein greater than about 0.0000067 wt % of the one or more additional VOCs is caryophyllene.

121. The method of claim 91, wherein said added VOCs comprise isobutyl alcohol, and wherein greater than about 0.52 wt % of the one or more additional VOCs is isobutyl alcohol.

122. The method of claim 91, wherein said added VOCs comprise furfuryl alcohol, and wherein greater than about 0.0086 wt % of the one or more additional VOCs is furfuryl alcohol.

123. The method of claim 91, wherein said added VOCs comprise alpha-pinene, and wherein greater than about 0.000009 wt % of the one or more additional VOCs is alpha-pinene.

124. The method of claim 91, wherein said added VOCs comprise ethyl butyrate, and wherein greater than about 0.0017 wt % of the one or more additional VOCs is ethyl butyrate.

125. The method of claim 91, wherein said added VOCs comprise isoamyl octanoate, and wherein greater than about 0.0006 wt % of the one or more additional VOCs is isoamyl octanoate.

126. The method of claim 91, wherein said added VOCs comprise ethyl decanoate, and wherein less than about 0.0000017 wt % of the one or more additional VOCs is ethyl decanoate.

127. The method of claim 91, wherein said added VOCs comprise diethyl succinate, and wherein greater than about 0.0023 wt % of the one or more additional VOCs is diethyl succinate.

128. The method of claim 91, wherein said added VOCs comprise alpha-terpineol, and wherein less than about 0.00006 wt % of the one or more additional VOCs is alpha-terpineol.

129. An agave spirit replica produced by the method of any one of claims 65 to 128.

130. A tequila-like alcoholic beverage concentrate comprising:
glycerin,
optionally, a tequila, wherein said alcoholic beverage, after dilution to produce a final product, comprises no more than about 10 wt % of said tequila,
optionally, an oak extract,
optionally, a plant oil, and
at least ten added VOCs, wherein said added VOCs comprise at least one acid, at least one additional alcohol, at least one aldehyde, at least one ester, at least one terpene, and at least one furan, and wherein at least one of said added VOCs is present in a concentration of at least about 2-fold the concentration of the same VOC in a corresponding traditional tequila or a corresponding non-concentrate tequila.

131. The tequila-like alcoholic beverage concentrate of claim 130, wherein at least one of said added VOCs is present in the concentrate in a concentration of at least about 5-fold the concentration of the same VOCs in a corresponding traditional tequila or a corresponding non-concentrate tequila.

132. The tequila-like alcoholic beverage concentrate of claim 130, wherein at least one of said added VOCs is present in the concentrate in a concentration of at least about 10-fold the concentration of the same VOCs in a corresponding traditional tequila or a corresponding non-concentrate tequila.

133. The tequila-like alcoholic beverage concentrate of claim 130, wherein at least one of said added VOCs is present in the concentrate in a concentration of at least about 15-fold the concentration of the same VOCs in a corresponding traditional tequila or a corresponding non-concentrate tequila.

134. The tequila-like alcoholic beverage concentrate of any one of claims 130 to 133, wherein upon dilution of said tequila-like beverage concentrate to a tequila-like alcoholic beverage, the tequila-like alcoholic beverage is the agave spirit replica of any one of claims 1 to 64.

135. A method of making a tequila-like alcoholic beverage concentrate, the method comprising combining:
glycerin,
optionally, a tequila, wherein said alcoholic beverage, after dilution to produce a final product, comprises no more than about 10 wt % of said tequila,
optionally, an oak extract,
optionally, a plant oil, and
at least ten added VOCs, wherein said added VOCs comprise at least one acid, at least one additional alcohol, at least one aldehyde, at least one ester, at least one terpene, and at least one furan, and wherein at least one of said added VOCs is present in a concentration of at least about 2-fold the concentration of the same VOC in a corresponding traditional tequila or a corresponding non-concentrate tequila.

136. The method of claim 135, wherein at least one of said added VOCs is present in the concentrate in a concentration of at least about 5-fold the concentration of the same VOCs in a corresponding traditional tequila or a corresponding non-concentrate tequila.

137. The method of claim 135, wherein at least one of said added VOCs is present in the concentrate in a concentration of at least about 10-fold the concentration of the same VOCs in a corresponding traditional tequila or a corresponding non-concentrate tequila.

138. The method of claim 135, wherein at least one of said added VOCs is present in the concentrate in a concentration of at least about 15-fold the concentration of the same VOCs in a corresponding traditional tequila or a corresponding non-concentrate tequila.

139. The method of any one of claims 135 to 138, wherein upon dilution of the tequila-like beverage concentrate to a tequila-like alcoholic beverage, the tequila-like alcoholic beverage is the agave spirit replica of any one of claims 1 to 64.
